(19) United States
(12) Patent Application Publication
(10) Pub. No.: US 2002/0138659 A1
(43) Pub. Date: Sep. 26, 2002

(54) Method and system for application development and a data processing architecture utilizing destinationless messaging

(76) Inventors: Zissis Trabaris, Forest Hills, NY (US); Ira Lee, Kew Gardens, NY (US)

Correspondence Address: KENYON & KENYON, ONE BROADWAY, NEW YORK, NY, 10004, US

(21) Appl. No.: 10/015,966

(22) Filed: Nov. 1, 2001

Related U.S. Application Data
(60) Provisional application No. 60/244,846, filed on Nov. 1, 2000.

(51) Int. Cl. G06F 9/00; G06F 9/46; G06F 15/16

(52) U.S. Cl. 709/313; 709/201; 709/328

(57) ABSTRACT

The present invention provides a data processing architecture and application development paradigm, which facilitates dynamic reconfiguration, code reuse, interoperability, performance, availability and manageability. The application architecture according to the present invention includes a combination of discrete and autonomous program processes each capable of generating destinationless data elements, one or more data repositories for the storage of data elements generated by the program processes and configuration information for each program process. The configuration information for each program process may associate a program process with one or more data repositories in either a read or write configuration. The application is made operative through the combination of the autonomous behavior of each program process and an exchange of data elements or communication pathways between program processes.

### PRIOR PROVISIONAL PATENT APPLICATION

The present application claims the benefit under 35 U.S.C. §119(e) of U.S. Provisional Application No. 60/244,846 filed Nov. 1, 2000.

### FIELD OF THE INVENTION

The present invention relates to the areas of information systems and information networks. In particular, the present invention provides a data processing system and a method and system for application development utilizing destinationless messaging.

### BACKGROUND INFORMATION

The complexity of applications network infrastructures places new demands on efficient application program development. The programming environment available to application developers and computer programmers is often determinative of development efficiency as well as the robustness of developed code and data structures. In particular, an application environment should facilitate flexible code reusability and reconfiguration, means for efficient re-deployment of developed code to provide dynamic load balancing and/or to adapt to changes in network structure or intermittent faults within portions of a network. In general, ideally a programming environment should facilitate arbitrary distribution of program elements to maximize the use of available core processing infrastructure. Furthermore, redistribution of processing tasks should be achievable at runtime to accommodate shifting network load and faults. Moreover, ideally application programmers should be liberated from concerns of network deployment and other runtime issues during the development stage in order to promote code within a myriad of diverse application environments.

The notion of object oriented programming languages and environments is a well known concept. However, honoring the object-oriented paradigm is often complicated due to the fact that the modern notion of information systems is a hybrid of pure processing tasks and communication tasks. Developing code for any networked application, which is a necessity in modern information systems, typically requires the developer to concentrate heavily on communication functionality (i.e. networking and protocol issues as well as scalability and high-availability requirements) during code development, which may promote inefficiency in focusing on the core behavioral and processing attributes of the developed code. Furthermore, the application developer is often required to interweave communication functionality alongside the core behavioral and processing code development. This often results in code that is not easily reusable outside of the idiosyncratic networking environment for which the code was originally intended.

Ultimately, the inherency of protocol/communications functionality to core functional development, which characterizes traditional development environments results in less efficient applications, long development and reconfiguration cycles and reduced code reusability. Because the developer most focus upon protocol and communication issues during development, attention to the underlying logic, data flow and code efficiency may be sacrificed.

In particular, one example where the efficiency of distributed applications becomes critical is providing eBusiness and Internet applications. The Internet and new technology standards and products make building distributed eBusiness applications a challenging proposition. Most companies rely on existing systems for company-specific functions such as data lookup and transaction processing. Rebuilding these core application systems to adapt them for eBusiness requirements is not feasible. Nor is rebuilding existing network infrastructures. To take advantage of the opportunities offered by the Internet, companies must be able to bridge the gap between the existing business systems and new Web-based systems, application components and services.

Early attempts to do this are proving more difficult than at first anticipated, resulting in escalating costs, unwieldy implementations and frequently, changes to the business requirements to meet the abilities of the available technologies. With limited resources, little in-house experience and tight time constraints, companies are forced to build solutions that are very specific to the immediate problem, without taking adaptability or scalability for future needs into consideration.

eBusinesss applications create significant constraints for data processing systems. eBusiness applications must communicate across a wide range of incompatible systems, networks, protocols, platforms, and underlying technologies. Furthermore, eBusiness applications require new levels of scalability. Any component of any application must be able to be individually scaled up to handle hundreds of thousands or even millions of users, transactions or device connections as demand increases. In addition, eBusiness applications must be very high performance, regardless of the physical environment within which they execute. Furthermore, if companies are going to use the Internet as a true business platform, eBusiness applications must have enterprise-class availability, security, fault tolerance, and failover recovery.

Known solutions for developing distributed computing solutions are deficient in that they do not provide for a decoupling of logic coding and communication protocol coding that allows distributed components to communicate with one another. This deficiency is directly related to the paradigm that traditional approaches employ. FIG. 34 illustrates a traditional distributed computing paradigm. A plurality of distributed processing elements 3410(1)-3410(N) communicate within computing environment 121 via a centralized controller 3405.

Utilizing the approach depicted in FIG. 34, each distributed computing element (3410(1)-3410(N)) must be made aware of the existence of the others. If it is desired that two computing elements communicate or exchange information, this must be established during the coding of the functional elements. Effectively, distributed elements 3410(1)-3410(N) must be “hard-wired” together via the operation of centralized controller 3405, which makes reconfiguration of an application very inefficient post-development.

For example, Tibco Software, Inc. provides a distributed computing environment, constructed upon a central messaging bus. Messages transmitted upon the bus are self-describing, that may be mapped via a rule set. Various distributed processes are executed within a computing environment, wherein each process communicates with one another over the central messaging bus. The Tibco product also provides an adaptor functionality to allow different network protocols and third-party integration to the messaging bus. A major deficiency of the Tibco system arises from the central bus architecture, which inhibits direct communication between communicating processes. Furthermore, utilization of centralized bus architecture creates bottleneck and efficiency issues as multiple processes are forced to compete for bandwidth on the bus.

IBM Corporation provides a distributed computing environment referred to as MQ series, which is a queue-based system utilizing cursor based access and committed and non-committed reads. Multiple processes are provided access to queues, which enables an exchange of messages between processes. A significant limitation of MQ series technology arises due to the fact that queue access must be configured and established during a development phase and thus remains fixed thereafter. Once a queue configuration has been coded, it essential remains hard-wired unless an application developer revisits the development environment to alter a queue configuration. Furthermore, MQ series requires a separate process to be executed on each host to facilitate access to the queues. This requirement limits flexibility and direct communication between processes. Furthermore, MQ series does not provide control functionality to allow separate processes to control one another since the process is disconnected from communication functionality.

Corba (“Common Object Request Brokering Architecture”) provided by the Object Management Group (“OMG”) provides a system for remote access to server based objects. The server based objects represent interfaces to various services that are executed on a backend processing environment. Corba relies on the concept of an ORB (“Object Request Broker”), which handles all aspects of communication and control. In particular, Corba allows users to query the ORB to discover objects, which are stored in a centralized repository system. In addition, it provides locator services to attach or bind to these objects. Once a process has bound to a particular object, it may then invoke the remote methods of the object.

A significant limitation with the Corba paradigm arises due to the fact that remote method invocation serves as the sole form of communication between entities. Thus, various processes are not capable of controlling one another, except indirectly by accessing pre-defined methods of objects stored in the centralized repository.

Another known technology, Forte, enables rapid integration of applications into a larger information system that may span heterogeneous environments. Forte relies upon a publish-subscribe model utilizing a centralized messaging bus. Each application communicates to the bus by means of a proxy, which utilizes an XML (“Extensible Markup Language”) communication interface. Forte requires deployment of a backbone infrastructure within a computing environment in order to access its features. Furthermore, applications that cannot communicate via XML require fusion connectors that server as a translation layer between an application's native protocol and XML.

The Forte technology suffers from inherent limitations similar to the other prior art technologies discussed. In particular, Forte relies upon a hierarchical centralized communication architecture, which inhibits direction communication between processes and typically creates bandwidth and bottleneck issues in large applications. Furthermore, Forte requires significant overhead relating to the deployment of the infrastructure code itself.

Thus, although a number of known systems have attempted to provide an object oriented development environment for application development, these technologies suffer from significant overhead, indirect communication between remote processes, limited ability for control between processes and/or rigid interfaces and protocol requirements. Furthermore, known technologies do not provide dynamic reconfiguration, which may be realized at deployment alone; instead known systems for application development require application redevelopment in order to reconfigure applications to function within a computing environment. These limitations are particularly severe in light of the sophisticated computing platforms currently being developed to provide real-time or near real-time processing such as transaction environments such as those designed to be accessed over information networks such as the Internet and World Wide Web. Typically, such sophisticated applications require rapid reconfiguration ability to perform functions such as load balancing and/or to rapidly react to system faults and overloads.

In particular, it would be desirable if differences between platforms, operating systems and communication protocols could be abstracted out of the application. Application components should know nothing about the networks on which they will run or the protocols with which they will communicate. In general, it would be desirable if integration and extension of applications could be achievable by ‘wiring’ together application components without rebuilding the applications or changing the application code. It would be further desirable if the scaling of applications could be achieved as a matter of distributing copies of individual components to make better use of resources, not reproducing entire application infrastructures.

Thus, a new paradigm for building and deploying distributed applications is necessary for achieving the goals of dynamic reconfiguration, code reuse, interoperability, performance, availability and manageability.

### SUMMARY OF THE INVENTION

The present invention provides a data processing architecture and application development paradigm, which facilitates dynamic reconfiguration, code reuse, interoperability, performance, availability and manageability. The present invention provides a system and method for application development, deployment and runtime monitoring which significantly fosters code reuse and dynamic reconfiguration of developed applications.

According to the present invention, mechanisms for an exchange of data within the application and by discrete elements of the application are entirely decoupled from the processing tasks of discrete elements of the application. This paradigm facilitates dynamic reconfiguration of an application at any time even after runtime has commenced. The paradigm of the present invention promotes attention to functional behavior of code, efficient logic design, control and logic flow based upon a programming specification. Furthermore, the development environment significantly reduces development and reconfiguration time, significantly fosters code reusability, reduces the frequency of design errors and promotes heightened performance through more efficient code design.

The application architecture according to the present invention includes a combination of discrete and autonomous program processes each capable of generating destinationless data elements, one or more data repositories for the storage of data elements generated by the program processes and configuration information for each program process. The configuration information for each program process may associate a program process with one or more data repositories in either a read or write configuration. The application is made operative through the combination of the autonomous behavior of each program process and an exchange of data elements or communication pathways between program processes.

The exchange of data between program processes is achieved through an association of modules with channels in either a read or write capacity and does not rely upon a centralized controller operator. Instead, program processes are autonomous and incognizant of other program processes and therefore exchange of data and information is not achieved by a coupling of processes either in a coding or runtime stage. The exchange of data between processes is achieved by the combined individual functional operation of each program process and the read/write behavior of each program process with respect to the data repositories, which collectively function as a conduit for an exchange of data between processes. The architecture provides significant benefits for distributed computing applications in dynamic reconfiguration, code reuse, interoperability, performance, availability and manageability.

According to one embodiment, the data processing architecture of the present invention provides for the development of a programming application utilizing a plurality of discrete functional processes herein referred to as modules. According to the present invention, modules are discrete self-contained collaborative entities, each of which is designed to perform a narrowly defined range of tasks within a programming application. Modules have the capacity of responding to a stimulus, which may be generated by other modules. Furthermore modules may initialize, terminate or reconfigure other modules. Because modules are coded as autonomous entities of specialized and limited functionality, the modules belonging to the same application have no built-in knowledge of each other's behavior nor the contribution that each makes to the whole. Each module functions in a collaborative fashion with respect to the entire application.

Modules are also characterized in their ability to generate structured destinationless messages. Messages may be structured into any of number of fields to include any information desired by the application developer and according to one embodiment are implemented utilizing BLOBs (“Binary Large Objects”). According to the present invention, messages are destinationless, meaning that they do not include any information in their fields or otherwise that relates to an intended recipient. Instead, modules generate messages typically to report the results of some computational behavior of the module. However, the consumer of messages generated by modules is not known or explicitly indicated in a modules functional code.

Each module is associated with configuration parameters (which may be modified even during runtime) that includes various configuration data related to operation and initialization of the associated modules.

The programming architecture according to the present invention includes at least one data repository, wherein a data repository receives and stores destinationless messages generated by modules. The data repositories, which are herein referred to as channels, provide a conduit for an exchange of messages between modules. Modules may write to particular channels or read for particular channels as defined by the application developer. According to one embodiment, channels are implemented utilizing FIFO (“First In First Out”) buffers, which may be implemented utilizing memory mapped page files for example on hard disk or in RAM (“Random Access Memory”).

The application architecture comprises a plurality of modules, module configuration parameters and channels. Among other things, module configuration parameters associate a module with one or more channels in either a write or a read capacity. The combined set of configuration parameters for the modules comprising an application achieves a communication binding between the modules.

The present invention provides an abstraction layer for development of an application using modules, channels and messages utilizing a plurality of API's (“Application Program Interfaces”). According to one embodiment of the present invention, a module API includes a plurality of function calls that allow the definition, initialization and termination of modules. A channel API includes a plurality of function calls for opening, closing, reading and writing from channels. A message API includes a plurality of function calls for the structuring of destinationless messages, namely the definition of a field structure for messages according to the design requirements of the developer.

The APIs function within an application development paradigm, which includes a module coding step, an assembly step, and a deployment/managing step.

During the module coding step, one or more modules are defined for an application. According to the present invention a module comprises a discrete element of code exhibiting a functional behavior. In particular, a module is a set of program instructions in any programming language, which incorporates a selection of API function calls—that is function calls relating to module definition, channel access and messaging definition.

According to one embodiment, each module is generated by creating a module source code file that includes a predefined structure. In particular, each module source code file includes an initialization function, a work function and a termination function which respectively include code to initialize the module, code to cause the module to exercise its characteristic behavior and code to terminate or kill operation of the module. The initialization, work and termination functions serve as callback functions, which permit remote control of module functions. In particular, modules may control one another by causing the initialization, termination or reconfiguration of other modules, which is effected by calling the respective initialization, work or termination function.

In the assembly step, among other things an interaction between modules is defined in the form of a schema that delineates one or more communication pathways between the modules for an exchange of messages. These communication pathways are virtual because modules do not directly communicate with one another. Channels provide the conduit for the exchange of messages between modules. Thus, during the assembly step, the associations between modules in a read or write capacity are achieved such that the configuration information for each module with respect to channels is set. According to one embodiment, a GUI (“Graphical User Interface”) tool provides the application developer with a convenient input mechanism for defining communication pathways.

In a deployment step, the defined application is deployed and configured within a computing environment such as a network, which may include any set of generalized processing entities (e.g., hosts). In particular, the modules included within the application are distributed to one or more hosts within the computing environment. During the deployment step, the interaction scheme specified in the assembly step is preserved although modules included within the application may be distributed among multiple hosts throughout the computing environment. According to one embodiment, in order to commence the deployment step, the application developer defines one or more components from the application. A component defines one or more modules designated to reside on a single host. Components are then deployed on respective hosts within computing environment in a manner that the communication pathways defined in the application building step are preserved (this is accomplished even if interacting modules span multiple hosts). According to one embodiment of the present invention, a GUI tool provides the deployment of an application within a computing environment.

According to one embodiment of the present invention, during the deployment step, defined communication pathways are ultimately resolved into a structure herein referred to as channel, which serves as a conduit to facilitate an interaction between modules included within an application based upon the interaction scheme defined during the application building step. According to one embodiment, a channel provides a pathway for an exchange of messages between modules. Messages are self-describing data entities utilizing a particular structure. According to one embodiment, a channel is implemented as a memory mapped data structure referred to herein as a page file. Page files may be implemented as memory mapped files on a given host so that data (i.e., messages) stored within the page files may be accessed using a convenient and fast memory pointer scheme. According to this scheme, a block of RAM (“Random Access Memory”) is reserved to correspond to a particular block of disk storage space so that data written to RAM corresponds to particular physical storage space on a non-volatile memory device such as a hard disk. According to an alternative embodiment, page files be implemented entirely in RAM using shared-memory facility on host 114. Each page file is associated with one or more read cursors and one or more write cursors.

During the deployment step, modules comprising an application are deployed to a computing environment based upon a deployment scheme. In order for an application to run within a computing environment, a runtime environment must be installed on each host in the computing environment in which one or more modules from the application will reside. According to one embodiment, a runtime environment includes a module manager module, a router module, a communications module, a reference retriever module, an authorization module and a file operations module. Consistent with the paradigm provided by the present invention, each module included within the runtime is structured like any other module included within an application (i.e., it utilizes a structured code paradigm as described above, and thus is associated with an initialization function, a work function and a termination function).

The module manager module 201 provides functionality for starting, suspending, stopping and cloning modules running on a host 114 on which the module manager has been deployed. Cloning of modules 201 involves invoking identical instances of running modules 201, which all share the same input and output channels.

A router module included within the runtime environment is tasked with dynamic routing of messages between modules. Conditional routing of messages may be accomplished utilizing a routing table (not shown) as defined within a configuration file. Routing may also be effected dynamically such that rules may be added or removed during runtime. A communications module included within the runtime environment provides a conduit for the deployment of modules including a runtime environment itself on hosts within the computing environment. A reference retriever module included within the runtime environment performs functions for resolving remote file access and reference requests. An authorization module included within the runtime environment provides functionality for permissioning, authentication and authorization related to the runtime operation of an application.

According to one embodiment, a number of facilitator modules are defined that aid in the deployment and operation of application including sender and receiver modules 201, multiplexer and demultiplexer modules 201, data mapper modules 201, a load balance module 201 and a router module 201 specifically configured to multiplex messages unconditionally to a set of channels.

In order to achieve interaction between modules deployed on separate hosts within a computing environment, sender modules and receiver modules may be deployed on separate respective hosts. A sender module and a receiver module may interact and exchange messages across separate hosts coupled together on a network. In particular, a sender module and a receiver module may communicate over a network utilizing a particular network protocol such as TCP/IP (“Transmission Control Protocol/Internet Protocol”).

A multiplexer module and demultiplexer module may be deployed to extend and preserve multiple physical channels across a single channel divide. A multiplexer module performs (as its work function) the operation of combining messages arriving from multiple channels so that they can be transported over a single channel. A demultiplexer module performs the function of demultiplexing messages arriving over a single channel into separate channels.

A data mapper module performs the task of transforming message formats based upon conditional rules. Message data may be re-mapped or aggregated.

According to one embodiment of the present invention an application development and network deployment tool is provided, which facilitates the development process by providing automated functions and graphical user interfaces (“GUI”) for performing the packaging step, the application building step and the deployment step. According to one embodiment, the ADNDT provides a GUI environment through which an application developer may define and deploy an application within a computing environment. As a function of input received through the GUI, ADNDT automatically populates associated configuration files for modules included within an application 405. ADNDT provides functionality for building an application by allowing an application developer to select desired modules from a module repository to perform an application building step.

After runtime has commenced, the performance of the application may be monitored to evaluate its performance. Even during runtime, applications may be reconfigured dynamically to respond to temporal variations within a computing environment such as shifting load and/or faults. The development environment provided by the present invention obviates developer focus upon protocol and communication issues within an intended computing environment during the development phase.

### BRIEF DESCRIPTION OF THE DRAWINGS

FIG. 1, which is prior art, illustrates a traditional application development environment.

FIG. 2a illustrates an application design paradigm and methodology according to one embodiment of the present invention.

FIG. 2b illustrates a runtime monitoring function provided by the present invention.

FIG. 3a illustrates an operation of a module according to one embodiment of the present invention.

FIG. 3b illustrates a relationship between a first module, a second module and a message according to one embodiment of the present invention.

FIG. 3c illustrates a remote initialization of a module according to one embodiment of the present invention.

FIG. 3d illustrates a remote termination of a module according to one embodiment of the present invention.

FIG. 3e illustrates a remote reconfiguration of a module according to one embodiment of the present invention FIG. 3f illustrates a communications between a number of exemplary modules utilizing a number of communications channels according to one embodiment of the present invention.

FIG. 3g shows an exemplary relationship between a number of communication pathways and a corresponding set of channels.

FIG. 4a depicts an application including a number of modules and an interaction scheme.

FIG. 4b depicts a resolution of the communication pathways for a set of modules residing on a single device into a number of channels.

FIG. 5a depicts a component according to one embodiment of the present invention.

FIG. 5b depicts an exemplary segmentation of an application into a number of components according to one embodiment of the present invention.

FIG. 6 depicts a number of application tools including application programming interfaces and a network deployment tool according to one embodiment of the present invention.

FIG. 7 is a flow diagram that shows a process for creating a module and a number of programming elements and data structures included in a module package according to one embodiment of the present invention.

FIG. 8 depicts the structure of a module repository according to one embodiment of the present invention.

FIG. 9a depicts the structure of a module code file according to one embodiment of the present invention.

FIG. 9b is a flowchart depicting a typical series of steps executed by a initialization function 910 according to one embodiment.

FIG. 9c is a flowchart depicting a typical series of steps executed by a work function according to one embodiment of the present invention.

FIG. 9d is a flowchart depicting a typical series of steps executed by a termination function according to one embodiment of the present invention.

FIG. 10 depicts the structure of a message according to one embodiment of the present invention.

FIG. 11 depicts the structure of a configuration file according to one embodiment of the present invention.

FIG. 12a depicts the structure of a dictionary data structure according to one embodiment of the present invention.

FIG. 12b further illustrates an orientation of a dictionary data structure according to one embodiment of the present invention.

FIG. 12c illustrates a portion of an exemplary dictionary data structure generated from the configuration file described above according to one embodiment of the present invention.

FIG. 13a depicts a relationship between a number of channels and corresponding page files and a channel file according to one embodiment of the present invention.

FIG. 13b further depicts the structure of a page file according to one embodiment of the present invention.

FIG. 13c further depicts the structure of a page file according to one embodiment of the present invention.

FIG. 13d depicts a data structure for storing a WriteMsgStruct object according to one embodiment of the present invention.

FIG. 13e depicts a data structure for storing a PageStruct data object according to one embodiment of the present invention.

FIG. 13f depicts a data structure for representing a PageIndexStruct object according to one embodiment of the present invention.

FIG. 13g depicts the structure of a RecordHeaderStruct object according to one embodiment of the present invention.

FIG. 13h depicts the structure of a MasterPageStruct object for storing path and memory mapped data pertaining to a page file according to one embodiment of the present invention.

FIG. 13i depicts the structure of a MasterPageIndexStruct according to one embodiment of the present invention.

FIG. 13j depicts the organization of a page file according to one embodiment of the present invention

FIG. 14a depicts a data structure for representing a ChanIoStruct object according to one embodiment of the present invention.

FIG. 14b depicts a data structure for representing a ChannelFileStruct object according to one embodiment of the present invention.

FIG. 14c depicts the structure of a ChannelObjStruct object according to one embodiment of the present invention.

FIG. 14d depicts the structure of a ChannelFileStruct object according to one embodiment of the present invention.

FIG. 14e depicts the structure of a ChannelFileHdrStruct object according to one embodiment of the present invention.

FIG. 14f depicts the structure of a ChannelFileObjectStruct object according to one embodiment of the present invention.

FIG. 14g depicts the structure of a ChanInfoStruct object according to one embodiment of the present invention.

FIG. 14h depicts the organization of a channel file according to one embodiment of the present invention.

FIG. 15 depicts a core runtime environment package according to one embodiment of the present invention.

FIG. 16 depicts an exemplary operation of a module manager module according to one embodiment of the present invention.

FIG. 17 is a flowchart depicting various steps included in an initialization function, work function and termination function of a module manager according to one embodiment of the present invention.

FIG. 18 is a flowchart that depicts the algorithmic structure of a module starter process.

FIG. 19 schematically depicts the operation of a router module according to one embodiment of the present invention.

FIG. 20 schematically depicts the operation of a sender and receiver module 201 according to one embodiment of the present invention.

FIG. 21 depicts the operation of a multiplexer and demultiplexer module according to one embodiment of the present invention.

FIG. 22 is a flowchart depicting the work function operation of a multiplexer module according to one embodiment of the present invention.

FIG. 23 is a flowchart depicting the work function operation of a demultiplexer module according to one embodiment of the present invention.

FIG. 24 depicts the operation of a communications module according to one embodiment of the present invention.

FIG. 25 depicts the operation of a data mapper module according to one embodiment of the present invention.

FIG. 26 depicts the operation of a reference retriever module according to one embodiment of the present invention.

FIG. 27 depicts the operation of an authorization module according to one embodiment of the present invention.

FIG. 28 graphically illustrates a set of steps for the development and deployment of an application utilizing an application development and network deployment tool.

FIG. 29 graphically depicts a set of steps for the resolution of a default input channel and a default output channel by an application development and network deployment tool for modules deployed on the same host according to one embodiment of the present invention.

FIG. 30 graphically depicts a set of steps for the resolution of a default input channel and a default output channel by an application development and network deployment tool for modules deployed on separate hosts according to one embodiment of the present invention.

FIG. 31 further illustrates an exemplary deployment configuration for modules residing on separate hosts according to one embodiment of the present invention.

FIG. 32 further illustrates an exemplary deployment configuration for modules residing on separate hosts according to one embodiment of the present invention.

FIG. 33 depicts the operation of a system monitor module and channel monitor module according to one embodiment of the present invention.

FIG. 34 illustrates a traditional distributed computing paradigm.

FIG. 35 depicts a data processing system according to one embodiment of the present invention.

FIG. 36 depicts a mechanism for an exchange of data elements between program processes according to one embodiment of the present invention.

FIG. 37 depicts a paradigm for application development according to one embodiment of the present invention.

### DETAILED DESCRIPTION

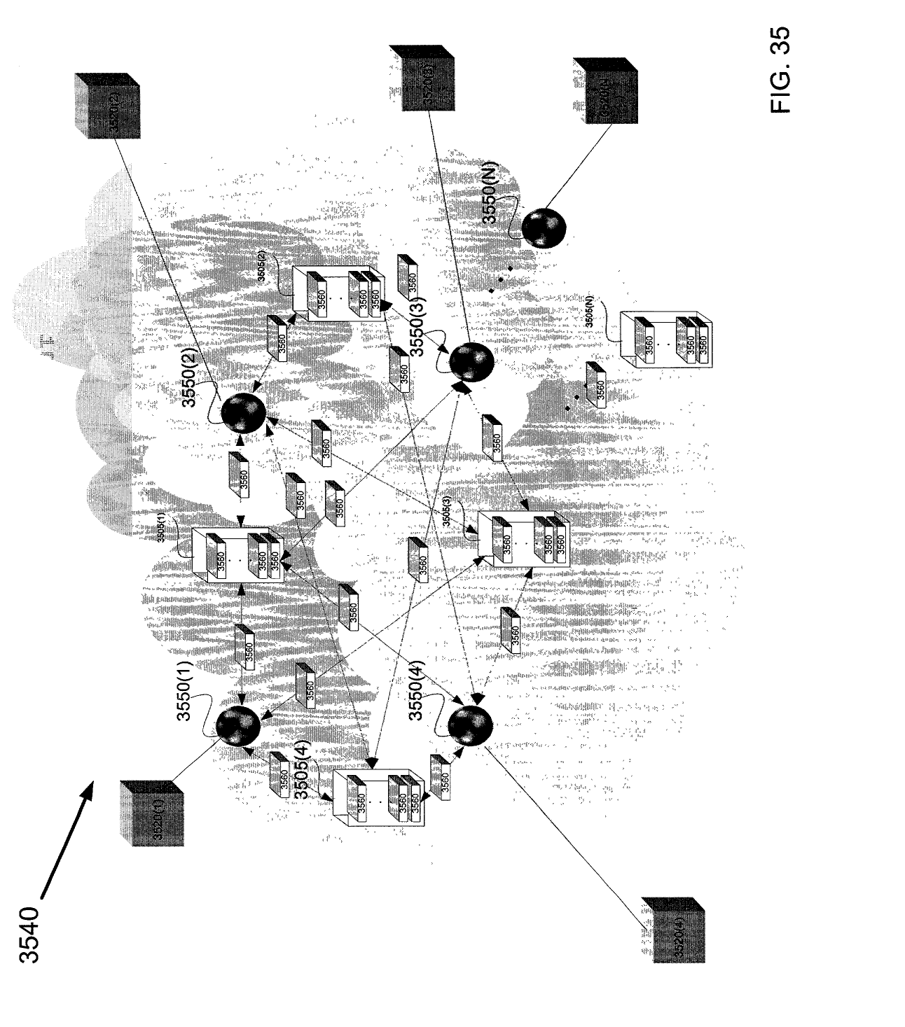

FIG. 35 depicts a data processing system according to one embodiment of the present invention. As shown in FIG. 35, data processing system 3540 includes a plurality of discrete and autonomous program processes 3550(1)-3550(N) each of which is associated with a respective configuration information 3520(1)-3520(N). Application 3540 further includes and one or more data repositories 3505(1)-3505(N). Program processes 3550(1)-3550(N) are autonomous in that they each perform a discrete functional behavior. According to one embodiment of the present invention, program processes 3550(1)-3550(N) are modules, the structure and function of which are described in detail below.

Each program process 3550(1)-3550(N) is capable of generating destinationless data elements 3560, which are generic in nature. Data repositories 3505(1)-3505(N) function to receive and store data elements 3560 generated by program processes 3550(1)-3550(N). Furthermore, program processes 3550(1)-3550(N) may read data elements 3560 from data repositories 3505(1)-3505(N) as described in detail below. According to one embodiment of the present invention, data repositories 3505(1)-3505(N) are channels, the structure and function of which are described in detail below.

In order to achieve an exchange of data elements 3560 between program processes 3550(1)-3550(N), the configuration information 3520(1)-3520(N) for each program process 3550(1)-3550(N) may associate a program process with one or more data repositories 3505(1)-3505(N) in either a read or write configuration. That is, certain program processes 3550(1)-3550(N) may be associated with particular data repositories 3505(1)-3505(N) for reading data elements. Certain program processes 3550(1)-3550(N) may be associated with particular data repositories 3505(1)-3505(N) for writing data elements. The application is made operative through the combination of the autonomous behavior of each program process 3550(1)-3550(N) and an exchange of data elements 3560 between program processes via data repositories 3505(1)-3505(N).

Note that the exchange of data elements 3560 between program processes 3550(1)-3550(N) is achieved through an association of modules with data repositories 3505(1)-3505(N) in either a read or write capacity and does not rely upon a centralized controller. Further, because program processes 3550(1)-3550(N) are autonomous and incognizant of other program processes and therefore exchange of data elements 3560 is not achieved by a coupling of program processes 3550(1)-3550(N) either in a coding or runtime stage. Instead, the exchange of data between program processes 3550(1)-3550(N) is achieved by the combined individual functional operation of each program process 3550(1)-3550(N) and the read/write behavior of each program process with respect to data repositories 3505(1)-3505(N), which collectively function as a conduit for an exchange of data elements 3560.

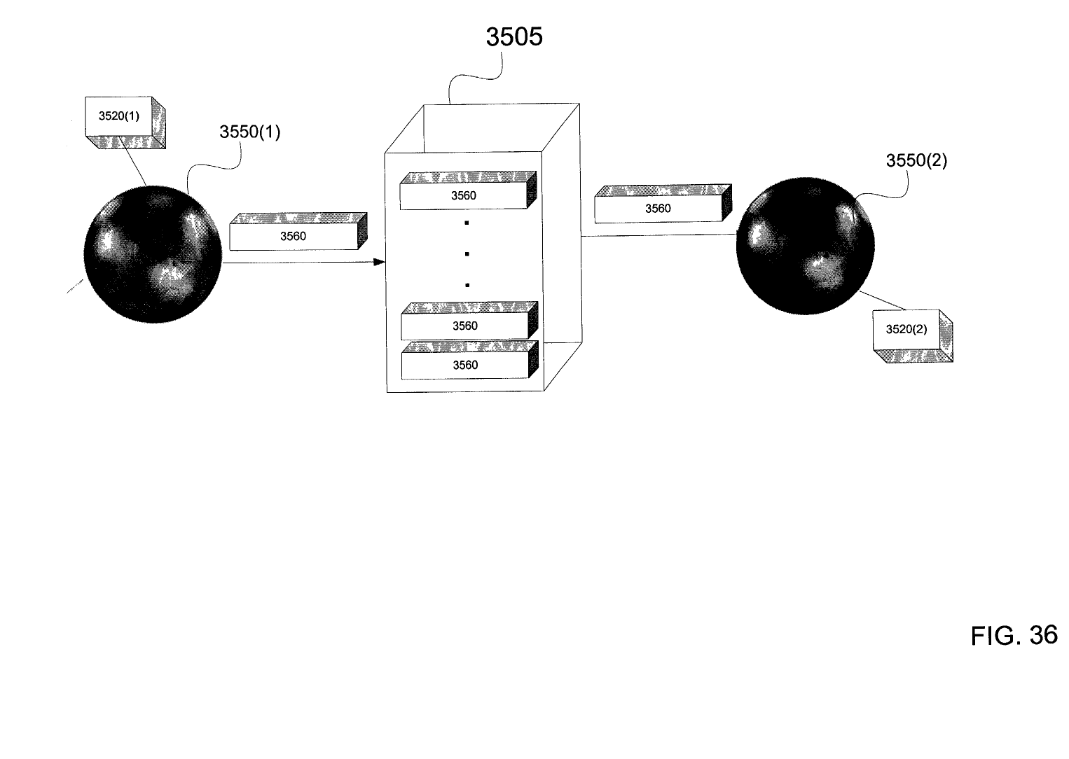

FIG. 36 depicts a mechanism for an exchange of data elements between program processes according to one embodiment of the present invention. As shown in FIG. 36, program process 3550(1) is configured via configuration information 3520(1) to write data elements 3560 to data repository 3505. Program process 3550(2) is configured via configuration information 3520(2) to read data elements 3560 from data repository 3505. Thus, program processes 3505(1) and 3505(2) are configured to exchange data elements 3560 via configuration information 3520(1) and 3520(2). Note, however, that the simple data flow depicted in FIG. 36 could easily be altered, for example, by changing the configuration information 3520(1) for program process 3550(1) to read data elements 3560 from data repository 3550 and changing the configuration information 3520(2) for program process 3550(2) to write data elements 3560 to data repository. In this way, data elements would effectively flow in the reverse direction than what is shown. Also, note that configuration information 3520(1)-3520(2) is decoupled from the actual functional behavior of program processes 3550(1)-3550(2) such that the data flow may be reconfigured independently of the coding of.

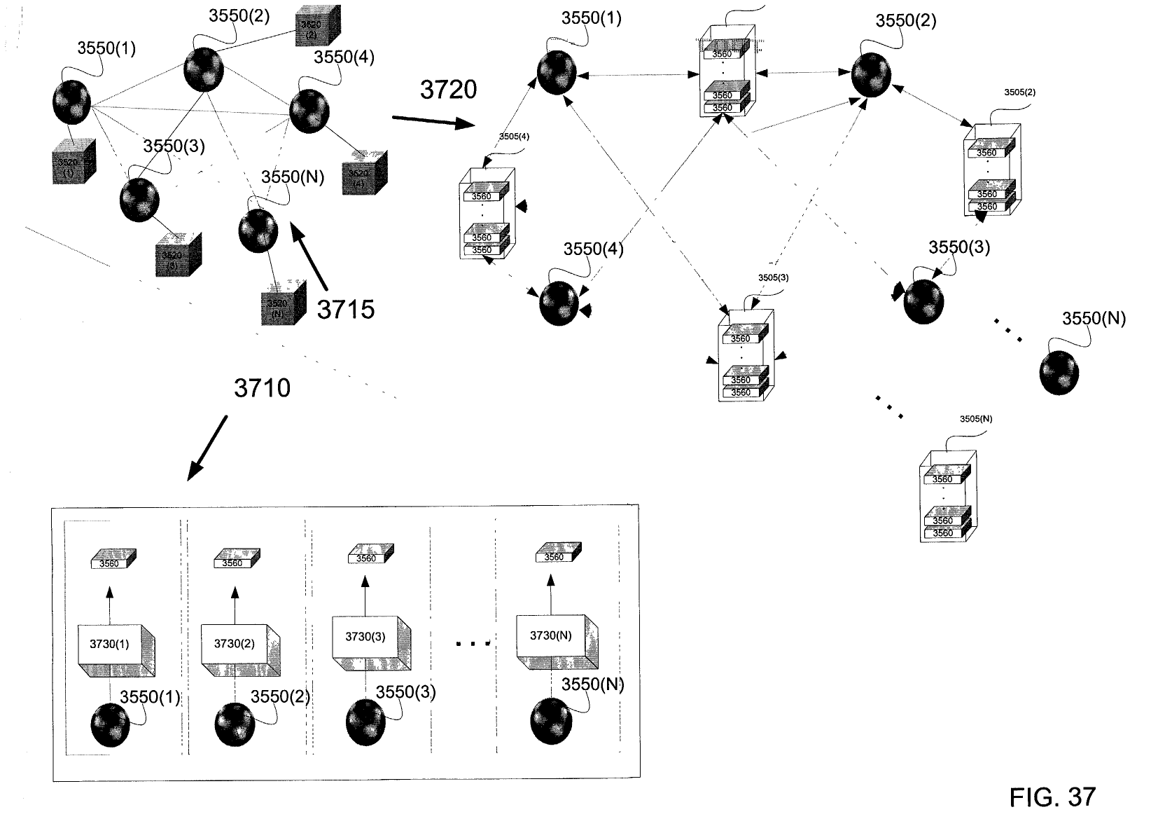

FIG. 37 depicts a paradigm for application development according to one embodiment of the present invention. Note that according to the paradigm, behavior development 3710 is decoupled from communication development 3720. In particular, in coding step, a plurality of modules program processes 3450(1)-3550(N) are defined. Program processes 3550(1)-3550(N) each perform a program task (respectively 3730(1)-3730(N)) and have capability for the generation of destinationless data elements 3560. According to one embodiment of the present invention, program processes 3550(1)-3550(N) are modules and data repositories 3505(1)-3505(N) are channels, the structure and function of which are described in detail below. Data elements 3560 generated by program processes 3550(1)-3550(N) are characterized as being destinationless (i.e., program processes 3550(1)-3550(N) do not generate data elements 3560, which are pre-defined to be received or consumed by other particular program processes 3550(1)-3550(N)). According to one embodiment, data elements 3560 are messages the structure and function of which are described in detail below. Moreover, according to the programming paradigm of the present invention, program processes 3550(1)-3550(N) are not made cognizant of the existence or operation of other program processes 3550(1)-3550(N).

During assembly step 3715, program processes 3550(I)-3550(N) are associated with message repositories 3505(1)-3505(N) in such a way to define one or more communication pathways between program processes 3550(1)-3550(N). According to one embodiment of the present invention, during assembly step 3715, the definition of communication pathways between program processes 3550(1)-3550(N) is reflected in configuration information 3520(1)-3520(N) for each program process.

In deployment step 3720, a plurality of data repositories 3405(1)-3405(N) are created as a function of configuration information 3520(1)-3520(N). Further, during deployment step 3720, program processes 3550(1)-3550(N) are associated with data repositories 3405(1)-3405(N) in one of a read and write capacity as a function of configuration information 3720(1)-3720(N) defined for each program process 3550(1)-3550(N) in assembly step 3715.

Note that data elements 3560 generated by program processes 3550(1)-3550(N) are not directed to a particular recipient (they are destinationless) and therefore do not refer to a destination program process. Data elements 3560 generated by a particular program process 3550(1)-3550(N) are simply written to a particular message repository 3505 associated with the program process 3550 and may be consumed (read) by other program processes 3550 by associating particular program processes 3550 to perform a read function with respect to the data repository 3505 to which the data elements are written.

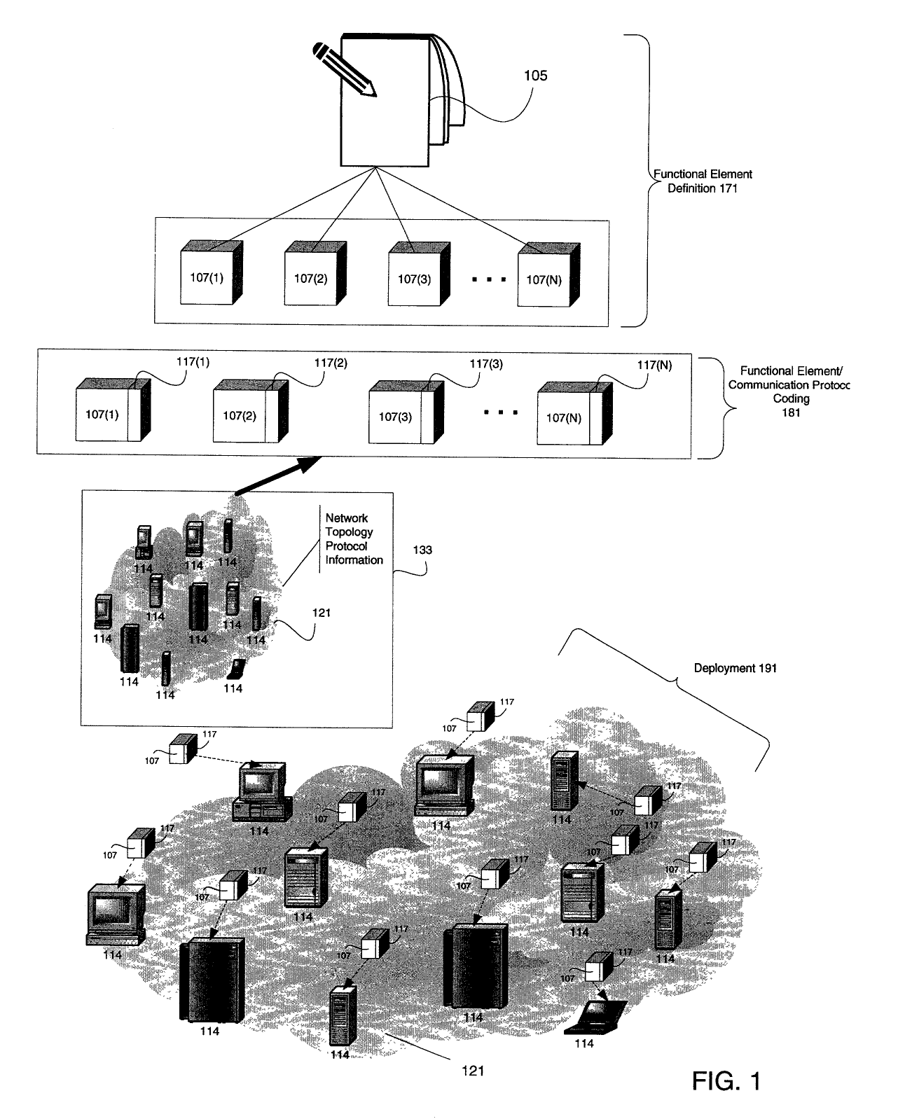

FIG. 1, which is prior art, illustrates a traditional application development environment. As shown in FIG. 1a, the development process is initiated with application specification 105, which sets forth a desired overall function and operation of an application. For example, application specification 105 may provide desired overall behavior of the application, required outputs, available inputs, performance specifications such as timing requirements, available processing resources, required processing efficiency with respect to CPU load, etc. In step 171, application specification 105 is analyzed to generate one or more functional elements 107(1)-107(N), which collectively operate in conjunction to achieve the desired behavior specified by application specification 105. Functional elements 107 may represent various programming classes or functions.

Note that the generation of particular functional elements 107 from application specification 105 is determined based upon network topology/protocol information 133. That is, the determination of particular functional elements 107 and their relationship to one another is based at least in part on consideration of a network topology 121 where the application is to be deployed and the various protocols resident within the network topology 121. As shown in FIG 1a, network topology information 133 includes data regarding a number of host processing devices 114 and the manner in which they are coupled together within network topology 121. In particular, provided a knowledge of network topology 121, functional elements are designed to collectively operate within network topology 121 and the determination of a set of functional elements 107 is typically designed to be deployed in a particular configuration within network topology.

Thus, with conventional application developments such as that depicted in FIG. 1, the developer is typically required to perform application development simultaneously or in conjunction with design of deployment of the application within network topology 121. The design limitation is illustrated in step 181 in which each of the defined functional elements 107 is coded to generate a corresponding functional code element 110 and a required communications/protocol code element 117. Functional code element 110 includes code designed to carry out the intended function of the functional element 107. Communication/protocol code element 117 is designed to perform communications and/or protocol negotiation with other functional elements 107 generated from application specification 105.

In step 191, functional code elements 110 and associated communication/protocol code element 117 are deployed within network topology 121. That is, functional code elements 110 and associated communication/protocol element 117 are installed on particular processing hosts 114 within network topology. Note that communication/protocol elements 117 allow for communication between functional elements 107 within network topology 121 and are each designed for the particular configuration in which functional elements 107 are deployed within network topology 121. However, note that if variations in network load, load faults or other temporal variations required redesign and/or redistribution of the application within network topology 121, communication protocol elements 117 and potentially functional code elements 110 would require redesign for adaptation to the new configuration. This redesign would typically require substantial design cycle time.

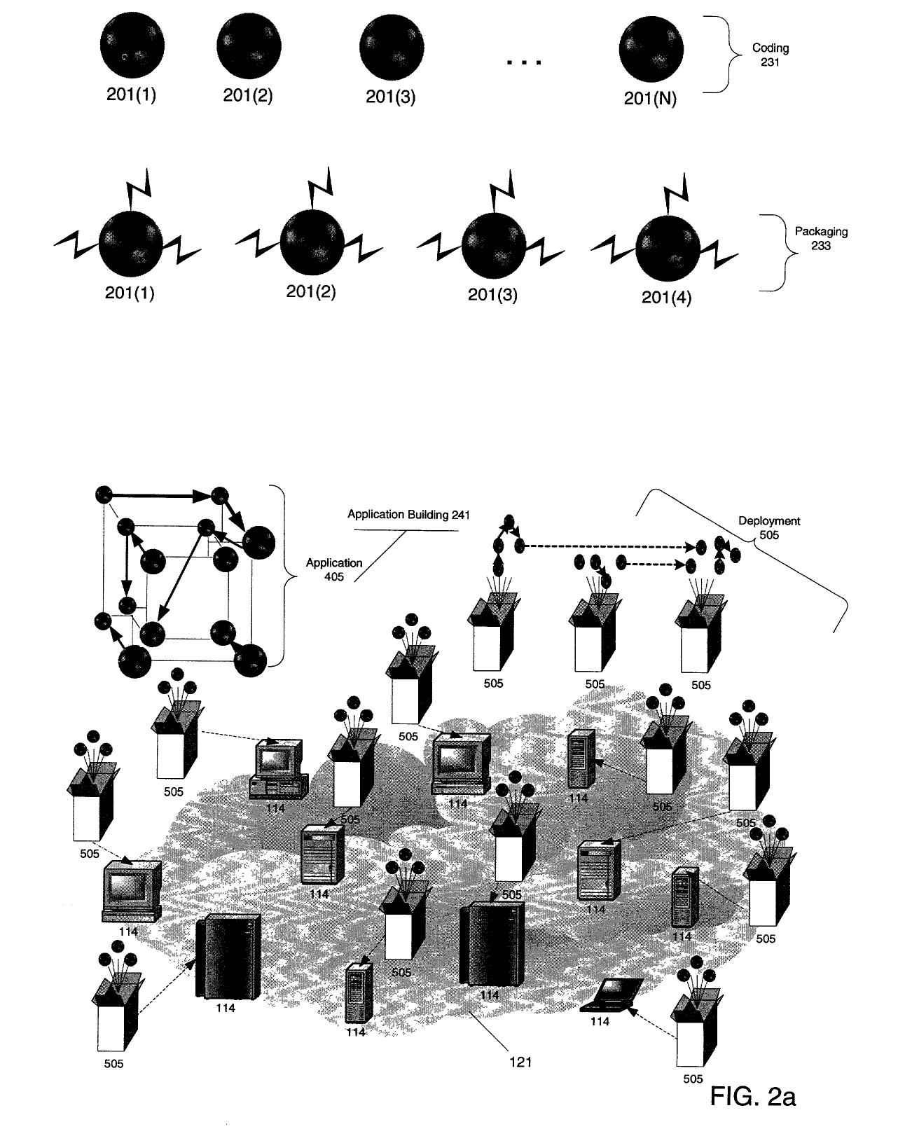

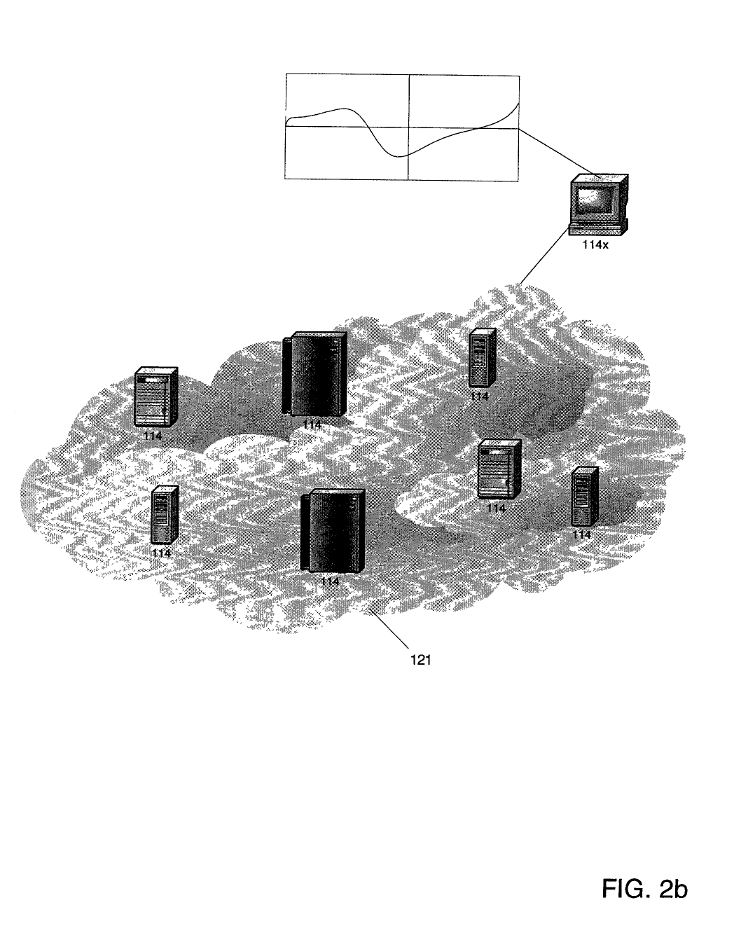

FIG. 2a illustrates an application design paradigm and methodology according to one embodiment of the present invention. According to one embodiment of the present invention, application development includes a coding step 231, a packaging step 233, an application build step 241 and a deployment step 251. In coding step 231, application specification 105 is analyzed to generate one or more modules 201. During coding step 231, the application developer defines one or more modules (201(1)-201(1)), which function as discrete entities each performing a behavior. The generation of a module 201 and its structure will become evident as the invention is further described. However, it should be noted that each module 201 is an automaton processing the capability of responding to a stimulus or reacting independently of any centralized controller. The collective behavior of all modules 201(1)-201(N) achieves the desired behavior and functionality specified in application specification 105.

During coding step 231, the application developer may provide the code to effect the logical behavior of each module 201 to be included within an application 405. During coding step 231, the application developer relies upon the assumption of an interaction between modules 201, which may be achieved by the delivery/consumption of messages between modules 201. During coding step 231, the application developer utilizes one or more APIs (“Application Programming Interfaces”) to determine the operation and behavior of each module 201. In particular, APIs provide a multitude of function calls that may be embedded in a module's code to effect a desired behavior.

In packaging step 233, the application developer may define and describe various parameters relating to potential interaction between modules 201 such as the delivery/consumption of messages by particular modules 201 over defined or known pathways. During packaging step 233, the application developer may define active pathways and messages used within the code to facilitate application build step 241. During packaging step 231, the application developer may also define restrictions on module interaction. Packaging step 233 also allows the application developer to define properties of files being packaged (i.e., operating system compatibility, versioning, compiler compatibility, etc.).

Packaging step 233 importantly serves to define a set of associated physical files—each with associated compatibility properties required fro smart deployment. Packaging step 233 also allows specification of information pertaining to versioning and change-control.

In application building step 241, the application developer defines an application 405. Application 405 defines an aggregate of modules 201, each module 201 exhibiting a specific functional behavior and an interaction scheme defining how modules 201 may interact (this interaction may be a function of message exchange) in application 280. According to one embodiment of the present invention, an interaction scheme may be defined by delineating one or more communications pathways between modules 201. These communications pathways define a conduit for an exchange of messages between modules 201 upon deployment. Mechanisms for interaction and exchange of messages between modules 201 are described in detail below. During application building step 241, various parameters may be adjusted to customize runtime behavior of modules 201(1)-201(N) and their interaction. Note that during application building step 241, the defined interaction scheme between modules 201(1)-201(N) is allowed or restricted by the packaging options defined in packaging step 233.

Note that during coding step 231, packaging step 233 and application building step 241 the developer is required only to focus on the logical and data flow aspects of modules 201 and their interaction to produce a desired behavior of application 405. The application developer is not required to consider network, protocol or deployment issues relating to a computing environment topology 121 in which application 405 will be deployed.

In deployment step 251, application 405 is deployed and configured within a computing environment 121. Computing environment 121 may be a network or any generalized collection of processing entities or (e.g., hosts 114) sharing communication means. In particular, the plurality of modules 201 included within application 405 are distributed to one or more hosts 114 included within computing environment 121. During deployment step 251, the interaction scheme designed in application building step 241 is preserved although modules 201 included within application 405 may be distributed among multiple hosts 114 throughout computing environment 121. For example, and as described in detail below, during deployment step 251, communications pathways between devices are upheld via auto-deployment of facilitator modules such as sender and receiver modules 201 that may transfer messages across hosts 114 (described below). The structure and function of sender and receiver modules 201 will become evident as the invention is further described. As a preliminary step in deployment step 251, according to one embodiment, the application developer defines one or more components 505 from application 405. A component 505 defines one or more modules 201 designated to reside on a single host 114. Components 505 are then deployed on respective hosts 114 within computing environment 121. The structure and function of components 505 is described in detail below.

FIG. 2b illustrates a runtime monitoring function provided by the present invention. During runtime of an application 405, a monitor host 114x may perform monitoring of application performance and generate various text or graphical reports relating to the performance. For example, runtime host 114 may generate reports relating to machine up time, number of users, average load, number of processes (running/sleeping), etc.

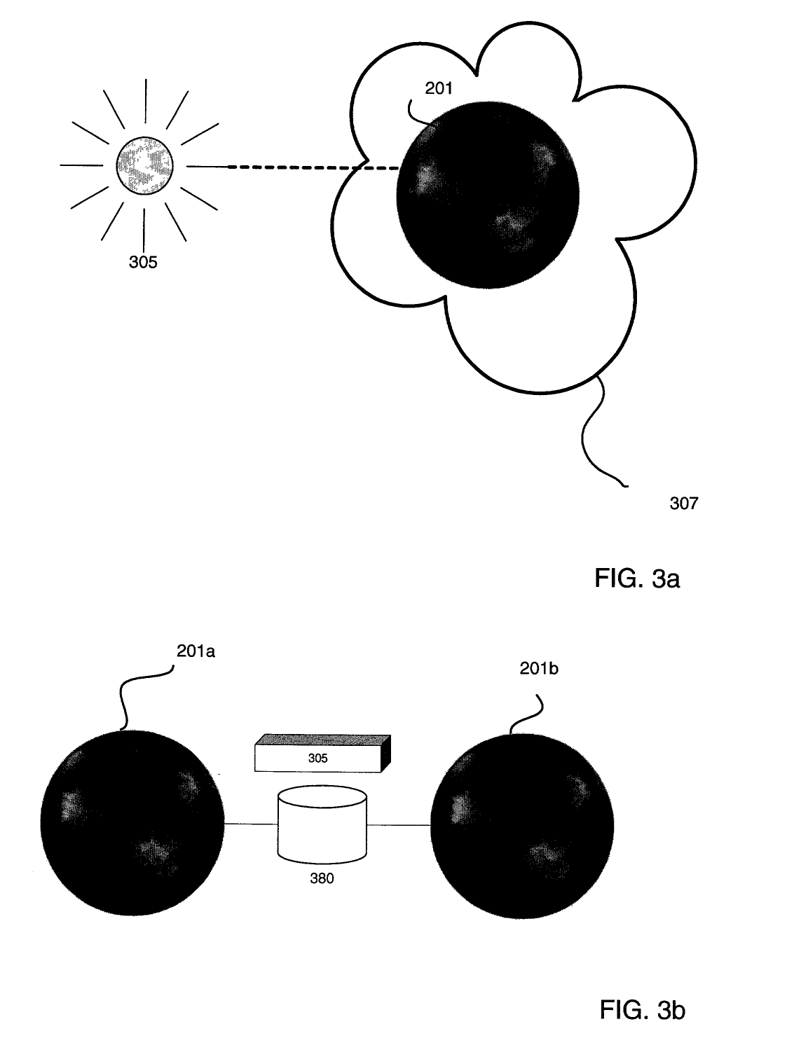

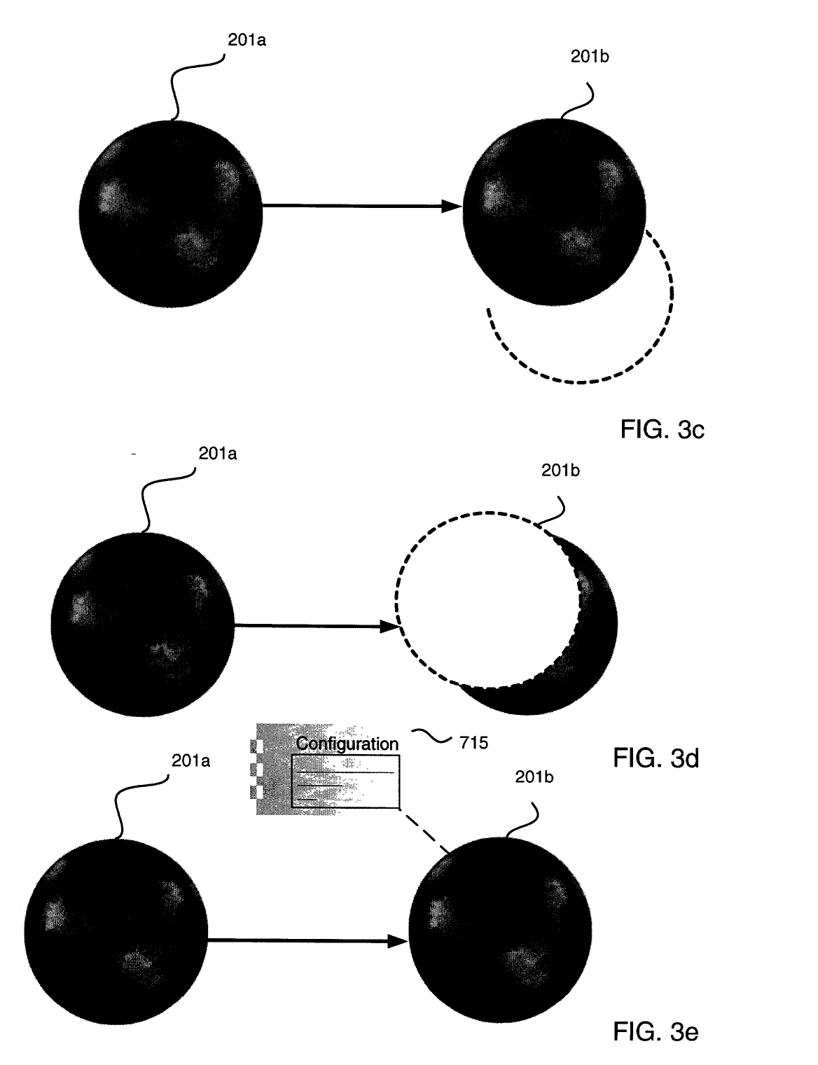

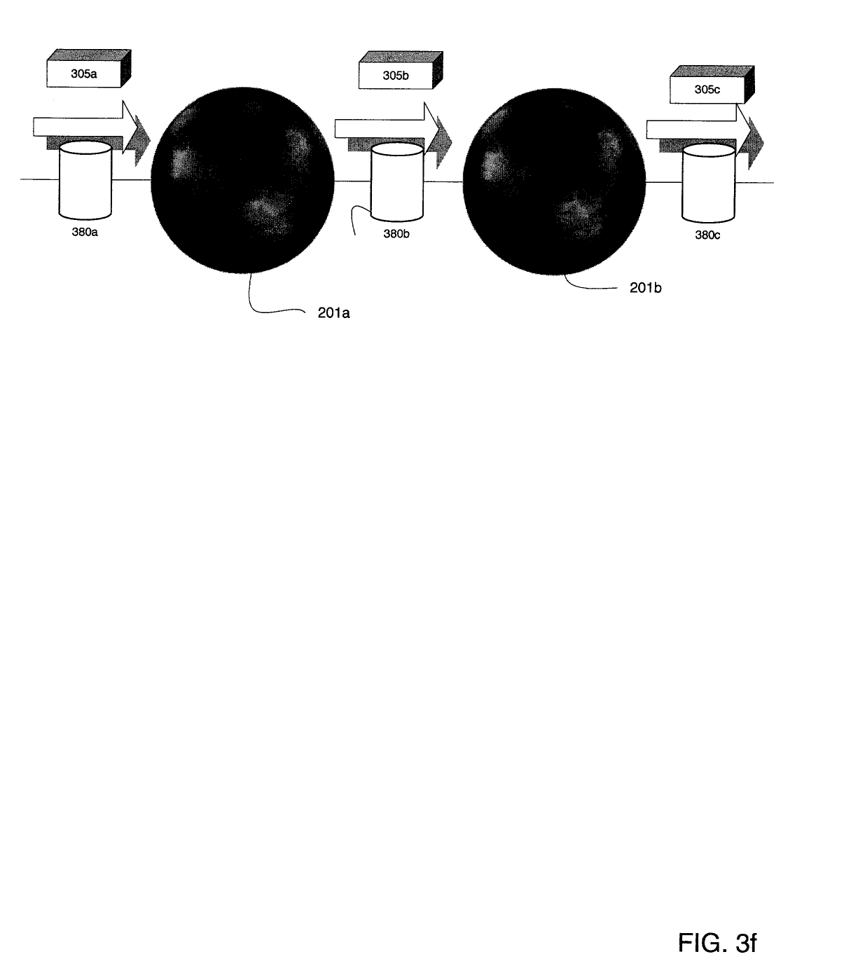

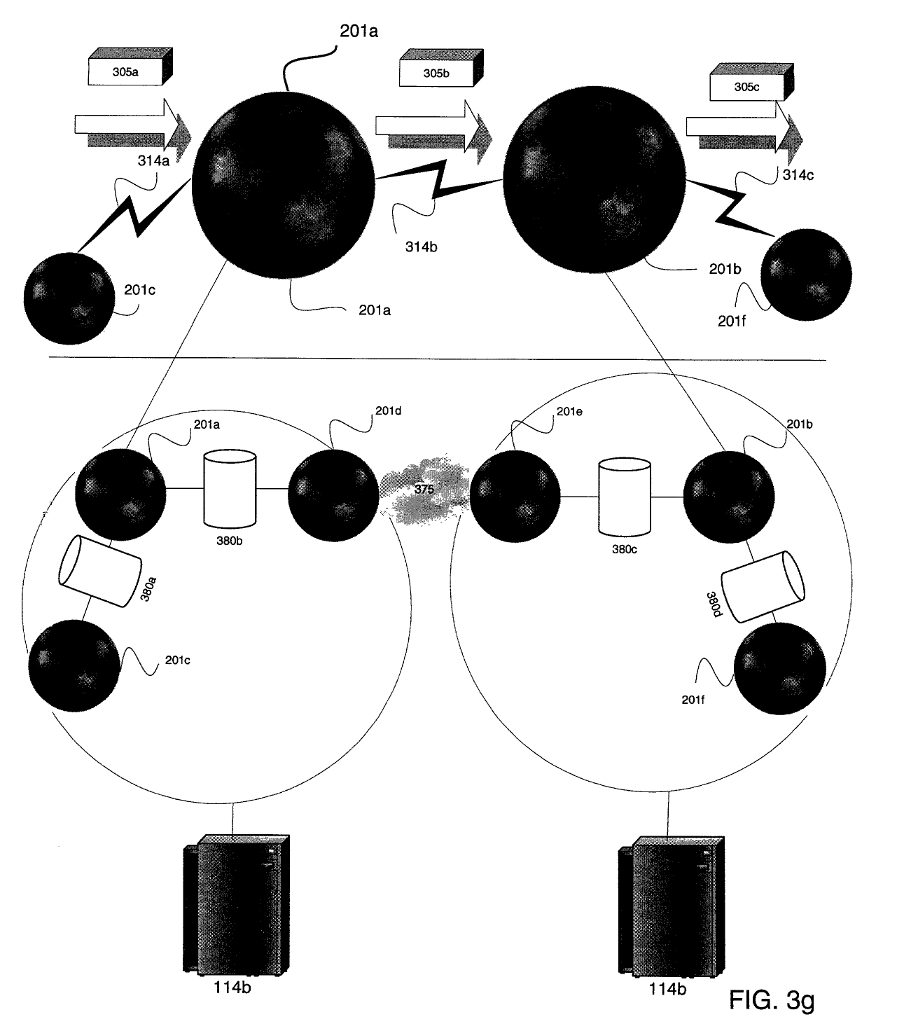

FIGS. 3a-3e illustrate various attributes, behaviors and functionalities associated with modules 201 according to one embodiment of the present invention. In particular, modules 201 exhibit a functional behavior possibly in response to a stimulus. Furthermore, modules 201 may interact with one another over a communications channel utilizing messages. Modules 201 may also exhibit remote control over one another to perform such functions as initialization, termination and reconfiguration.

FIG. 3a illustrates an operation of a module according to one embodiment of the present invention. Module 201 receives as input stimulus 305 and produces behavior 307 as output. As will become evident as the invention is further described, stimulus 305 may be messages representing self-describing data, requests for processing, events or signals, data files, executable code or some other signal received by module 201. Thus, modules 301 may generate stimulus 305, which affects other modules 301. Stimulus 305 may a self-describing message, an input variable, vector or some other signal. Methods for exchange of messages 305 between modules 201 will become evident as the invention is further described. Stimulus 305 may be an output variable, vector or other signal generated by module 201 itself, in which case module 201 would be arranged in a feedback configuration. Typically behavior 307 is realized as a result of some processing performed by module 201, typically as a function of stimulus 305. However, it should be noted that according to one embodiment, module 201 might not receive a stimulus 305 at all. However, such a module 201 decoupled from a stimulus 305 may still exhibit a behavior as a function of processing, such as processing based upon internal data or variables decoupled from an external stimulus 305.

Note that it is also possible for the input stimuli 305 to come from a module-internal source, e.g., the basis for the processing done by the module 201 may be internal data or variables.

FIG. 3b illustrates a relationship between a first module, a second module and a message according to one embodiment of the present invention. Referring to FIG. 3b, module 201a generates message 305 and transmits it to module 201b over channel 380. The structure and function of messages 305 and channels 380 will become evident as the invention is further described.

FIGS. 3c-3e illustrate various remote control functions carried out by a module according to one embodiment of the present invention. As will become evident, as the invention is further described modules 201 may reside on a particular host 114, but may exist in a dormant or active state. It may be desirable, for example, to perform activation, termination of a module on a dynamic basis, for example, based upon temporal variations within computing environment 121 such as changes within network load, etc. For example, FIG. 3c shows module 201a causing remote initialization of module 201b according to one embodiment of the present invention. FIG. 3d shows module 201a causing remote termination of module 201b according to one embodiment of the present invention. Each module 201 is associated with a configuration file 715 that stores various default attributes related to the module 201. For example, configuration file 715 may store parameters such as a default input channel from which a module 201 will write. Configuration file 715 may include a myriad of other internal variables and vectors necessitated to carry out the processing, initialization or termination functions associated with the module 201. An exemplary configuration file structure is described in detail below.

FIG. 3f illustrates a communications between modules utilizing a number of channels according to one embodiment of the present invention. In particular, as shown in FIG. 3f, module 201a transmits messages 305b to module 201b via message pathway 380b. Module 201a receives messages 305a via channel 380a. Although FIG. 3f depicts only two modules (201a-201b), it is assumed that module 201a receives messages 305a via channel 380a from one or more other modules 201 not shown in FIG. 3f. Similarly, module 201b transmits messages 305c via channel 380c to one or more other modules 201 not shown in FIG. 3f. The structure and function of channels 380 and messages 305 will become evident as the invention is further described.

During application building step 241, the application developer defines one or more communication pathways between modules 201 as a function of parameters defined in packaging step 233. Communication pathways define an interaction between modules 201 included in an application. During deployment step 251, communication pathways are ultimately resolved into channels 380, which are a physical realization for effecting interaction between modules 201. During

FIG. 3g shows an exemplary relationship between a number of communication pathways and a corresponding set of channels. In particular, during application building step 241 communication pathway 314a is defined between modules 201c and 201a, communication pathway 314b is defined between modules 201a and 201b and communication pathway 314c is defined between module 201b and module 201f. This definition of communication pathways 314 defines the intention for messages 305a to be transmitted between modules 201c and 201, messages 305b to be transmitted between modules 201a and 201b and messages 305c to be transmitted between modules 201b and 201f.

According to one embodiment of the present invention, a communications pathway 314 defined in application build step 241 is ultimately resolved into one or more channels 380, which are a physical realization of an interaction between modules 201. The structure and function of a channel 380 will become evident as the invention is further described. In some circumstances, such as where two modules 201 reside on a single host 114, a one-to-one correspondence may be established between a communication pathway 314 and a channel 380. For example, referring to the bottom half of FIG. 3g, communication pathway 314a between modules 201c and 201a, which reside on a single host 114a, is resolved into channel 380a. Similarly, message pathway 314c between modules 201b and 201f, which reside on a single host 114b, is resolved into channel 380d.

However, if a communication pathway 314 is defined between two modules 201 that reside on separate hosts 114, the communication pathway 314 may be resolved into multiple channels 380. For example, note that communication pathway 314b is defined between modules 201a and 201b, which reside on separate respective hosts 114a and 114b. Message pathway 314b between modules 201a and 201b is effected utilizing channels 380b and 380c, communications modules 201d and 201e and communications interface 375. The resolution of a communication pathway 314 into channels 380 is described in detail below.

According to one embodiment of the present invention, each module 201 may be associated with a default input channel 380 and a default output channel 380, which is typically defined in the module's configuration file 715. According to this embodiment, to establish a communication pathway 314 between a first module 201 and a second module 201, the default input channel 380 of the first module 201 is set to the default output channel 380 of the second module.

According to one embodiment, the physical realization of channel 380 is established using a disk or memory based (e.g., RAM) queue data structure. Exemplary implementations of channels 380 will become evident as the invention is further described.

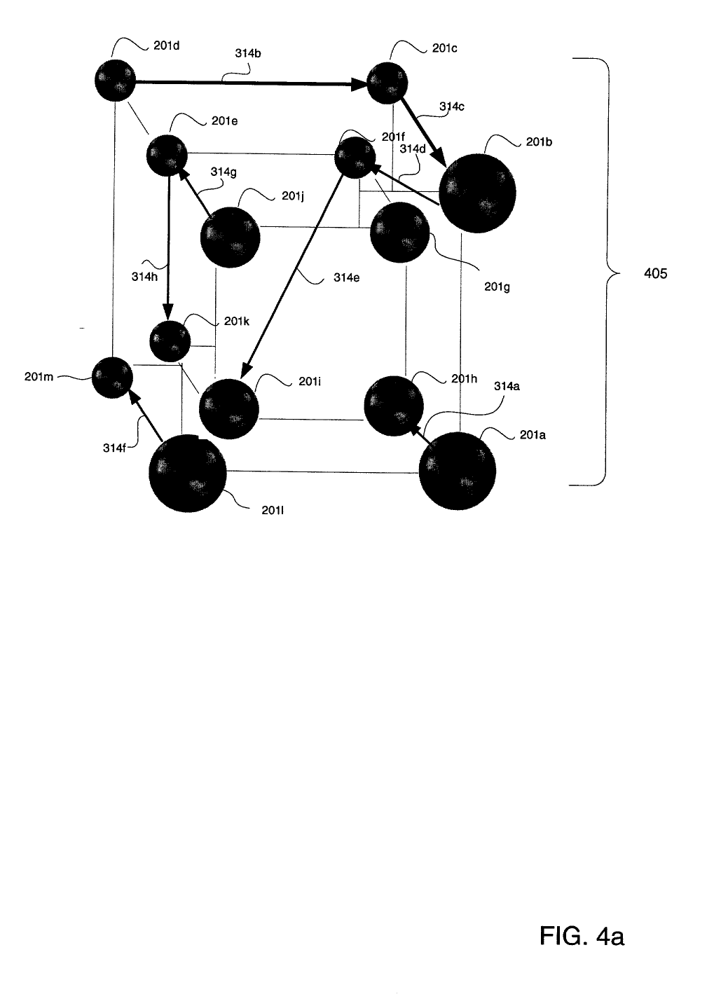

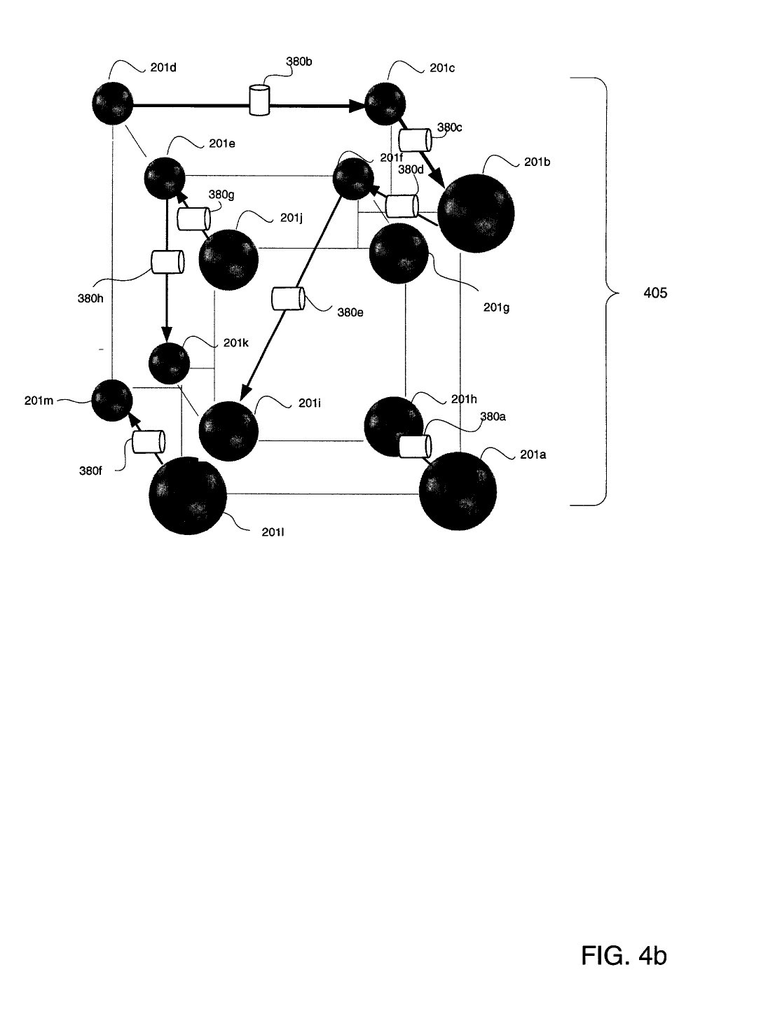

FIG. 4a depicts an application including a number of modules and an interaction scheme. As described above, during application building step 241, the application developer determines the modules 201 to be included within application 405 and generates an interaction scheme, which determines how modules 201 will interact with one another. According to one embodiment of the present invention, the application developer defines an interaction between two modules by establishing a communication pathway 314 between them. Communication pathway 314 represents a placeholder that modules 201 will interact during runtime. Ultimately, communication pathway 314 is resolved into one or more channels 380 during deployment step 251. Interaction of modules 201 includes exchanges between them via messages 305, which may include any combination of self-described data, requests for action, a signal event, executable code, reference to a file.

In particular, referring to FIG. 4a, module 201a interacts with module 201h via communication pathway 314a, module 201d interacts with module 201c via communication pathway 314b, module 201c interacts with module 201b via message pathway 314c, module 201b interacts with module 201f via communication pathway 314d, module 201f interacts with module 201i via communication pathway 314e, module 2011 interacts with module 201m via communication pathway 314f, module 201j interacts with module 201e via communication pathway 314g, and module 201e interacts with module 201k via communication pathway 314h.

As described above with respect to FIG. 3g, note that the communication pathways are ultimately resolved into one or more channels 380 as a function of a deployment configuration defined by the developer. FIG. 4b depicts a resolution of the communication pathways established in FIG. 4a for a set of modules 201 residing on a single device into a number of channels 380. In particular, as shown in FIG. 4b, message pathways 314a-314f are resolved into respective channels 380a-380f. In order to establish an interaction scheme between a number of modules 201 such as the exemplary applications shown in FIG. 4a-4b, appropriate default input and output channels 380 for each module 201 in the application 405 are set to establish the interaction scheme. For example, in order to establish the interaction scheme for application 405 shown in FIGS. 4a-4b, the following relationship between default input channels of modules 201a-2011 is established:

| Module | Default Input Channel | Default Output Channel |
|---|---|---|
| 201a | X | 380a |
| 201b | 380c | 380d |
| 201c | 380b | 380c |
| 201d | X | 380b |
| 201e | 380g | 380h |
| 201f | 380d | 380e |
| 201g | X | X |
| 201h | 380a | X |
| 201i | 380e | X |
| 201j | X | 380g |
| 201k | 380h | X |
| 201l | X | 380f |
| 201m | 380f | X |

Upon completion of application building step 241, a deployment step 251 is commenced in which the application 405 is deployed to computing environment 121. In particular, the plurality of modules 201 included within application 405 are distributed to one or more hosts 114 included within computing environment 121. During deployment step 251, the interaction scheme designed in application building step 241 is preserved although modules 201 included within application 405 may be distributed among multiple hosts 114 throughout computing environment 121. For example, and as described in detail below, during deployment step 251, communication pathways 314 between modules spanning separate hosts 114 are upheld via auto-deployment of facilitator modules such as sender and receiver modules 201 that may transfer messages across hosts 114 (described below). The structure and function of sender and receiver modules 201 will become evident as the invention is further described. As a preliminary step in deployment step 251, according to one embodiment, the application developer defines one or more components 505 from application 405. A component 505 defines one or more modules 201 designated to reside on a single host 114. Components 505 are then deployed on respective hosts 114 within computing environment 121. The structure and function of components 505 is described in detail below.

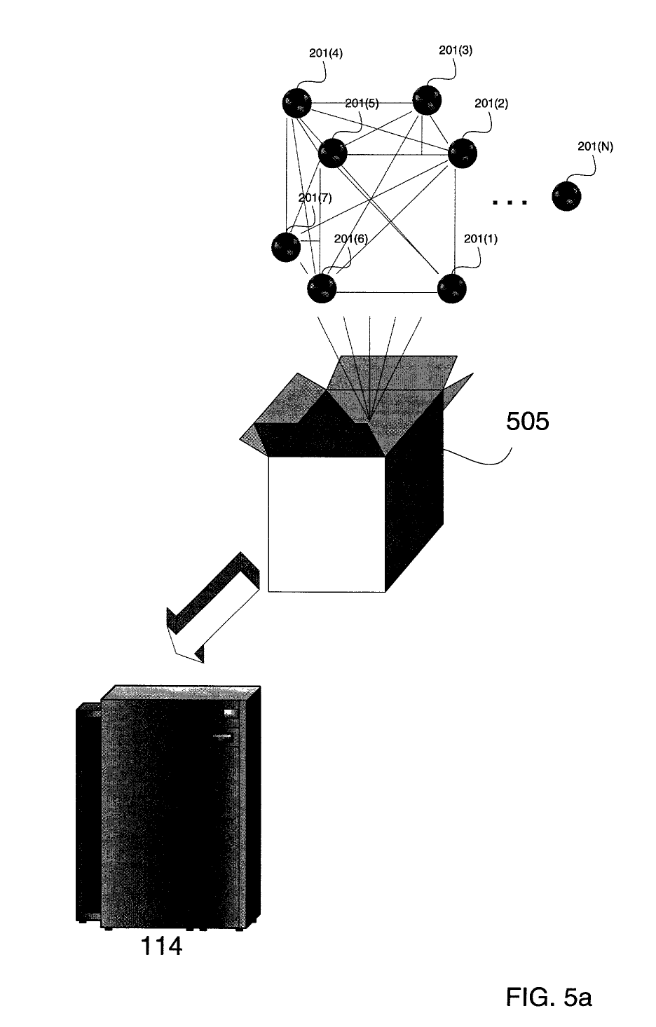

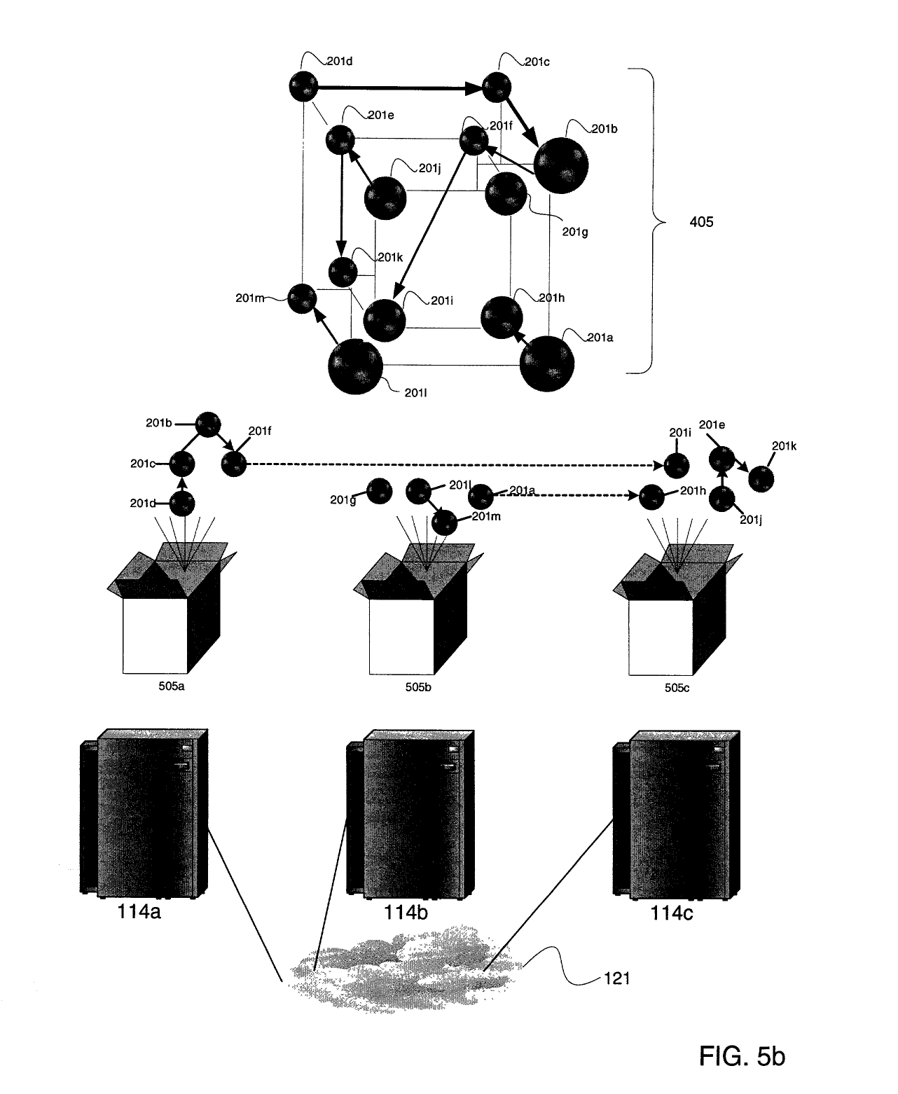

FIG. 5a depicts a component according to one embodiment of the present invention. Component 505 represents a logical grouping of one or more modules 210 to be deployed on a single host 114. Thus, as shown in FIG. 5a, component 505 includes a logical grouping of one or more modules 210(1)-210(N) to be deployed on host 114.

FIG. 5b depicts an exemplary definition of a number of components from an application according to one embodiment of the present invention. For consistency, FIG. 5b shows a component definition based upon the same application interaction scheme exemplified in FIG. 4a. Referring to FIG. 5b, as described above, application 405 includes modules 201a-201m and an interaction scheme, which defines how modules 201 may interact with one another. FIG. 5b shows segmentation of application 405 into three components 505a-505c, which are to be deployed respectively on hosts 114a-114c. Hosts 114a-114c are coupled together via a computing environment 121, which may be a network. Component 505a includes modules 201d, 201c, 201b and 201i, component 505b includes modules 201g, 2011, 201m and 201a and component 505c includes modules 201i, 201e, 201h, 201j and 201k. Note that segmentation of application 405 into components 505a-505c does not require inclusion of all interacting modules 201 within a single component 505 (i.e., to be deployed on a single host 114). For example, module 201f interacts with module 201i, yet module 201f and module 201i are assigned to separate components, namely 505a and 505c respectively and are therefore to be deployed on hosts 114a and 114c respectively. As will be described below, preservation of interaction between interacting modules 201 deployed on separate hosts may be effected utilizing specialized sender, receiver, multiplexer and/or demultiplexer modules 201 (described below).

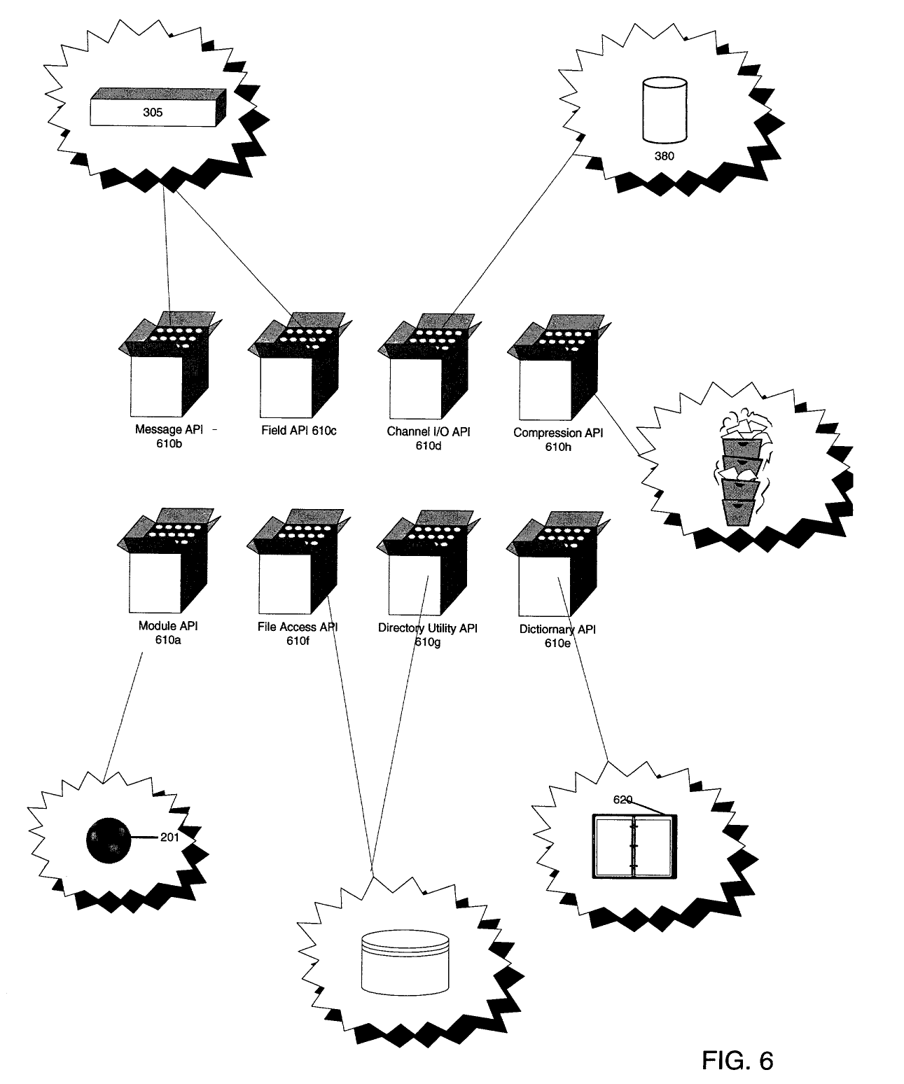

According to one embodiment, the present invention provides a number of APIs for application development. FIG. 6 shows module API 610a, message API 610b, Field API 610c, channel I/O API 610d, dictionary API 610e, file access API 610f, directory utility API 610g and compression API 610h. Each API includes a plurality of function calls for controlling various aspects of an application 405 including messaging, etc. During coding step 231, the application developer may utilize any function calls defined by particular APIs to control various aspects of the application 405. APIs 610a-610h provide functionality for initializing and controlling various elements of an application 405 including modules 201, channels 380, messages 305, etc.

Module API 610a provides functionality for initializing, controlling, and terminating modules 201. In particular, module API 610a provides an interface for module programming. Message API 620 provides functionality for initializing messages 305, reading messages. Field API 610c provides further functionality related to messages 305 including. Channel I/O API 610d provides functionality for reading and writing to channels. Channel I/O API 610d provides a framework for opening and creating channels and associating names with them including sending and receiving messages on different channels. Specific functionality provided by channel I/O API 610d will become evident as the structure and function of channels is developed herein. Dictionary API 610e provides functionality for initializing and maintaining a data structure referred to herein as a dictionary 620. A dictionary 620 provides a container for storing and parsing configuration data related to a particular module 201. The structure of a dictionary 620 will become evident as the invention is further described. File access API 610g and directory utility API 610h provide functionality for reading, writing and performing other maintenance tasks for simple data files. Compression API 610h provides functionality for compressing and decompressing files.

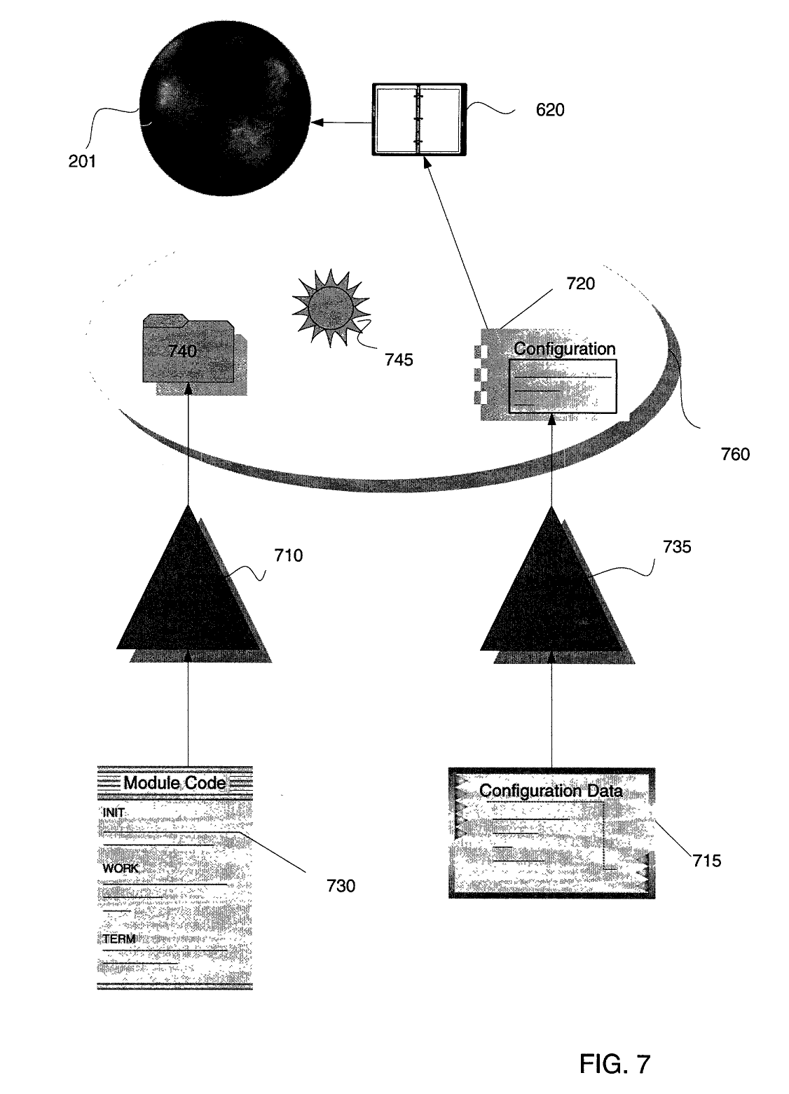

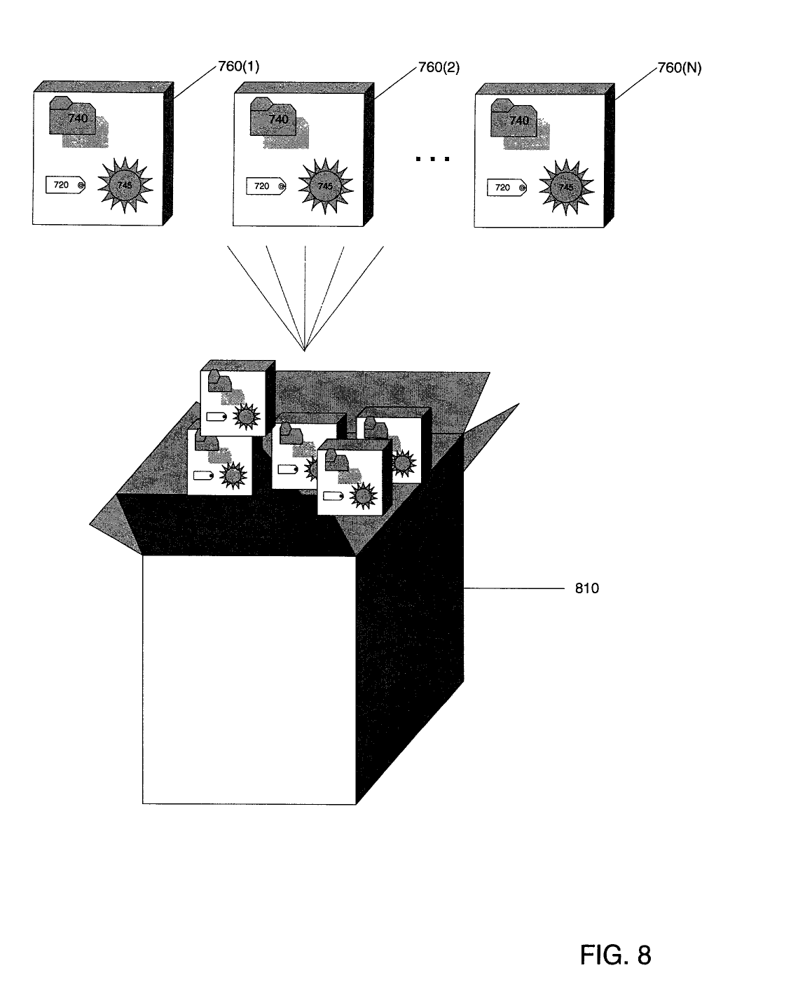

Prior to application building step 241 and deployment step 251, it is necessary to create and define modules 201 to be included within an application 405. FIG. 7 is a flow diagram that shows a process for creating a module and a number of programming elements and data structures included in a module package according to one embodiment of the present invention. As shown in FIG. 7, module package 760 includes shared object file 740 (“SO file”), configuration file 720 and icon file 745. SO file 740 includes object code, which may be dynamically linked at executed at run-time. SO file 740 is generated from module code file 730. In particular, compiler 710b receives module code file 730, generated by the application developer, and processes module code file to generate SO file 740. The structure of module code file 730 is described in detail below with reference to FIG. 8.

Configuration file 720 includes various configuration data related to operation and initialization of the associated module 201. The structure of configuration file 720 is described below. Custom configuration GUI 735 receives configuration data 715 generated by the application developer and produces as output configuration file 720, which stores configuration information for module 201. Icon file 745 includes data representative of a graphical image, which may be utilized by a GUI tool such as application development tool (described in detail below) to assist an application developer in the generation of an application 405.

FIG. 7 also shows the relationship between dictionary 620 and configuration file 720. In particular, dictionary 620 provides a container utilizing a specific data structure for storage by a module 201 of data from a configuration file related to module 201. The structure of dictionary 620 is described in detail below.

According to one embodiment, module packages 760 may be aggregated into a central repository, where they may be retrieved, modified, and/or reviewed, for example, as part of a deployment step utilizing an application development tool (described in detail below). FIG. 8 depicts the structure of a module repository according to one embodiment of the present invention. Module repository 810 includes at least one module package 760, each module package 760 including respective SO file 740, configuration file 720 and graphical icon file 745. According to one embodiment, a generic repository may be defined to store data relating to applications 405, components 505 and other objects, etc.

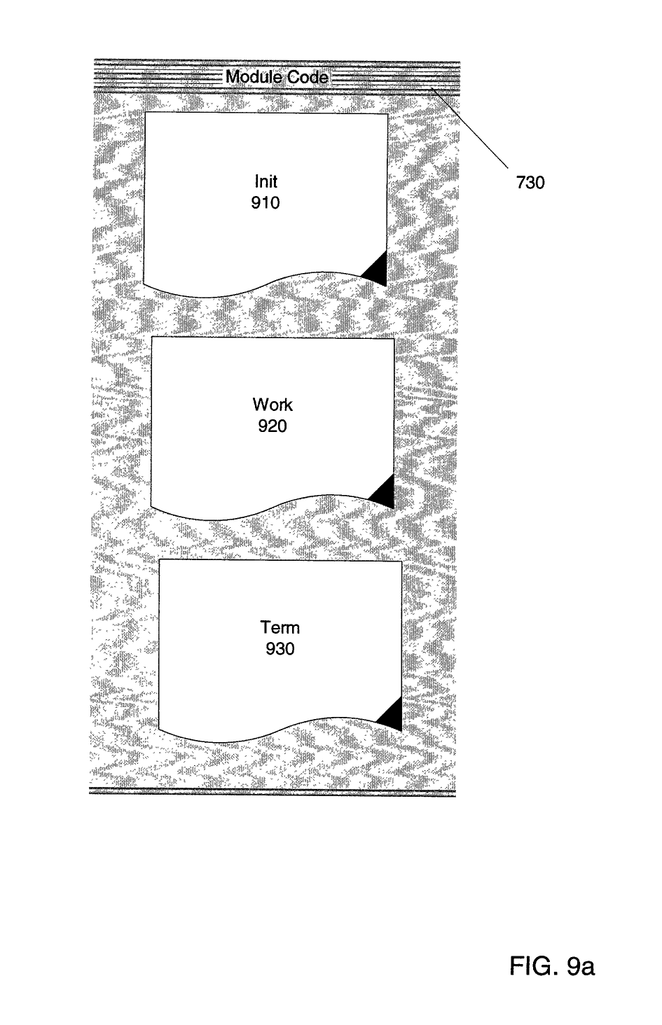

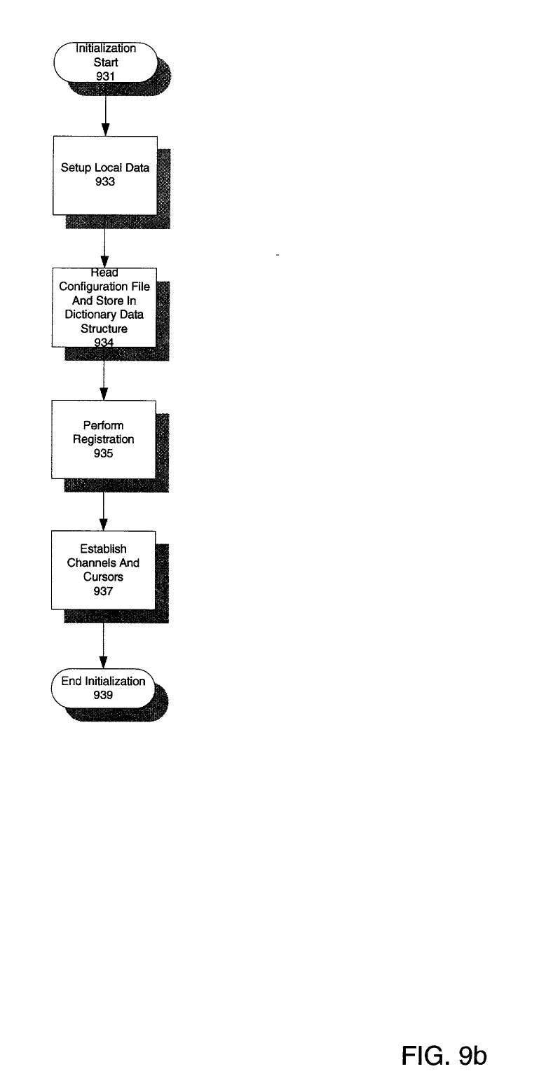

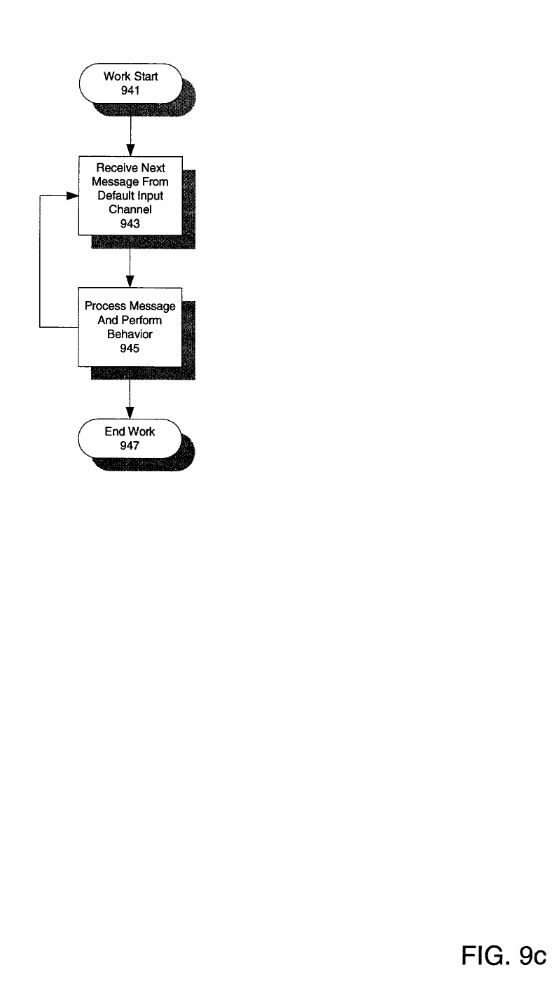

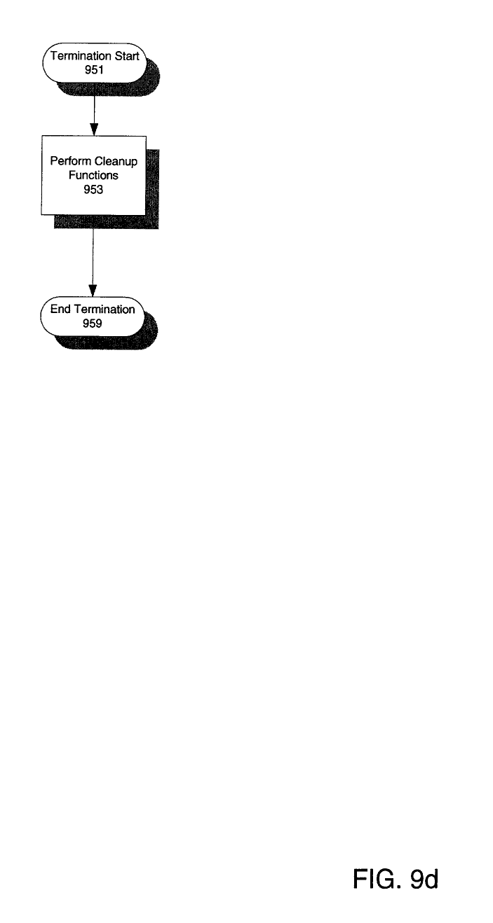

FIG. 9a depicts the structure of a module code file according to one embodiment of the present invention. A module code file 730 includes an initialization function 910, a work function 920 and a termination function 930. According to one embodiment of the present invention, initialization function 910, work function 920 and termination function 930 are each callback functions, which may be called and executed by a remote process (e.g., another module 201).

For example, according to one embodiment, initialization, work and termination functions (910-930) are effected as callback functions utilizing the following prototypes:

typedef int (*MCPModInitCB)(MCPModHandle mod)

typedef int (*MCPModWork CB)(MCPModHandle mod)

typedef int (*MCPModTermCB)(MCPModHandle mod)

These prototype function pointers upon compilation into SO file 740 serve as entry points respectively for initialization function 910, work function 920 and termination function 930.

Initialization function 910 performs startup routines for a module 201 such as setup of local data, reading configuration information, registration with a runtime environment and establishing channels and cursors to be used for module interaction.

According to one embodiment, during module initialization all or some of the following actions nearly always occur:

the data to be used by the module 305 are identified;

the module's configuration file is identified;

the module 305 is named/registered in (made known to) the processing environment;

space is allocated for the module data;

the data allocated are explicitly associated with the module 305;

the module's default inbound and outbound channels are created/identified;

the module is 305 configured by consulting the configuration file.

FIG. 9b is a flowchart depicting a typical series of steps executed by a initialization function 910 according to one embodiment. Note, however, that the steps shown in FIG. 9b are merely exemplary and a module 201 may effect any number of initialization routines. Referring again to FIG. 9b, the initialization function is commenced in step 931. In step 933, local data is stored and initialized on the host 114 on which the module 201 resides. In step 934, the initialization function reads data from the associated configuration file 720 and stores the data in a dictionary 620 data structure. In step 935, initialization function 910 performs a registration process, which is related to a runtime environment in which an application 405 may run. In step 937, the initialization function 910 initializes and establishes channels 380 and cursors on which it will read and write messages 305. The nature of channels 380 and cursors will be described in detail below. The initialization process ends in step 939.

FIG. 9c is a flowchart depicting a typical series of steps executed by a work function according to one embodiment of the present invention. Work function 920 performs the behavior associated with a module 201. Typically, work function 920 receives messages 305 from an input channel 380, processes received messages 305 and exhibits some behavior (i.e., function) based upon the received messages 305. Thus, as shown in FIG. 9c, work function 920 is initiated in step 941. In step 943, a next message 305 is retrieved from a default input channel 380. In step 945, the message 305 is processed and based upon the message 305a behavior 307 is effected. The nature of the behavior 307 is dependent upon the particular module 201 and the work it is intended to perform.

FIG. 9d is a flowchart depicting a typical series of steps executed by a termination function according to one embodiment of the present invention. In step 951, the termination function is initiated. In step 953, cleanup functions are performed. The process ends in step 959.

In general, the task of coding the above module functions (init, work and term) has two independent but complementary facets. On the one hand, there is the task of selecting from among the functions presented by the API exactly those functions that are compatible with the design and purpose of the given application. On the other hand, there is the task of embedding and manipulating the selected functions within the context of a specific programming language in a manner that allows the application to achieve its goals.

Once the module code is completed, the code is Compile the code into a shared library, ensuring that the following definitions are part of the compiled code:

A definition of the prototype of the module initialization, work and termination functions as follows:

typedef int (*MCPModInitCB)(MCPModHandle mod)

typedef int (*MCPModWorkCB)(MCPModHandle mod)

typedef int (*MCPModTermCB)(MCPModHandle mod)

A definition of the data type MCPLinkInfoStruct, which will be used to create an array of module entries—see the next step.

typedef struct
{

char moduleName;
MCPModInitCB initFn;
MCPModWorkCB workFn;
MCPModTermCB termFn;

}MCPLinkInfoStruct, *MCPLinkInfoPtr;

In a next step, a file named LinkInfo.c is created with the following contents:

MCPLinkInfoStruct MCPModules[] = {

{
“module name”,
ModInit,
ModWork,
ModTerm

},

{
...

},

{
NULL,
NULL
NULL
NULL
}

}

Each entry in the array MCPModules[ ]represents a module (i.e., a module is an instance of the structure of type MCPLinkInfoStruct). The first item in a module entry is the name of a particular module while the remaining items point to the module's initialization, work and termination functions. During the module startup process, the module name (the first item in the module entry) is compared with value of the configuration file parameter CodeEntrySym (discussed in the next step). They must match for the module to load successfully.

In a further step, a configuration file is created for the module 201. The configuration file associated with a module determines the module's behavior. The information contained in a configuration file includes the definition of the following items:

module linking information

debugging information

processing threads

channels and so on.

The entries in the configuration file conform to a special format, exemplified in the following fragment:

TestMod|CodeEntryFile lib/libMTLogger_r.so

TestMod|CodeEntrySym Logger

TestMod|ModVerbose 1

TestMod|ChannelFileInfo|PATH queues/ChannelFile

TestMod|ChannelFileInfo|SIZE 1024000

TestMod|ChannelFileInfo|ACCESS O_APPEND

TestMod|ChannelFileInfo|LOCKTYPE PROCESS_SAFE

TestMod|ChannelFileInfo|MEMTYPE MMAP

TestMod|Alias|TestMod|DefIn|NAME TestModIn

TestMod|Alias|TestMod|DefIn|PATH queues/TestModIn

. . .

. . .

. . .

The configuration file is organized as a left-to-right oriented tree of nodes and node values. The above fragment, for example, contains the root node TestMod which contains the subnodes CodeEntryFile, CodeEntrySym, ModVerbose, ChannelFileInfo and Alias. A vertical bar (‘|’) in front of a token identifies it as a subnode. The subnodes Alias and ChannelFileInfo expand into further subnodes, which in turn contain additional subnodes. The subnode Alias, for instance, contains the subnode TestMod, which has a subnode of its own, DefIn, which branches off into the subnodes NAME and PATH. Associated with a node may be a value. In the above tree, for example, each of the subnodes branching off ChannelFileInfo has an associated value. Thus, the subnode SIZE has 1024000 as its value while the subnode MEMTYPE has the value MMAP. (These node values specify that a memory-mapped channel file of size 1024 MB must be created for the module TestMod.)

The following table lists the events that typically occur during a module's initialization phase and exemplary API functions, which are used to implement them:

| | |
|---|---|
| Module | MCP API or C Library Function |
| Initialization Phase | |
| Events | |
| The module's | MCPModRegisterModuleName |
| name is registered in the | |
| environment. | |
| The module's | MCPModGetModName |
| name is obtained from its | |
| configuration file. | |
| Space is allocated | Malloc |
| for the module. | |
| Space allocated | Memset |
| for the module is | |
| cleared/initialized. | |
| The module's data | MCPModSetDataPt |
| structure is attached to | |
| the module handle/API. | |
| Module | MCP API or C Library Function |
| Initialization Phase | |
| Events | |
| A structure for | MCPModGetChanIo |
| accessing the module's | |
| channels is created. | |
| The name of the | MCPModGetOutBoundChannelName |
| module's outbound | |
| channel is obtained from | |
| the configuration | |
| dictionary. | |
| The name of the | MCPModGetInBoundChannelName |
| module's inbound | |
| channel is obtained from | |
| the configuration | |
| dictionary. | |
| A pointer is set to | MCPChanIoCreateCurs |
| the inbound channel. | |
| Must be performed for | |
| each channel. | |
| The module's | MCPModGetConfig |
| configuration dictionary | |
| is accessed. | |

As noted above, in general, the work that a module 201 does during its work phase involves messaging, i.e., receiving and/or sending messages 305. The basic framework for messaging includes the function MCPModGetDataPtr and either one or both of the functions MCPChanIoGetNextMsg and MCPChanIoSendMsg.

| | |
|---|---|
| Module Work Phase | MCP API or C Library |
| Events | Function |
| Get data pointer, access | MCPModGetDataPtr |
| the local data structure. | |
| Read a message from the | MCPChanIoGetNextMsg |
| indicated channel. | |
| Write the message to the | MCPChanIoSendMsg |
| indicated channel. | |

According to one embodiment, some modules do nothing but receive (MCPChanIoGetNextMsg) and send (MCPChanIoSendMsg) messages, most modules perform a wide variety of message processing and other tasks between the events of receiving and sending messages.

During module termination, according to one embodiment, the following two API functions are typically called:

| | |
|---|---|
| Module Termination | MCP API or C Library |
| Phase Events | Function |
| Get data pointer. | MCPModGetDataPtr |
| Free the resource(s). | free |

According to one embodiment, the messages 305 generated by modules 201 are self-describing—i.e., each message 305 incorporates a description of how it is encoded. A message consists of a message header and a data block. According to one embodiment, the message header is made up of eight fields, which provide the following information:

Protocol version of the message API under which the current message was created

Message code

Time

GMT offset

MCP license

Unique identifier (for routing purposes)

Bit flags (for special functionality)

Name of the module generating the message

According to one embodiment, the message header is created internally by the application.

The data block of the message, which is accessible to the module programmer, includes a set of offset fields followed by a null field followed by a set of data fields. Each data field is actually of a pair of fields, the first of which contains an identifier describing the type of the data in the second field of the pair. The number of the offset fields is identical to the number of data fields (i.e., an identifier field followed by a data field). The value in the offset field indicates the distance in bytes to the corresponding data field.

In accordance with the discrete self-contained nature of the module, the messages 305 generated by a module 201 do not contain an identifier for the destination module. The routing of messages to their destinations is not an issue that needs to be resolved at the module coding stage, where the modules are treated as separate isolated entities that have no knowledge of what is beyond their own boundaries.

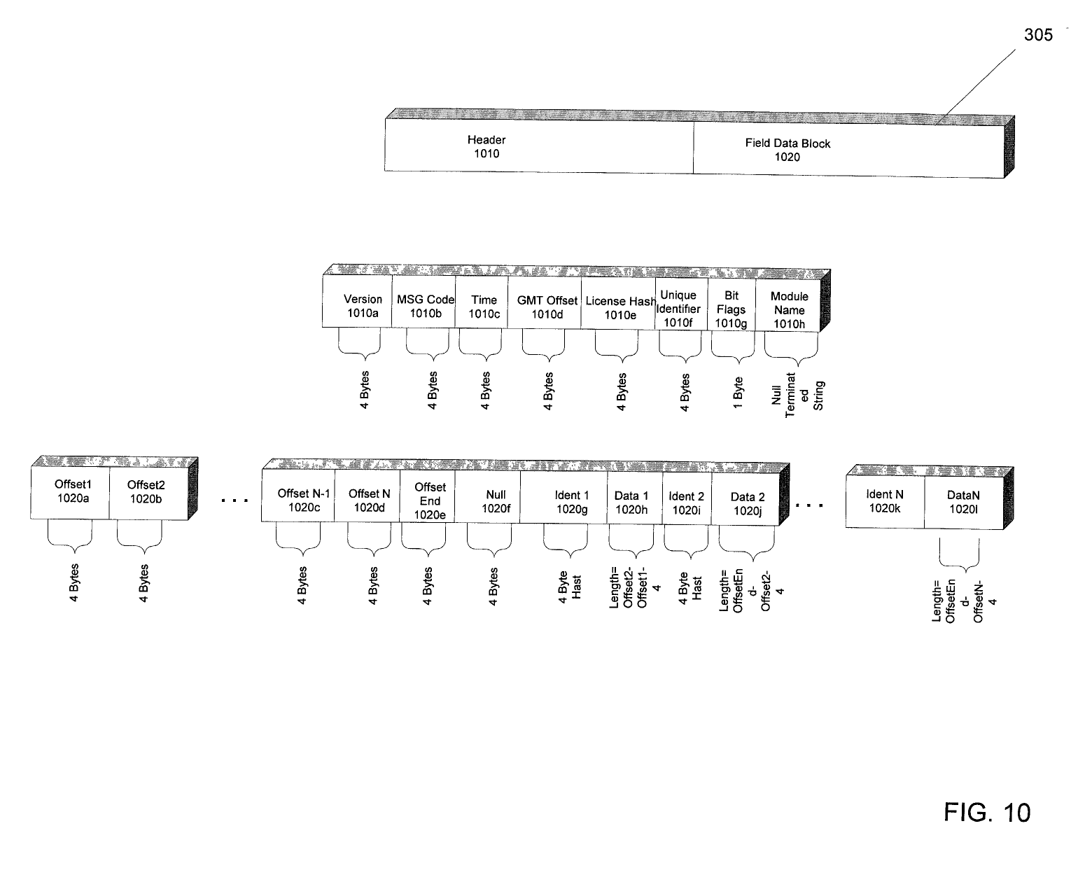

FIG. 10 depicts the structure of a message according to one embodiment of the present invention. According to one embodiment, messages are self-describing. As shown in FIG. 10a, message 305 includes header 1010 and field data block 1010. Header 1010 includes 4-byte version field 1010a, 4-byte message code field 1010b, 4 -byte time field 1010c, 4-byte GMT offset field 1010d, 4-byte license hash field 1010e, 4-byte unique identifier field 1010f, 1-byte bit flag 1010g and null terminated module name field 101h. Message code field 1010a stores a code representing a protocol version for message API 610b. Message code field 1010b stores a 4-byte integer representing a message code. GMT offset field 1010d stores a 4-byte integer representing a GMT offset value. License hash field 1010e stores a 4-byte code representing a license for licensing purposes. Unique identifier field 1010f stores a 4-byte number utilized for routing purposes. Bit flags field 1010g stores a 1-byte value used for special functionality such as reference fields, etc. Module name field 1010h stores a name of an associated module that generated the message 305. According to one embodiment of the present invention, module name field 1010h stores a digital signature, which is assigned in configuration file 720 during deployment step 251 and output during running during API calls. Note that messages 305 are destinationless. That is, messages 305 do not require or include a field for a destination module predetermined to receive the message 305. The destinationless character of messages 305 provides for significant ability for dynamic reconfiguration of an application 405 post-deployment (i.e., during runtime).

Field data block 1020 includes an arbitrary number of offset fields 1020a-1020e, which are separated from a corresponding number of identifier/data pair fields (i.e., 1020g/1020h, 1020i/1020j and 1020k/1020l) by null field 1020f. Each offset field (i.e., 1020a-1020d) stores an offset value in bytes to a corresponding identifier/data pair field (e.g., 1020g/1020h). Each identifier field (i.e. fields 1020g, 1020i and 1020k) stores a 4 byte type field describing a corresponding data object. Each data field (i.e., 1020h, 1020j and 1020l) stores a data object of a particular type.

As described above messages 305 do not include destination module 201 identifiers. Messages 201 within the environment include source module identifiers 1010h inside the header 101 which uniquely identify the originating module 201 within an application 201 for a particular network deployment. According to one embodiment, a function referred to herein as “Respond To Message” is provided, which allows a module 201 to make a response to a request and have the system direct the response message back to the module 201 that made the original request. Modules 201 that send a message 305 and expect a response for a given message provide an identifier in the message 305 as a “request” and optionally determine which of its input channels 380 the response is expected on. Reply messages 305 make use of reserved “system-level” fields to store information so that a response message 305 may be delivered to the requester. Request messages 305 may optionally mark fields as “copyback” fields, to tag one or more fields to be copied into the response message 305.

In particular, modules 201 may mark a message 305 as a “Request” before sending it out. Additionally, the requesting module 305 may specify a set of “respondOn” channels 380 that it desires the response to be delivered on. According to one embodiment, a module 201 desiring to deliver a message 305 (responding to a request) builds the message 305 and then calls a function named RespondToMsgo to deliver the response. This function inspects the original request message 305 to obtain the source module's unique id and inserts this as a special field in the response message 305 such that the response message 305 may be routed to the requesting module 201. For delivery of the response, the RespondToMsgo function checks if the requesting module 201 resides locally (i.e., on the same host as the requesting module 201). If it does, then the message 305 gets written directly to the requesting module's “respondOn” channels 380. If it does not reside locally, the message is written to its DefResponse output channel, which is sent (via special sender/receiver modules 201 described below) to the requester module 201 on another host 201.

According to one embodiment each module 201 is associated with a configuration file 720, which contains information about the module 201 such as its name (and possible aliases), its location in the shared memory, its communication channels 380 and their characteristics (size, location, implementation, etc.), and so on. Also, the messages 305 that the module 201 handles may be defined in the configuration file 720.

According to one embodiment, configuration file 720 is a text file consisting of a set of statements (entries) that describe selected properties of a specific module 201. The statements in configuration file 70 are presented in the form of a tree, i.e., a hierarchically organized collection of nodes. The nodes of the tree are arranged in a left-to-right fashion. The leftmost item of the tree is the root (node) of the tree. This is always the name of the module to which the configuration pertains. Branching off the root node is a set of subnodes (also called child nodes). A subnode may divide into further subnodes (child nodes). The subnodes of the tree are identified with a vertical bar (‘|’) in front of the node name. Associated with each node of the tree may be one or more values. A node's value is written to the right of the node with a space in front of it (multiple node values are also separated with a space from each other).

According to one embodiment, the configuration file entries are constructed according to the following schema:

root_node|subnode₁val₁|subnode₂ val₂val₃ . . . |subnodeₙvalₙ

While the root node of a configuration entry is always the name of the module with which the configuration file is associated, the tokens representing subnodes and node values may be literals, variables or members of predefined inventories. For instance, in the case of describing the properties of a module's communication channels, the configuration entries are constructed according to the following variant schema:

root_node|“Alias”|alias_name|“Chan”|“DefIn”(or “DefOut”)|parameter value

In this schema, the items (subnodes) in quotes are literals that must be used exactly as indicated (though without quotes). The tokens representing the subnode parameter as well as the values associated with that node must be drawn from a predefined inventory. Likewise, the name of the fourth subnode must be either DefIn or DefOut.

The entries in a configuration file may include:

Module linking information (information specifying where the module code resides in memory);

Module aliases (alternative names or aliases for the module);

Communication channels (A typical module uses one inbound and one outbound channel. Hence, equally many channel definitions must be entered in the configuration file);

Channel file—(for each module a channel file is defined to keep track of all channels in use);

Debugging information—(statements controlling the amount of debugging information to be written to the console of an application)

According to one embodiment, module linking information is conveyed by the values associated with the subnodes (parameters) CodeEntryFile and CodeEntrySym. The CodeEntryFile parameter takes as its value a path statement indicating the location in shared memory of the module code. The CodeEntrySym parameter takes as its value a module name, which must match the module name specified in the entry for the module in the MCPModules array. The two subnodes must occur immediately to the right of the root node (conveying the name of the module), as shown in the following fragment from the configuration file of a module named Blaster:

Blaster|CodeEntryFile lib/libMTBlaster_r.so

Blaster|CodeEntrySym Blaster

In the above example, the parameter CodeEntryFile has the value

lib/libMTBlaster_r.so (this is where the Blaster module is on disk) and the parameter CodeEntrySym has the value Blaster (this name must match the module name in the entry for the module in the MCPModules array in the shared memory—see the section “Module Building Process at a Glance,” above).

According to one example, configuration entries for the channel file are of the following format:

root₁₃ node|“ChannelFileInfo”|parameter value

where

| root_node | Specifies the name of the module. | |
|---|---|---|
| “ChannelFileInfo” | Specifies the literal ChannelFileInfo. | |
| parameter value | The subnode parameter may be specified with a | |
| | token designating a category of channel file | |
| | properties. The following tokens (categories) are | |
| | available: | |
| | PATH | |
| | SIZE | |
| | ACCESS | |
| | LOCKTYPE | |
| | MEMTYPE | |
| | The subnodes value may be specified as follows: | |
| | PATH | The path where the channel file |
| | | resides in the file system. For |
| | | example, PATH/tmp/foo. |
| | SIZE | The size of the channel file. |
| | ACCESS | Indicates how the channel file is to be |
| | | treated upon being opened. |
| | | Specify the value as O_APPEND if |
| | | the messages already registered in the |
| | | channel file are to be retained, i.e., |
| | | new message arriving in the channel, |
| | | will be appended to those already |
| | | there. |
| | | Specify O_TRUNC if the messages |
| | | already registered in the channel file |
| | | are to be deleted, i.e., the channel file |
| | | will record only new messages. |
| | LOCKTYPE | Manages the contention for a |
| | | channel. |
| | | Specify PROCESS_SAFE |
| | | (recommended) to prevent contention |
| | | among processes. |
| | | Specify THREAD_SAFE to prevent |
| | | contention among threads. |
| | | Specify KERNEL_SAFE to use |
| | | the kernel locking mechanisms to |
| | | prevent the processes on the same |
| | | CPU from contending for the same |
| | | channel resource. |
| | | Specify LOCK_STATE_NO_{—} |
| | | LOCK to indicate that no locking |
| | | mechanism is used to control |
| | | contention for the channel. |
| | MEMTYPE | Determines how the channel file |
| | | is implemented. |
| | | Specify DATA_Q_MMP if the |
| | | channel file is to be realized as a |
| | | memory-mapped entity. |
| | | Specify DATA_Q_SHM if the |
| | | channel file is to be implemented in |
| | | shared memory. |

For example, a channel file definition for a module named TestMod might be written as follows::

TestMod|ChannelFileInfo|PATH queues/ChannelFile

TestMod|ChannelFileInfo|SIZE 1024000

TestMod|ChannelFileInfo|ACCESS O_APPEND

TestMod|ChannelFileInfo|LOCKTYPE PROCESS_SAFE

TestMod|ChannelFileInfo|MEMTYPE DATA_Q_MMAP

According to one embodiment, module communication channels are defined with statements of the following format:

root_node|“Alias”|alias name|channel specifier|parameter value

where

| | |
|---|---|
| root_name | Specifies the name of the module. |
| “Alias” | Specifies the literal Alias. |
| alias name | Specifies an alternative name for the module |
| | designated by root_name. If the module does not have |
| | an alias, the ‘real’ name of the module must be |
| | specified. |
| channel specifier | Specifies a channel as being either inbound or |
| | outbound. |
| | Use DefIn for an inbound channel and DefOut for an |
| | outbound channel. |
| parameter value | The subnode parameter may be specified with a token |
| | designating a category of channel properties. The |
| | following tokens (categories) are available: |
| | NAME |
| | PATH |
| | SIZE |
| | MODE |
| | LOCKTYPE |
| | MEMTYPE |
| | MAXSIZE |
| | MAXPAGES |

The subnodes value may be specified as follows:

| | |
|---|---|
| NAME | The name of the inbound or outbound |
| | channel, e.g., NAME BlasterIn. |
| | Once the channel has been initialized, |
| | the current program or another can call |
| | MCPChanIoOpenChannel to open the channel |
| | using this channel name. The user of |
| | MCPChanIoOpenChannel must |
| | be using the same channel file as |
| | defined under the |
| | ChannelFileInfo config node. See |
| | MCPChanIoOpenChannel in ChanIo.h. |
| | In MCPModRegisterModuleName it is |
| | used as the channelName argument when |
| | calling MCPChanIoCreateChannel. |
| PATH | The path where the channel resides in |
| | the file system. |
| MAXSIZE | The maximum size of the channel. |
| MODE | Indicates how a channel is to be treated |
| | upon being opened. |
| | Specify the value as O_APPEND if the |
| | messages already in the channel are to |
| | be retained, i.e., new messages arriving |
| | in the channel will be appended to those |
| | already there. |
| | Specify O_TRUNC if the messages |
| | already in the channel are to be deleted, |
| | i.e., the channel will contain only new |
| | messages. |
| LOCKTYPE | Manages the contention for a channel. |
| | Specify PROCESS_SAFE (recommended) to |
| | prevent contention among processes. |
| | Specify THREAD_SAFE to prevent contention |
| | among threads. |
| | Specify KERNEL_SAFE to use the kernel |
| | locking mechanisms to prevent the processes on |
| | the same CPU from contending for the same |
| | channel resource. |
| | Specify LOCK_STATE_NO_LOCK to |
| | indicate that no locking mechanism is used to |
| | control contention for the channel. |
| MEMTYPE | Determines how the channels are |
| | implemented. |
| | Specify DATA_Q_MMP if the channels are to |
| | be realized as memory-mapped entities. |
| | Specify DATA_Q_SHM if the channels are to |
| | be implemented in shared memory. |
| MAXPAGES | Specifies the maximum number of pages |
| | that a channel can use. |

For example, sample channel definitions for a module named Blaster might be written as:

Blaster|Alias|Blaster|DefIn|NAME BlasterIn

Blaster|Alias|Blaster|DefIn|PATH queues/BlasterInput

Blaster|Alias|Blaster|DefIn|MAXSIZE 1024000

Blaster|Alias|Blaster|DefIn|LOCKTYPE PROCESS_SAFE

Blaster|Alias|Blaster|DefIn|MEMTYPE DATA_Q_MMAP

Blaster|Alias|Blaster|DefIn|MAXPAGES 6

Blaster|Alias|Blaster|DefIn|MODE O_APPEND

Blaster|Alias|Blaster|DefOut|NAME LoggerIn

Blaster|Alias|Blaster|DefOut|PATH queues/LoggerInput

Blaster|Alias|Blaster|DefOut|MAXSIZE 1024000

Blaster|Alias|Blaster|DefOut|LOCKTYPE PROCESS_SAFE

Blaster|Alias|Blaster|DefOut|MEMTYPE DATA_Q_MMAP

Blaster|Alias|Blaster|DefOut|MAXPAGES 6

Alternative names, if any, that a module may have are specified with statements of the same format as the module's communication channels:

root_node|“Alias”|alias name|channel specifier|parameter value

In the case of a module that does not have an alias, the above schema is instantiated so that root_node (the module name) is identical with alias name:

Blaster|Alias|Blaster|DefIn|NAME|BlasterIn

Blaster|Alias|Blaster|DefIn|PATH queues/BlasterInput

However, if a module does have an alternative name (e.g., Abcd), it will appear as the third subnode in the configuration entries for the module:

Blaster|Alias|Abcd|DefIn|NAME Abcd

Blaster|Alias|Abcd|DefIn|PATH queues/AbcdIn

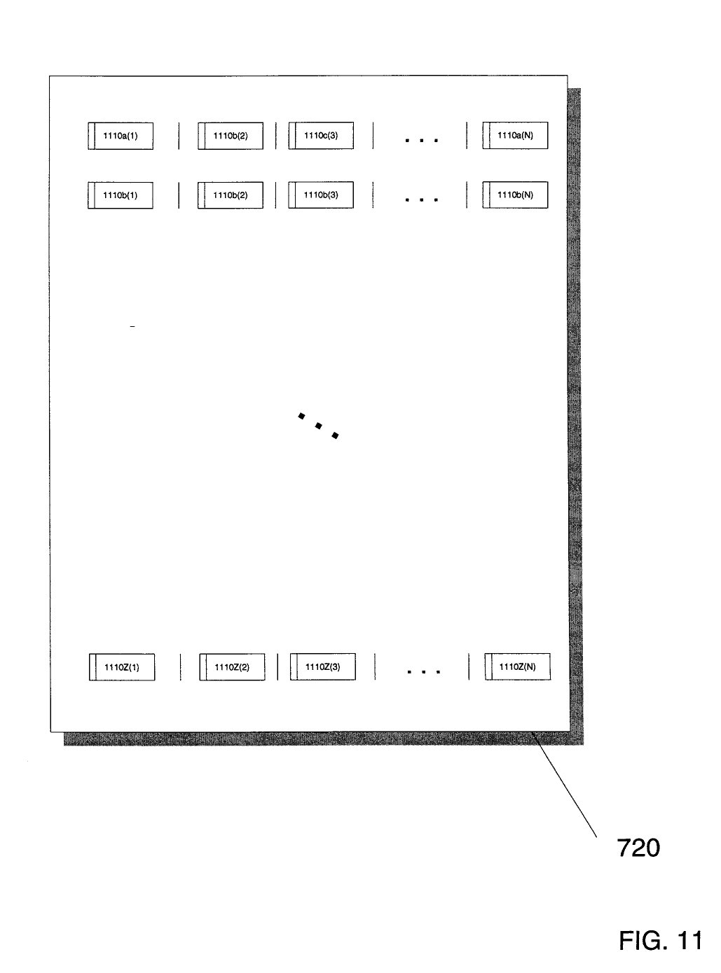

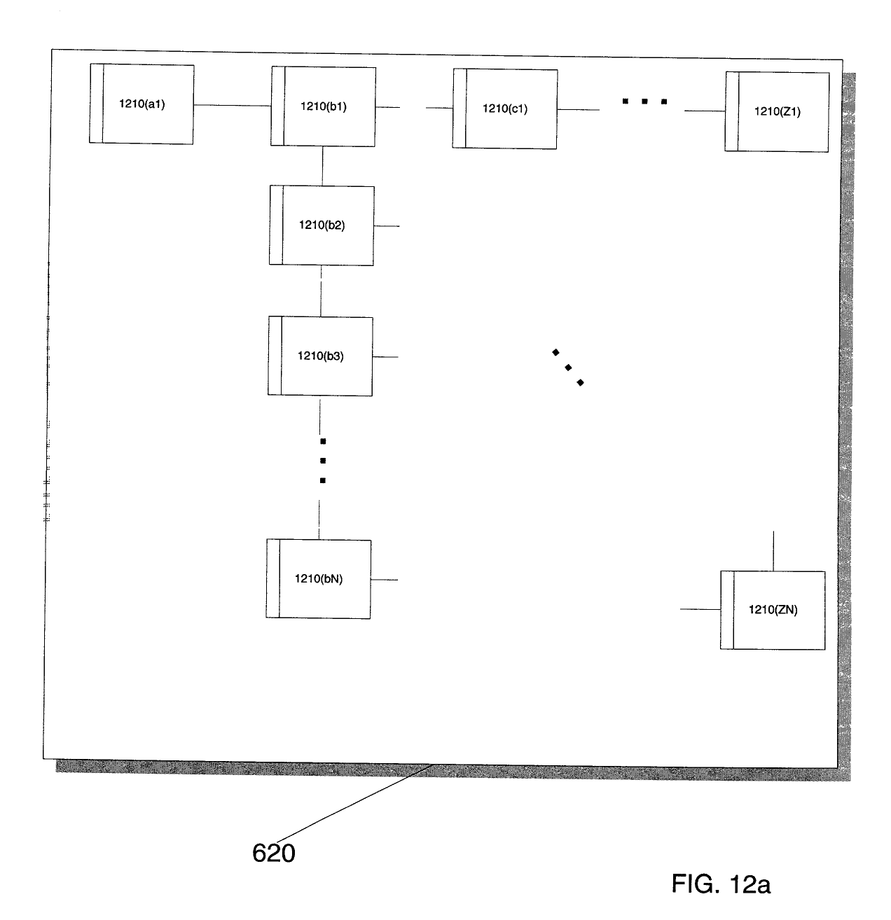

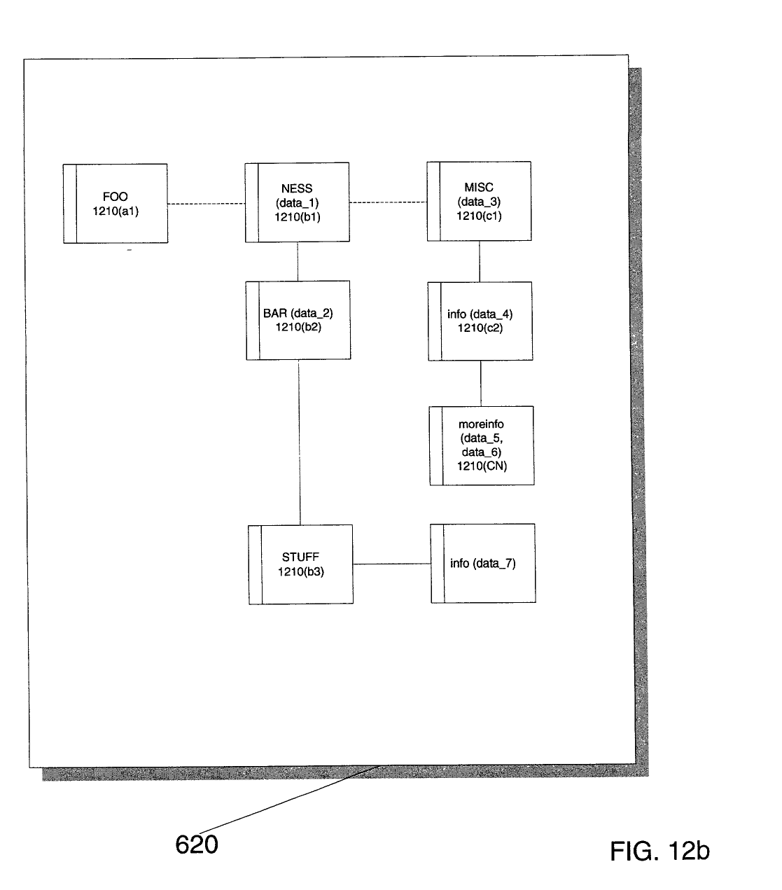

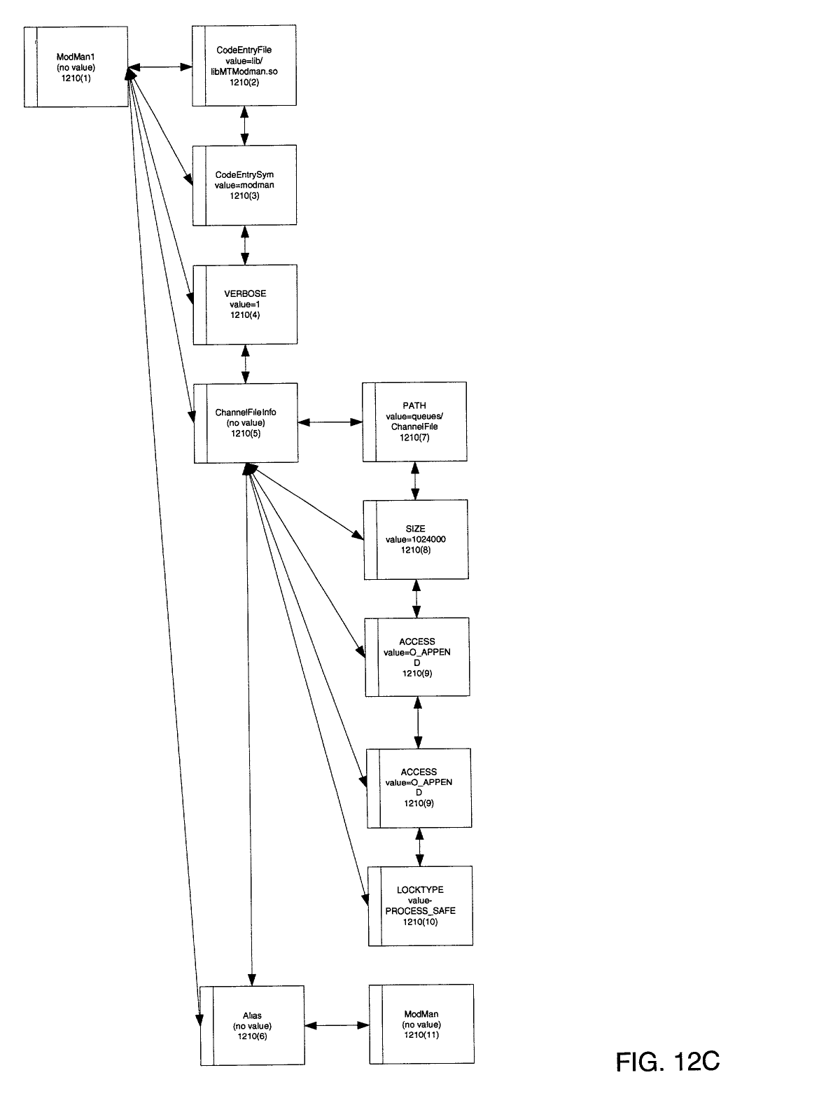

FIG. 11 depicts the structure of a configuration file according to one embodiment of the present invention. Configuration file 720 includes configuration entries 1110a(1)-1110Z(N). The structure and relationship of configuration entries 1110 within configuration file 720 defines a hierarchical relationship between configuration entries 1110, from which, a series of nodes comprising a dictionary data structure 620 may be generated. A dictionary data structure 620 is described below with reference to FIGS. 12a-12b.

The following is an excerpt from an exemplary configuration file according to one embodiment of the present invention.

#CodeEntryFile and CodeEntrySym specify the module code to run

# The name at the beginning of each line is the module name.

ModMan|CodeEntryFile lib/libMTModMan_r.so

ModMan|CodeEntrySym ModMan

ModMan|VERBOSE 2

ModMan|SHOWMSG 1

ModMan|ChannelFileInfo|PATH queues/ChannelFile

ModMan|ChannelFileInfo|SIZE 1024000

ModMan|ChannelFileInfo|ACCESS O_APPEND

ModMan|ChannelFileInfo|LOCKTYPE PROCESS_SAFE

ModMan|ChannelFileInfo|MEMTYPE MMAP

ModMan|Alias|ModMan|DefIn|NAME ModManIn

ModMan|Alias|ModMan|DefIn|PATH queues/ModManIn

ModMan|Alias|ModMan|DefIn|MAXSIZE 1024000

ModMan|Alias|ModMan|DefIn|LOCKTYPE PROCESS_SAFE

ModMan|Alias|ModMan|DefIn|MEMTYPE DATA_Q_MMAP

ModMan|Alias|ModMan|DefIn|MAXPAGES 6

ModMan|Alias|ModMan|DefIn|MODE O_APPEND

ModMan|Alias|ModMan|DefOut|NAME LogModMan

ModMan|Alias|ModMan|DefOut|PATH queues/LogModMan

ModMan|Alias|ModMan|DefOut|MAXSIZE 1024000

ModMan|Alias|ModMan|DefOut|LOCKTYPE PROCESS_SAFE

ModMan|Alias|ModMan|DefOut|MEMTYPE DATA_Q_MMAP

ModMan|Alias|ModMan|DefOut|MAXPAGES 6

ModMan|Alias|ModMan|DefOut|MODE O_APPEND

ModMan|Alias|ModMan|deployId 0

ModMan|ConfFileDir queues

ModMan|AdminChanInfo|PATH queues

ModMan|AdminChanInfo|MAXSIZE 1024000

ModMan|AdminChanInfo|LOCKTYPE PROCESS_SAFE

ModMan|AdminChanInfo|MEMTYPE DATA_Q_MMAP

ModMan|AdminChanInfo|MAXPAGES 6

ModMan|AdminChanInfo|MODE O_APPEND

Each configuration entry 1110 may be associated with a string value or vector of string values, which are also loaded into a dictionary data structure 620. For example, the configuration file entry

ModMan|CodeEntrySym ModMan

associates the string “ModMan” with a child node “CodeEntrySym” that is a child node of “ModMan.”

FIG. 12a depicts the structure of a dictionary data structure according to one embodiment of the present invention. Dictionary data structure 620 is a hierarchical data structure, which includes reference node pointers for efficient search and wildcard specification of resources. Data is stored for each node 1210 in the form of entries in a vector. The vector exists for every node, whether or not data exists. Data entries read from the dictionary are stored as strings. According to one embodiment of the present invention, dictionary data structure 620 utilizes a modified tree-like structure of nodes 1210, each node 1210 specifying a string value or a vector of string values. All nodes 1210 have pointers to sibling nodes 1210, parent nodes 1210 and one first child node 1210. Referring to FIG. 12a, shows nodes 12110a1-12110zN. Note that node 1210a1 is parent node of node 12110b1. Furthermore, each node 1210 may be associated with a full node name or node key. Nodes may be referred using their respective keys (i.e., full node name).

FIG. 12b further illustrates an orientation of a dictionary data structure according to one embodiment of the present invention. The node including the data value data_2 is also referred to as node “foo|bar.” The full node name or node key of the node containing the data value data_{—2} is “foo|bar.” The node to the left of node “foo|bar” is “foo|bar|misc.” Nodes “foo|bar misc,” “foo|bar|info,” and “foo|bar|moreinfo,” are subnodes of “foo|bar.” The node up from node “foo|bar” is “foo|ness.” The node down from “foo|bar” is node “foo|ness.” The node left of node “foo|ness” is node “foo.” The node left of node “foo|stuff” is node “foo.” There exists no node up from node “foo|ness.” There exists no node down from node “foo|stuff.” Nodes “foo|bar” and “foo|bar|misc” are subnodes of node “foo.” Note the node “foo|stuff” includes no data elements (i.e., its data vector stores 0 elements). Node “foo|stuff|info” includes one data element, namely “data_7.” Node “foo|bar|moreinfo” stores two data elements, “data_5” and “data_6.”

FIG. 12c illustrates a portion of an exemplary dictionary data structure generated from the configuration file described above according to one embodiment of the present invention. Note that node modman1 1210(1) is associated with five child nodes, CodeEntryFile 1210(2), CodeEntrySym 1210(3), VERBOSE 1210(4), ChannelFile 1210(5) and Alias 1210(6). Node “Modman|CodeEntryFile” stores a path to a shared object file for the module 201, in this case “lib\libModmanMt.so” This path information may be utilized to start or stop the module 201 (i.e., by calling the respective initialization 920 or termination function 930. The node Modman|ChannelFile 1210(5) designates information pertaining to channel files associated with the module 205 and is associated with five child nodes 1210(7)-1210(11). Node Modman|ChannelFile|Path 1210(8) stores path information for channels associated with the module 20 (“/queues/Channelfile”). Note that the identifiers shown in FIG. 12c and are merely exemplary. A dictionary data structure 620 may store a configuration file 720 including any type of data required to control operation of a module 201.

As noted above, a channel 380 is an example of a data repository 3505 that serves as a physical implementation of a communication pathway 314 between two modules. According to one embodiment, channels 380 are realized as memory mapped data structures or page files stored on a permanent but erasable storage medium such hard disk. The page files are mapped into RAM. When data are written to a page file mapped into RAM the event is mirrored in the corresponding page file on hard disk.

The page files store the messages 305 generated by the modules 201. Associated with each page file (i.e., channel) is one or more read and/or write cursors, which are essentially pointers to the messages stored in a particular page file (channel). A read cursor points to a position within the channel from which a message is being read while a write cursor points to a page file position into which a message is being written. Once a message 305 has been read or written, the cursor is advanced to the next read or write position in the page file. The channels 380 implemented between the modules 201 of an application are listed in a special channel file.

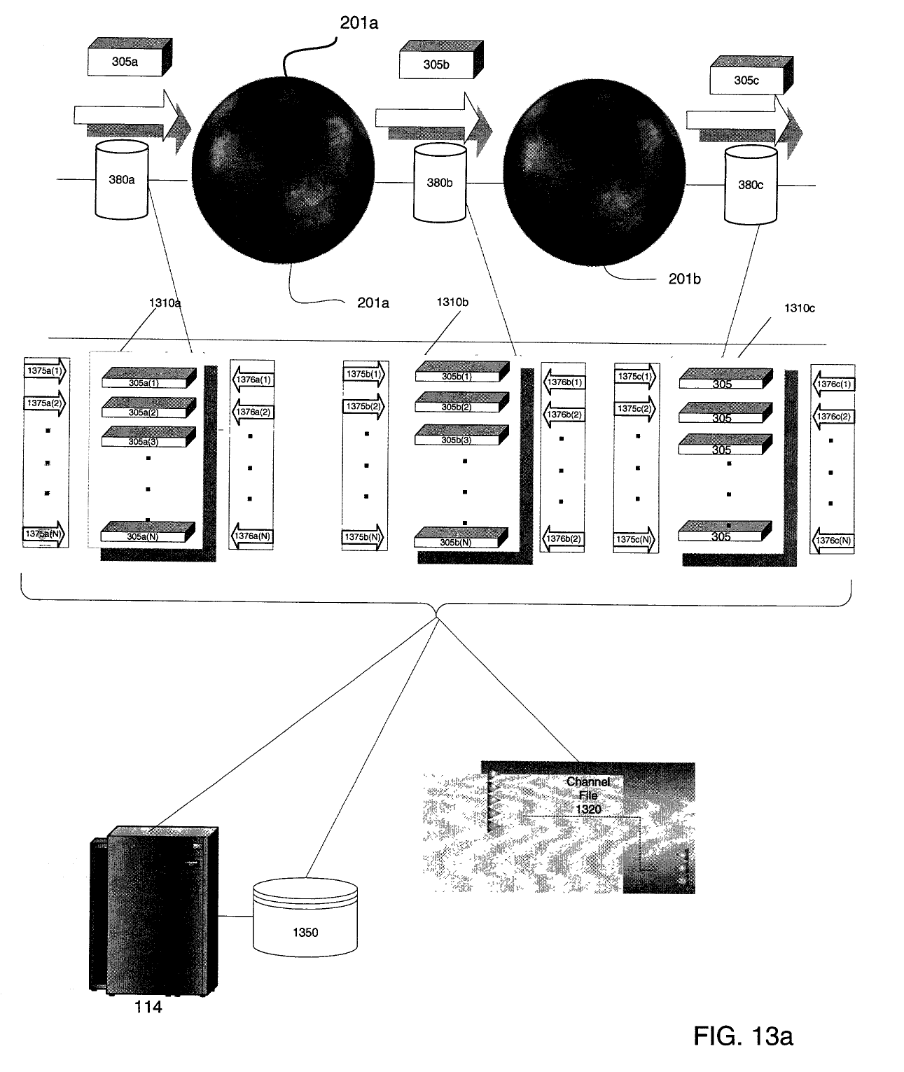

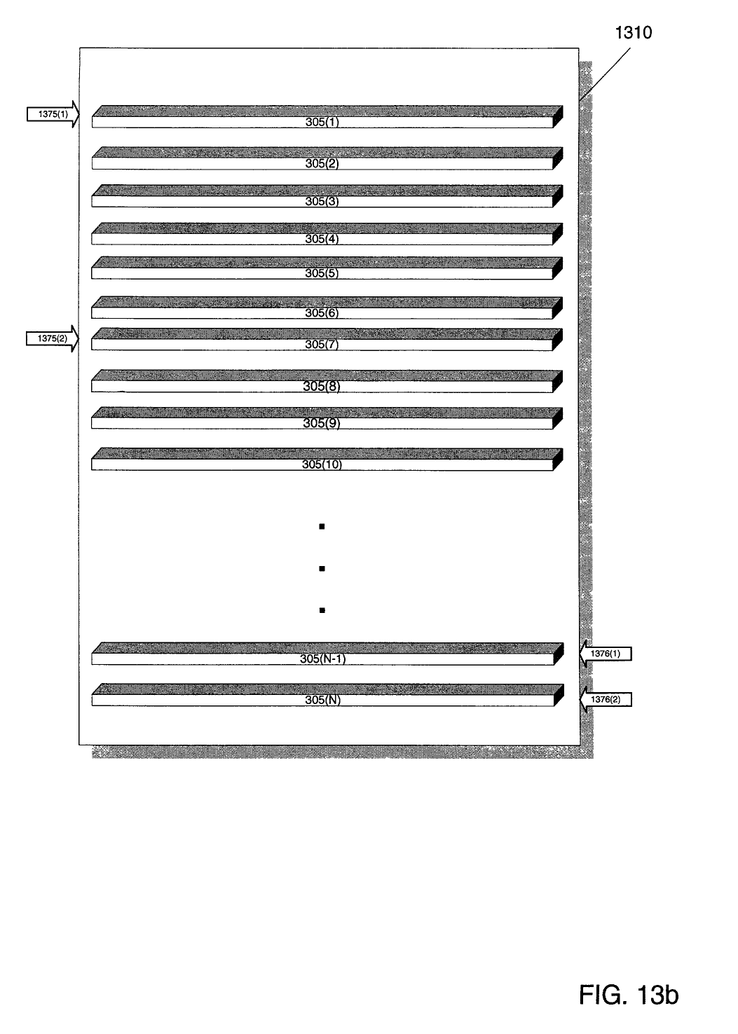

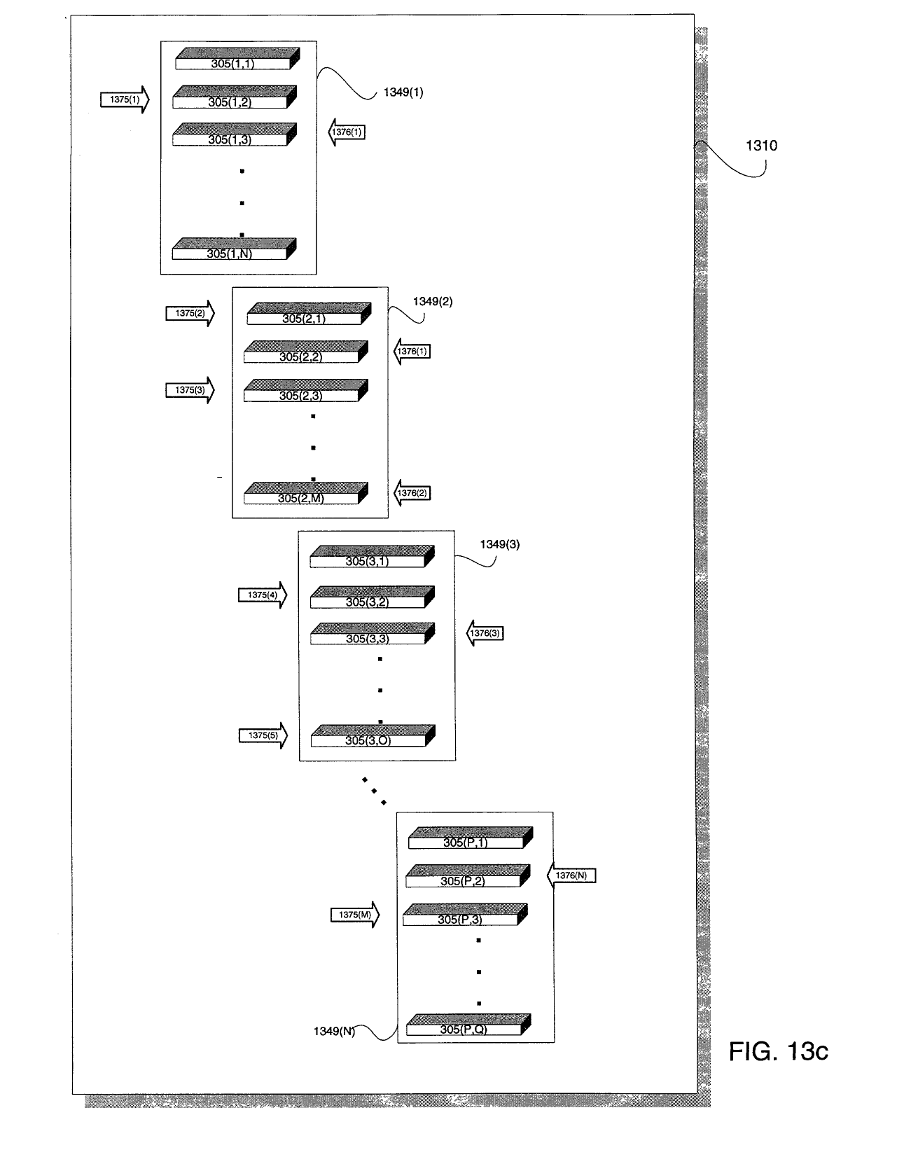

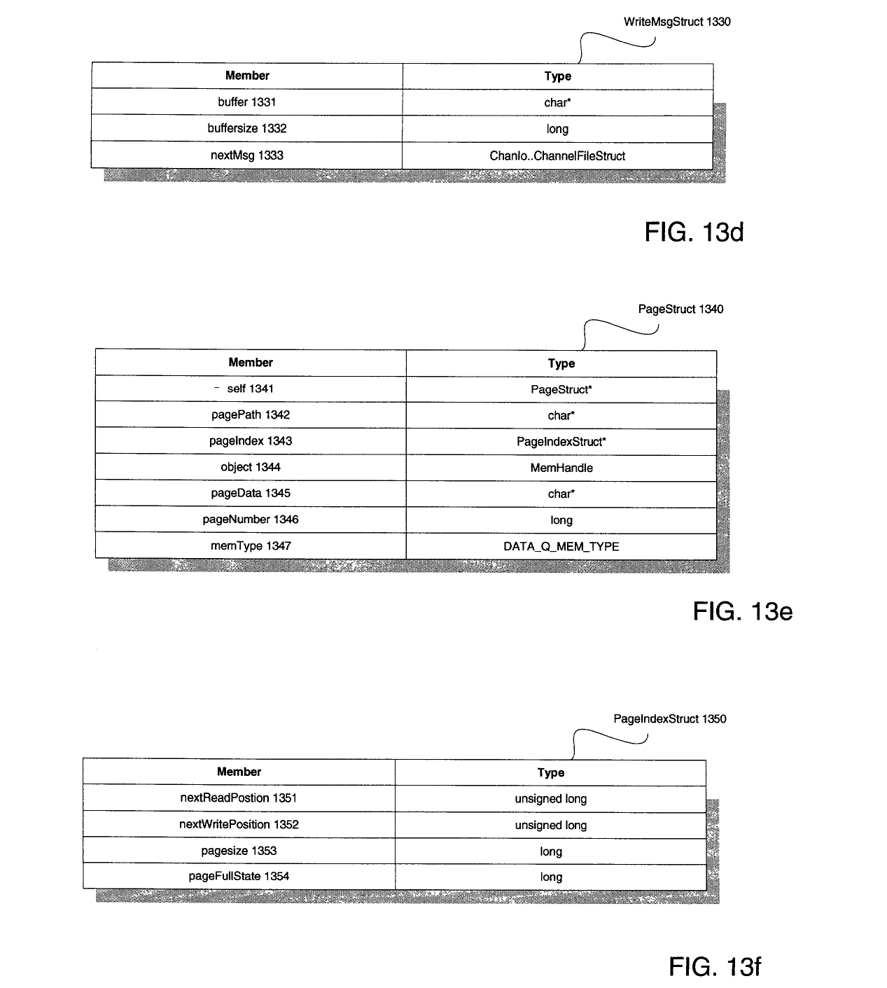

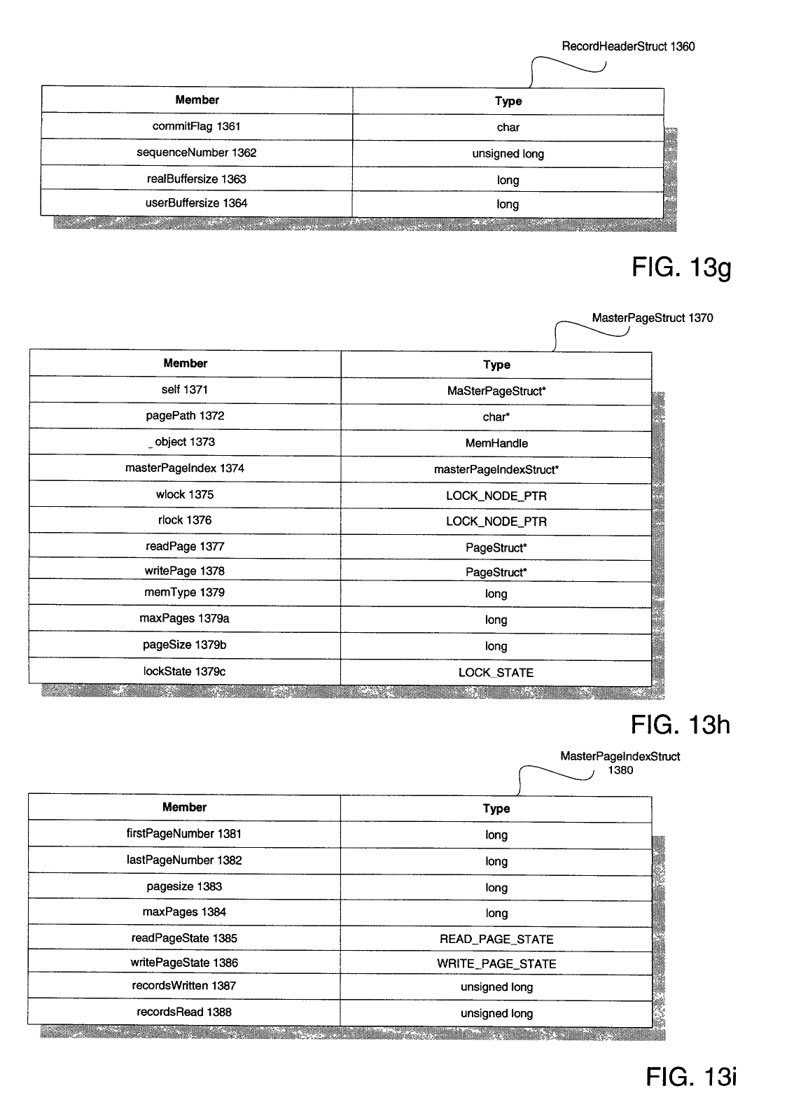

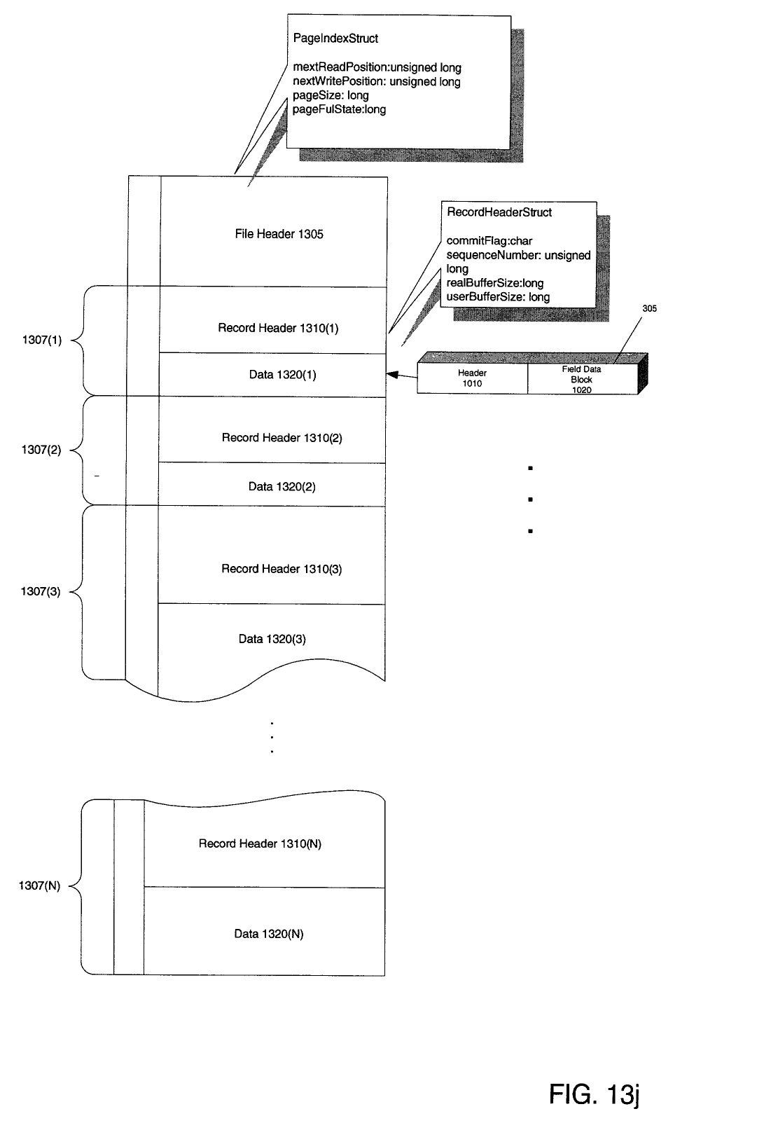

According to one embodiment of the present invention, channels 380 are physically realized utilizing a memory mapped data structure referred to herein as a page file. FIG. 13a depicts a relationship between a number of channels and corresponding page files and a channel file according to one embodiment of the present invention. As shown in FIG. 13a, each channel 380a-380c is associated with a respective page file 1310a-1310c. Page files 1310 function as a physical realization of channels 380. Note that page files 1310 store one or more messages 305 generated by modules 201. For example, messages 305a(1)-305a(N) reside in page file 1310a, messages 305b(1)-305b(N) reside in page file 1310b and messages 305c(1)-305c(N) reside in page file 1310c. According to one embodiment, page files 1310 are stored upon a permanent but erasable storage medium such as hard disk 1350. Page files 1310 may be implemented as memory mapped files on a given host 114 so that data (i.e., messages 305) stored within page files 1310 may be accessed using a convenient and fast memory pointer scheme. According to this scheme, a block of RAM (“Random Access Memory”) is reserved to correspond to a particular block of disk storage space so that data written to RAM corresponds to particular physical storage space on hard disk 1350. According to an alternative embodiment, page files 1310 may be implemented using the system's shared-memory facility in RAM on host 114.

Each page file 1310 is associated with one or more read cursors 1375 and one or more write cursors 1376. Read cursors 1375 point to a current position within a page file 1310 from which a thread is currently reading. Write cursors 1376 point to a current position within a page file 1310 from which a thread is currently reading. As noted, any number of read cursors 1375 and/or write cursors 1376 may be opened for a channel 380 (i.e., page file 1310). Upon a read operation for a given read cursor 1375, data pointed to by the cursor 1375 is read by a module and the read cursor 1375 is then updated to point to the next read position within the page file 1310. Similarly, upon a write operation, data to be written for an associated write cursor 1376 is written to the position pointed to the write cursor 1376 and the write cursor 1376 is then updated to point to the next available write position within page file 1310.

Thus, for example page file 1310a is associated with channel 380a. Thereby, module 201a reads messages 305a(1)-305(N), which reside within page file 1310a and module 201a would open a read cursor 1375 with respect to page file 1310a. Page file 1310b is associated with channel 380b. Because module 201a interacts with module 201b (i.e. passes messages 305 to module 201b over channel 380b), the default output channel of module 201a, 380b, is set as the default input channel, 380b, of module 201b. In addition, module 201a would typically open one or more write cursors 1376 with respect to page file 1310b. Similarly, module 201b would typically open one or more read cursors 1375 with respect to page file 1310b. Page file 1310c is associated with channel 380c. Module 201c thereby would open a write cursor 1376 with respect to page file 1310c.

Channel file 1320, which resides on hard disk 1350 or in RAM (not shown), stores a master list of all channels 380 that have been opened for all applications 405 currently running on host 114. Among other things, channel file 1320 provides a centralized repository of opened channels 380 so that modules 201 included within an application 405 may be made aware of previously opened channels 380 and related information.

FIG. 13b further depicts the structure of a page file according to one embodiment of the present invention. In particular, FIG. 13b illustrates an exemplary page file 1310 and a relationship between a number of messages 305, read cursors 1375 and write cursors 1376. According to one embodiment of the present invention, modules 201 may read and write from channels 380 (i.e., page files 1310) in either a committed or non-commited fashion. During a non-commited write operation, a message 305 is queued to be written to a channel 380. However, a message 305 is not physically written to the associated page file 1310 until a commit operation is executed.

In a non-commited read operation, a module 201 may read a message 305 from a channel 380. After the read, the read message 305 remains available on the channel 380 (i.e., page file 1310), and thus may be read at a later time by other threads that have opened read cursors 1375 on the channel 380. However, in a committed read operation, upon reading a message 305 from channel 380, the read message 305 may no longer be read at a later time by other threads that have opened read cursors 1375 on the channel 380.

FIG. 13b illustrates a distinction between committed and non-commited read operations, by showing committed read operations as dimmed message symbols. In particular, FIG. 13b illustrates two read cursors 1375(1) and 1375(2) and two write cursors 1376(1) and 1376(2) associated with page file 1310. Thus, note that messages 305(2) and 305(9) were read in a committed fashion from page file 1310 at a previous time (indicated by dimming).

FIG. 13c further depicts the structure of a page file according to one embodiment of the present invention. In order to maximize the efficiency of writing and reading from page file 1310, page file 1310 is segmented into one or more pages 1349(1)-1349(N). The number and size of pages 1349 associated with a page file 1310 are user defined as described below. Note that aggregate of pages 1349 included within page file 1310 function as a single file. Thus, note read cursors 1375(1)-1375(M) and write cursors 1376(1)-1376(N) traverse all pages 1349 within page file 1310.

According to one embodiment of the present invention, channels 380 are implemented utilizing an internal API (herein referred to as “DataQ”) to write physical records to a public data resource. For example, according to one embodiment the public data resource is a memory-mapped file.

FIG. 13d depicts a data structure for storing a WriteMsgStruct object according to one embodiment of the present invention. WriteMsgStruct objects 1330 are stored in memory prior to being written to a page file and are managed as a singly linked list. The DataQ API controls WriteMsgStruct objects 1330. In particular, a WriteMsgStruct object 1330 represents a datastructure used to hold a linked list of uncommitted records managed by the DataQ API. WriteMsgStruct 1330 includes members buffer 1331, buffersize 1332 and nextMsg 1333. Buffer 1331 is a pointer pointing to a character array. BufferSize is a long 32-bit data type that stores the size of a message. NextMsg 1333 is a pointer to a next WriteMsgStruct object in a linked list.

The following is an exemplary sequence of API calls to perform committed writes of WriteMsgStruct objects 1330 to a page file 1310 according to one embodiment of the present invention:

ChanIoCommitWrite( )

MTWriteCursToQ

The ChanIoCommitWrite( ) command commits all uncommitted messages 305. The MTWriteCursToQ command copies all of the records from the “buffer” within WriteMsgStruct into a memory mapped page file 1310. According to one embodiment, an API call ChanIoSendMsg( ) function is used to write (send) a message 305 through a channel 380. This function has a flag that can be set to commit or not commit the record. If the flag is set to not commit, then the message will simply sit in the DataQ within a linked list of WriteMsgStruct records—until the ChanIoCommitWrite( ) function is called.

FIG. 13e depicts a data structure for storing a PageStruct data object according to one embodiment of the present invention. The PageStruct data object shown in FIG. 13e includes a process level data structure for tracking page files 1310. As shown in FIG. 13e, PageStruct 1340 is an object including member variables self 1341, pagePath 1342, pageindex 1343, object 1344, pageData 1345, pageNumber 1346 and memtype 1347. Self 1341 is a reflexive reference to the PageStruct object. PagePath 1342 is a pointer to a character array that stores a path name where an associated page file 1310 resides. PageIndex 1343 is a pointer to a PageIndexStruct object 1340, which is the header of the page file 1310. Object 1344 stores a handle to a shared memory or memory mapped file object. PageData 1345 stores a pointer to the page file's data. PageNumber 1346 stores a long value that uniquely identifies the page file 1346. MemType 1347 stores a data object indicating whether the page file 1310 is stored as an operating system file object or purely in system memory.

Each page file 1310 includes a header with a data structure represented in a PageIndexStruct object 1350. FIG. 13f depicts a data structure for representing a PageIndexStruct object according to one embodiment of the present invention. Each PageIndexstruct object 1350 includes members nextReadPosition 1351, nextWritePosition 1352, pagesize 1353 and pageFullState 1354. NextReadPosition 1351 is an unsigned long value that holds the position in the page file of the next record to be read. NextWritePostion 1352 is an unsigned long value that stores the position in the page file of the next record to be written. PageSize 1353 stores a long value that determines the maximum number of records to be written to a page file 1310. PageFullstate 1354 stores a long value that indicates whether a page file 1310 contains its maximum number of records.

After the header, each data record is preceded with a record header, which is represented by a RecordHeaderStruct data object. FIG. 13g depicts the structure of a RecordHeaderStruct object according to one embodiment of the present invention. As shown in FIG. 13g, each RecordHeaderstruct object 1360 includes CommitFlag 1361, sequenceNumber 1362, realBuffersize 1363 and userBuffersize 1364. CommitFlag 1361 is a character value that indicates whether the record it to be automatically added to a page file queue or staged in a cursor. SequenceNumber 1362 stores an unsigned long value that indicates the position of the record within the page file 1310. RealBufferSize 1363 stores a long value pertaining to the size of the data buffer adjusted for padding. UserBuffer size 1364 stores a long value that represents the amount of data in bytes included in the record's buffer.

According to one embodiment, a MasterPageStruct object stores a path to all of the memory mapped data corresponding to a page file 1310. FIG. 13h depicts the structure of a MasterPageStruct object for storing path and memory mapped data pertaining to a page file according to one embodiment of the present invention. As shown in FIG. 13h, MasterPageStruct object 1370 includes self member 1371, pagePath member 1372, object member 1373, masterPageIndex member 1374, wlock member 1375, rlock member 1376, readPage member 1377, writePage member 1378, memType member 1379, maxPages member 1379a, pageSize member 1379b and lockState member 1379c.

Self 1371 is a reflexive reference to the MasterPageStruct object 1370. PagePath 1372 stores a character pointer, which points to the path/name of the mapped master page index file. Object 1373 is a memhandle object. MasterPageIndex 1374 stores a reference to the master page index file. Wlock 1375 stores a LOCK_NODE_PTR, which is a pointer to a lock object used for guarding writes to the data queue. Rlock 1376 stores a LOCK_NODE_PTR object that points to the lock object used for guarding reads from the data queue. ReadPage 1377 stores a PageStruct pointer. WritePage 1378 stores a PageStruct pointer. MemType 1379 stores a DATA_QMEM_TYPE object that indicates the memory storage mode of the master page index file. This may be mapped to an operating system file or stored in system memory. MaxPages 1379a stores a long value that specifies the maximum number of page files 1310 to be used by the DataQ API. PageSize 1379b stores a long value that specifies the maximum size of a page file 1310. LockState 1379c stores a LOCK_STATE parameter that indicates the level of synchronization that will be provided by the locking mechanism (i.e., process, thread or kernel).

According to one embodiment of the present invention, a data MasterPageIndexStruct data structure is maintained in memory as a memory mapping that stores information relating to a master page index file. FIG. 13i depicts the structure of a MasterPageIndexStruct according to one embodiment of the present invention. As shown in FIG. 13i, each MasterPageIndexStruct 1380 includes members firstPageNumber 1381, lastPageNumber 1382, pagesize 1383, maxPages 1384, readPageState 1385, writePageState 1386, recordswritten 1387 and recordsRead 1388. FirstPageNumber 1381 stores a long value and is used to maintain an index of the first page file 1310 (i.e., used to keep track of the head of the page file set as the window of the page rolls forward). LastPageNumber 1382 stores a long value that represents an index of the last page file 1310 (i.e., used to keep track of the tail end of the page file set as the window of pages rolls forward). PageSize 1383 stores a long value that represents the maximum page file size. This value is copied from the MasterPageStruct object. MaxPages 1384 stores a long value that represents the maximum number of page files 1310. This value is copied from the MasterPageStruct object. ReadPageState 1385 stores a READ_PAGE_STATE parameter. WritePageState 1386 stores a WRITE_PAGE_STATE parameter. RecordsWritten 1387 stores an unsigned long value that tracks the number of records written to the associated page file. RecordsRead 1388 stores an unsigned long value that tracks the number of committed reads against the associated page file 1310.

FIG. 13j depicts the organization of a page file according to one embodiment of the present invention. As shown in FIG. 13i, each page file 1310 includes a file header 1305, which is represented by a PageIndexStruct object 1350. The remainder of the page file 1310 is a structured set of data elements 1307(1)-1307(N). Data elements 1307(1)-1307(N) are structured to include a records header 1310(1)-1310(N) and a data portion 1320(1)-1320(N). Each records header 1310(1)-1310(N) is represented by a RecordHeaderStruct object 1360 according to one embodiment of the present invention. Data portions 1320(1)-1320(N) store actual messages 305, which have been written to the page file 1310 (i.e., message 305 includes header 1010 and field data block 1020).

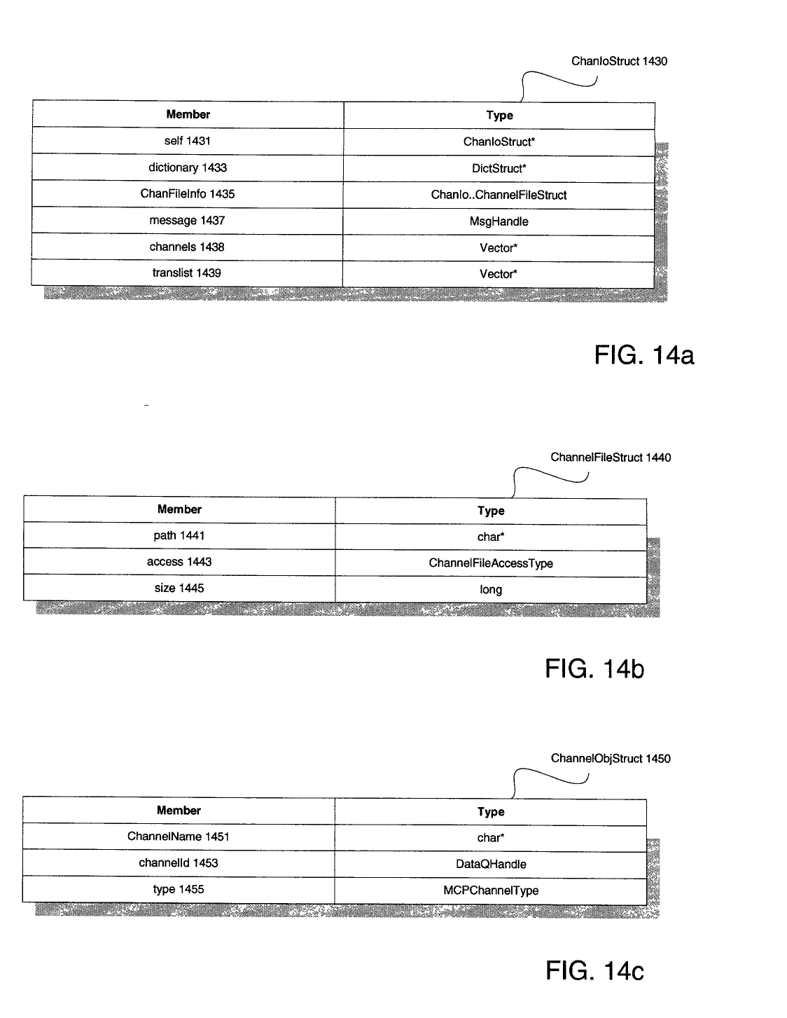

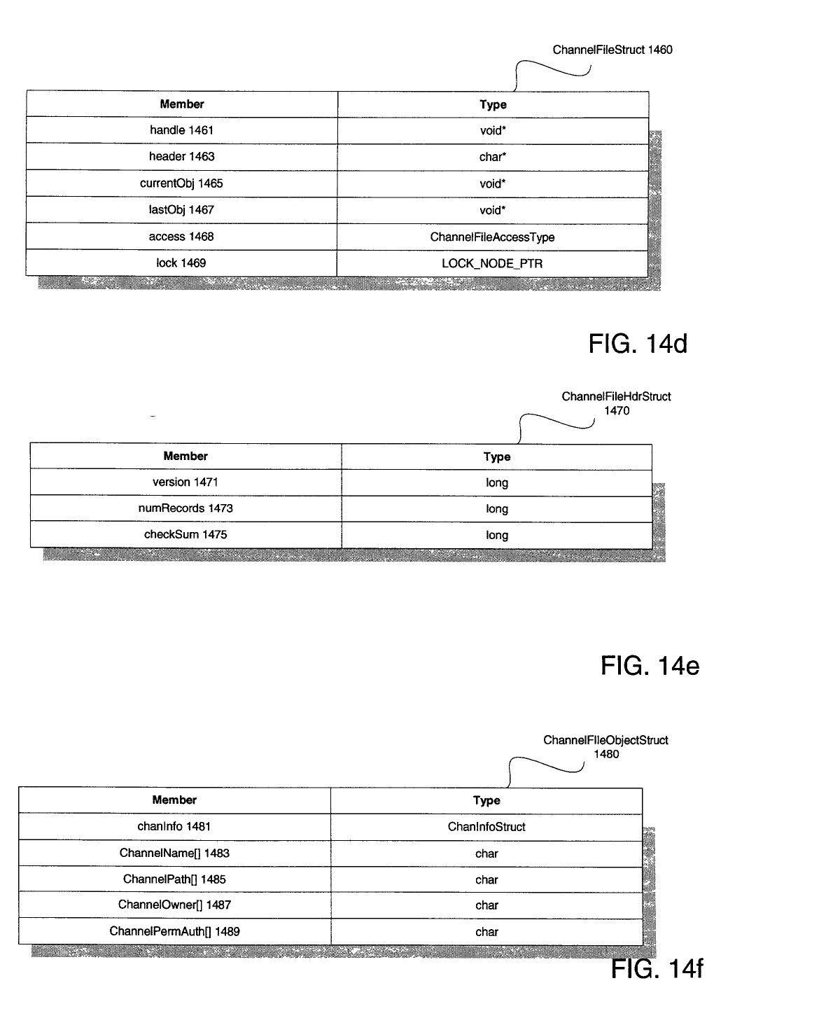

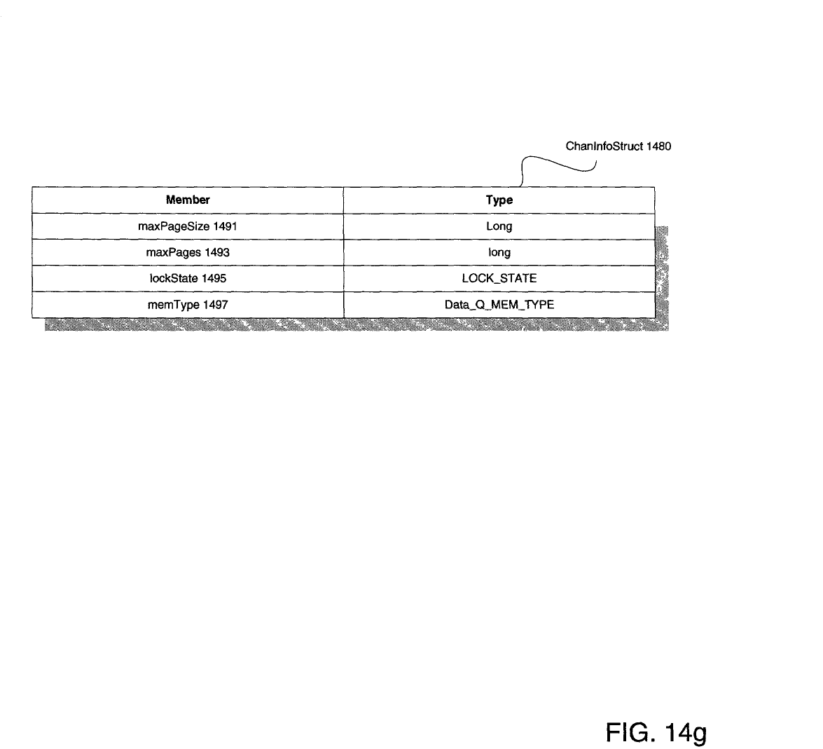

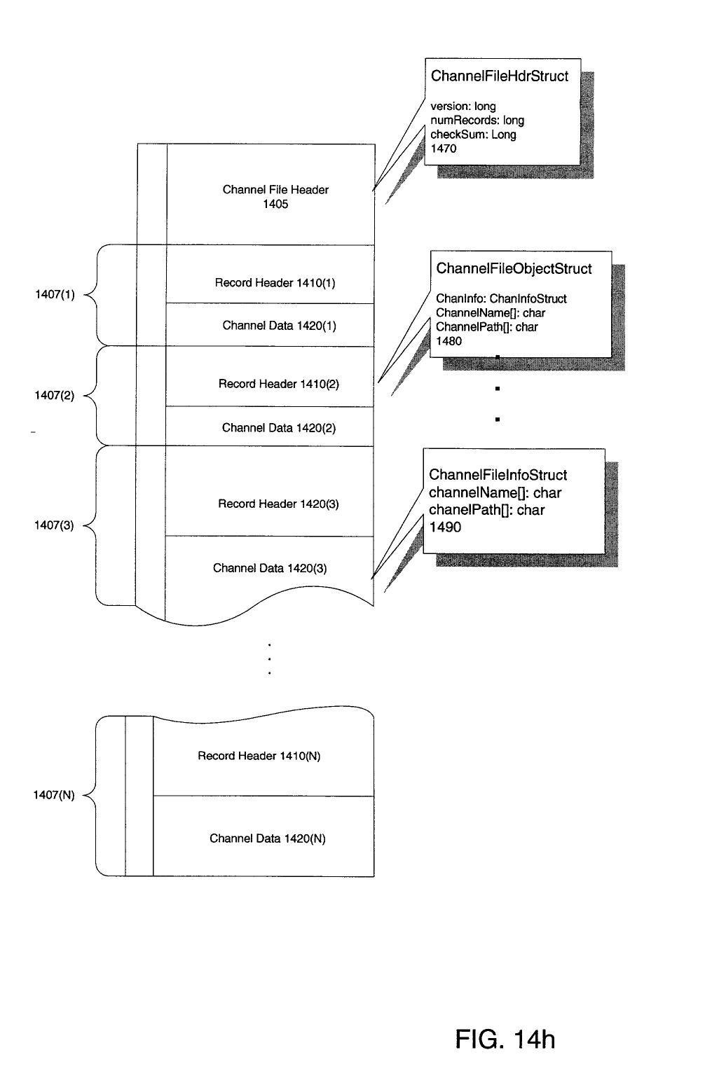

FIG. 14a depicts a data structure for representing a ChanIoStruct object according to one embodiment of the present invention. The ChanIoStruct object 1430 is a channel I/O stream abstraction. It maintains references to configuration information stored in the dictionary 620 and a master list of channels 380 and translation objects. ChanIoStruct object 1430 is allocated and initialized by an API call to CMPChanIoInit( ).

As shown in FIG. 14a, ChanIoStruct object 1430 includes members self 1431, dictionary 1433, chanFileInfo 1435, message 1437, channels 1438 and translist 1439. Self 1431 is a pointer to the ChanIoStruct object 1430 itself. Dictionary 1433 stores a pointer to an associative data structure used to store channel configuration information. ChanfileInfo 1435 stores a pointer to the channel file's path, size and access type (i.e., memory mapped or shared memory). Message member 1437 stores a MsgHandle data structure. A MsgHandle is a data structure used to send and retrieve messages from channels 380. Channels 1438 stores a pointer to a vector of channels 380 to be managed. Translist member 1439 stores a list of translation objects.

FIG. 14b depicts a data structure for representing a ChannelFileStruct object according to one embodiment of the present invention. A ChannelFileStruct object 1440 is used when creating a channel file. An instance of ChannelFileStruct 1440 is allocated as a member of ChanIoStruct 1430 in the call to MCPChanIoInito. ChannelFileStruct object 1440 includes path member 1441, access member 1443 and size member 1445. Path member 1441 stores a pointer to a character string of a directory path to a channel file. Access 1443 stores a switch variable ChannelFileAccessType that designates whether the channel file is to be stored in a file mapping or in a shared memory object. Size member 1445 stores a long data type that specifies a size of the channel table file.

FIG. 14c depicts the structure of a ChannelObjStruct object according to one embodiment of the present invention. ChannelObjStruct 1450 associates a channel with a DataQ. ChannelObjStruct 1450 includes members ChannelName 1451, channeled 1453 and type 1455. A call to MCPChanIoCreateChannel( ) allocates and initializes a ChannelObjStruct object. ChannelName 1451 stores a pointer to a channel name passed to the API call MCPChanIoCreateChannel( ). Channel ID 1453 stores a reference to an associated DataQ object. Type 1455 stores an indication of the channel type (user, default, inbound or default outbound).

FIG. 14d depicts the structure of a ChannelFileStruct object according to one embodiment of the present invention. Each ChannelFileStruct object 1460 includes members handle 1461, header 1463, currentObj 1465, lastObj 1467, access 1468 and lock 1469. Handle 1461 stores a reference to an underlying memory object. Header 1463 stores a local mapping of either the shared memory or memory mapped object. CurrentObj 1465 stores a pointer to the position within the channel file of the next available ChannelFileStruct object 1460. LastObj 1467 stores a pointer to the position of the last valid ChannelFileObjectStruct record 1460 in the channel file. Access 1468 stores the storage mode for the channel file (i.e., shared memory or memory mapping). Lock 1469 is a data structure, which supports process and thread synchronization.

FIG. 14e depicts the structure of a ChannelFileHdrStruct object according to one embodiment of the present invention. ChannelFileHdrStruct 1470 includes members version 1471, records 1473 and checksum 1475. Version 1471 stores the channel file version. NumRecords 1473 stores the number of ChannelFileObjectStruct records 1460 in the channel file. CheckSum 1475 is generated when the channel file is first initialized.

FIG. 14f depicts the structure of a ChannelFileObjectStruct object according to one embodiment of the present invention. Each ChannelFileObjectStruct object 1480 includes members ChanInfo 1481, ChannelName 1483, ChannelPath 1485, ChannelOwner 1487 and ChannelPermAuth 1489. ChanInfo 1481 stores a pointer to a ChanInfoStruct (described below). ChannelName 1483 stores a channel name. ChannelPath 1484 stores a path to a channel. ChannelOwner 1487 stores a module id of a channel owner. ChannelPermAuth 1489 stores the name of a resource within the authorization facility when looking for channel permission table requests.

FIG. 14g depicts the structure of a ChanInfoStruct object according to one embodiment of the present invention. Each ChanInfoStruct object 1490 includes members maxPageSize 1491, maxPages 1493, lockState 1495 and memType 1497. MaxPageSize 1491 stores a maximum page file size. MaxPages 1493 stores a maximum number of pages. LockState 1495 stores a synchronization mode parameter. MemType 1497 stores a parameter relating to a storage node for the page file 1310.

FIG. 14h depicts the organization of a channel file according to one embodiment of the present invention. As shown in FIG. 14h, each channel file 1320 includes a file header structure 1405, which is represented by a ChannelFileHdrStruct object 1470. The remainder of the channel file 1320 is a structured set of data elements 1407(1)-1407(N). Data elements 1407(1)-1407(N) are structured to include a records header 1410(1)-1410(N) and a data portion 1420(1)-1420(N). Each records header 1410(1)-1410(N) is represented by a ChannelFileObjectStruct object 1480. Data portions 1420(1)-1420(N) store ChanFileInforStruct objects 1490.

During deployment step 241, modules 201 comprising an application 405 are deployed to a computing environment based upon a deployment scheme. In order for an application 405 to run within a computing environment, a runtime environment must be installed on each host 114 in the computing environment 121 in which one or more modules 201 from the application 405 will reside.

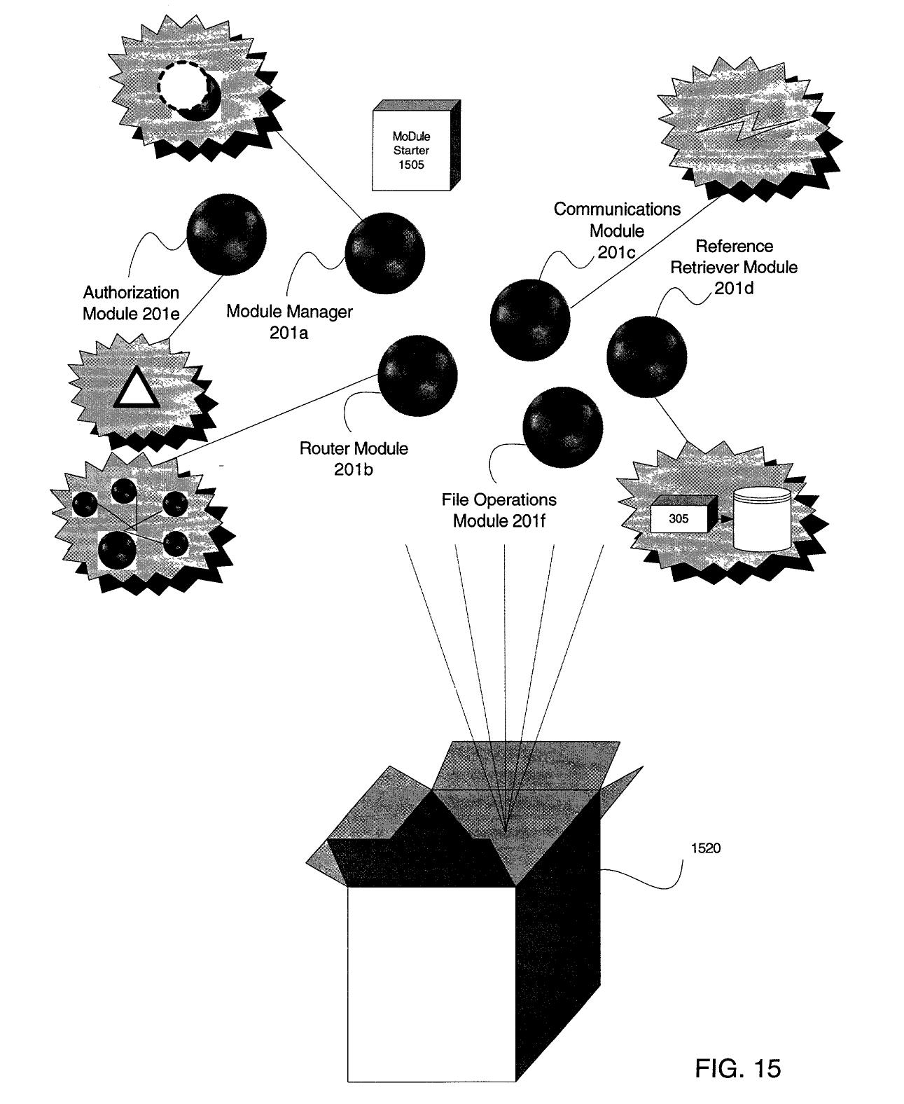

FIG. 15 depicts a core runtime environment package according to one embodiment of the present invention. Core runtime environment package 1520 includes module manager module 201 a, router module 201b, communications module 201c, reference retriever module 201d, authorization module 201e and file operations module 201f. According to one embodiment, as part of a deployment step for an application, which is described in detail below, one or more modules 201 included within core runtime environment package 1520 may be installed upon hosts 114 within a computing environment 121. Note that each module included within core runtime environment package 1520 (i.e. modules 201a-201f) utilizes a structured code paradigm as described above, and thus is associated with an initialization function 910, work function 920 and termination function 930.

Module manager 201a provides functionality for starting, suspending, stopping and cloning modules running on a host 114 on which module manager 201a has been deployed. Cloning of modules 201 is a method of balancing the load of a given module 201 and involves invoking identical instances of the running module code, which all share the same input and output channels 380. According to one embodiment, module manager 201a is associated with one or more child modules, which defines other modules 201 that module manger module 201a is to control on the same host 114 as module manager 201a.

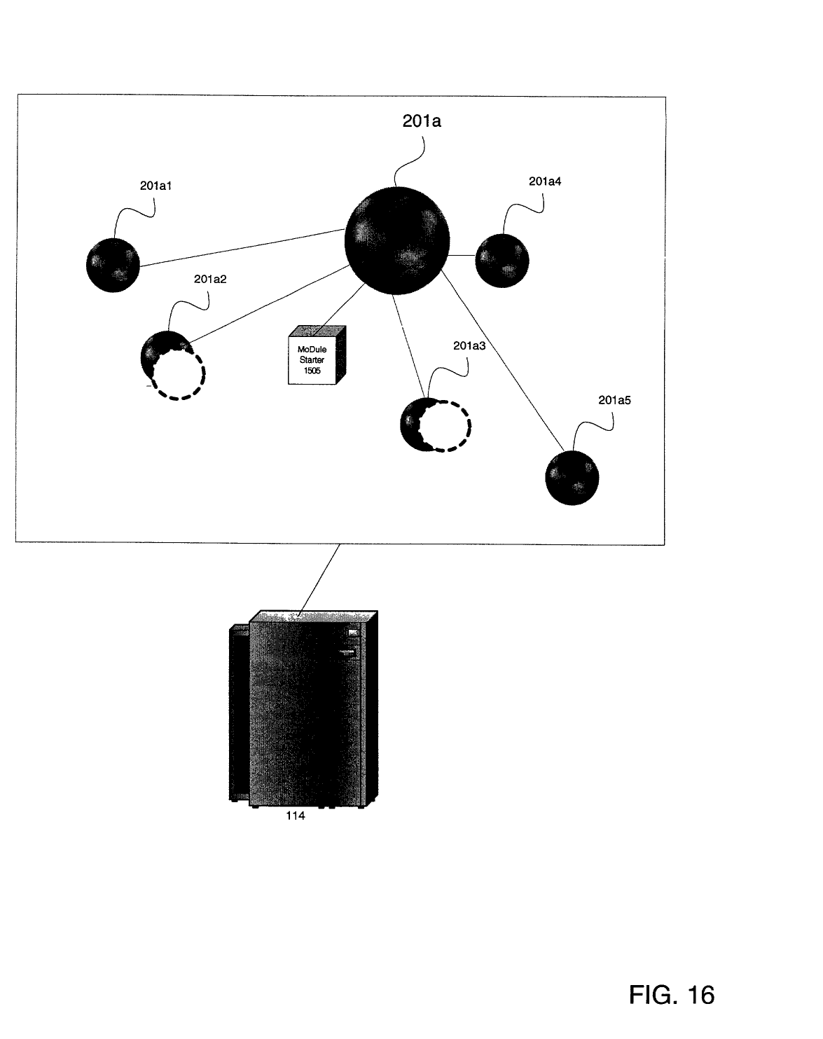

FIG. 16 depicts an exemplary operation of a module manager module according to one embodiment of the present invention. As shown in FIG. 16, module manager 201a controls operations of one or more other modules 201 associated with a particular host 114 (i.e., the child modules 201 of module manager 201). Thus, referring to FIG. 16, module manager 201a controls operation of child modules 201a1-201a5. In particular, module manager 201a may start, stop, clone or suspend modules 201a1-201a5. In addition, module manager 201a may dynamically change configuration file 720 information for particular child modules 201a1 -201a5 in order to control operation of those modules 201. For example, FIG. 16 illustrates module manager 201a altering configuration information for modules 201a1, 201a2 and 201a3. Also, as exemplified in FIG. 16, module manager 201a causes initialization of module 201a2 and termination of module 201a3.

According to one embodiment of the present invention, module manager 201a effects initialization, suspension, cloning and/or termination of modules 201 by causing the respective initialization 910 and/or termination functions 930 of those modules 201 to be called. According to one embodiment, this is accomplished via module starter process 1705.

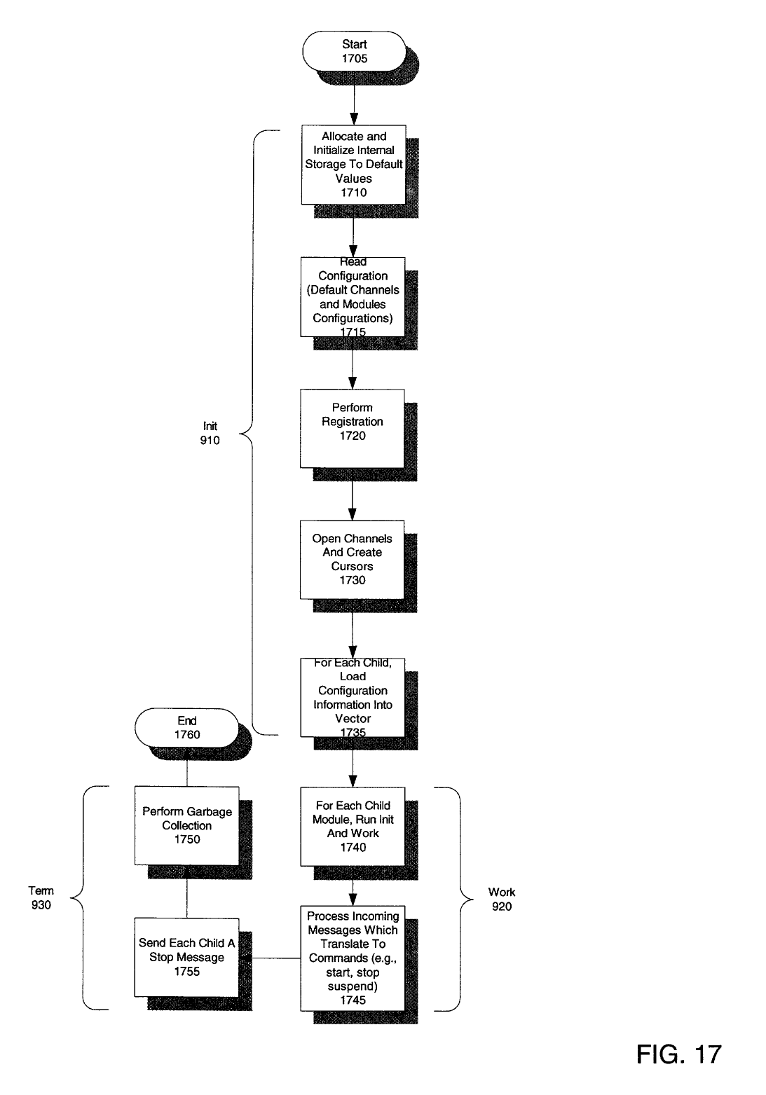

FIG. 17 is a flowchart depicting various steps included in an initialization function, work function and termination function of a module manager according to one embodiment of the present invention. The process is initiated in step 1705. Steps 1710-1735 are executed as part of an initialization function 910. Specifically, in step 1710, internal storage is allocated and initialized. In step 1715, configuration file 720 is read into a dictionary structure 620 including default channels and the module configuration. In step 1720, the module name for module manager 201a is registered with the environment. In step 1730, channels and cursors are opened and initialized. In step 1735, all configuration information for all children modules 201 are read into a vector. According to one embodiment, this is accomplished by reading data from the configuration file.

Steps 1740 and 1745 are executed as part of a work function 920 of module manager 201 according to one embodiment. Specifically, in step 1740 the initialization and work functions (910, 920) are executed for all children modules 201. In step 1745, a process loop is entered in which each incoming message is processed and an appropriate function executed as a result. For example, module manager 201a may receive messages to stop, suspend or start one or more children modules 1745. As module manager 201a has retrieved configuration information for children modules 201 and stored this information within a vector, module manager 201 may call initialization, work and/or termination functions 910, 920 and 930 of children modules 201.

Steps 1750 and 1755 are executed as part of a termination function 930 of module manager 201 according to one embodiment of the present invention. In step 1750, module manager 201 transmits a stop message 305 to each child module 201. In step 1655, module manager 201 performs garbage collection. The process ends in step 1760.

According to one embodiment, a module starter process performs the startup (i.e., initialization of modules 201). According to one embodiment, the module starter is started with the following command:

modstarter file://filepath

In this command, modstarter (module starter) is the name of a bootstrap function/program that initiates module execution and filepath denotes the location of the module's configuration file in the file system.

After the modstarter command has been submitted, the following events take place:

1. The module starter loads the configuration file into memory and looks in it for two parameters, one labeled CodeEntryFile and the other CodeEntrySym. (As explained in the preceding section, the value of the CodeEntryFile parameter points to the shared library which contains the module code itself, the definitions of the module initialization, work and termination functions, the definition of the MCPLinkInfoStruct data type and the array MCPModules[ ]. The CodeEntrySym parameter contains the name of the module to be run.)

2. If the module starter finds the two entries in the configuration file, it loads the shared library referred to by CodeEntryFile and loops through the MCPModules[ ] array, trying to locate in it a module name matching the value of the CodeEntrySym parameter.

3. If the array entry with NULL data members is reached first, no match was found for CodeEntrySym and the startup process is aborted. However, if the value of the CodeEntrySym parameter is matched, the module starter loads the module.

4. Next, with a call to the module's initialization function, the module begins to execute.

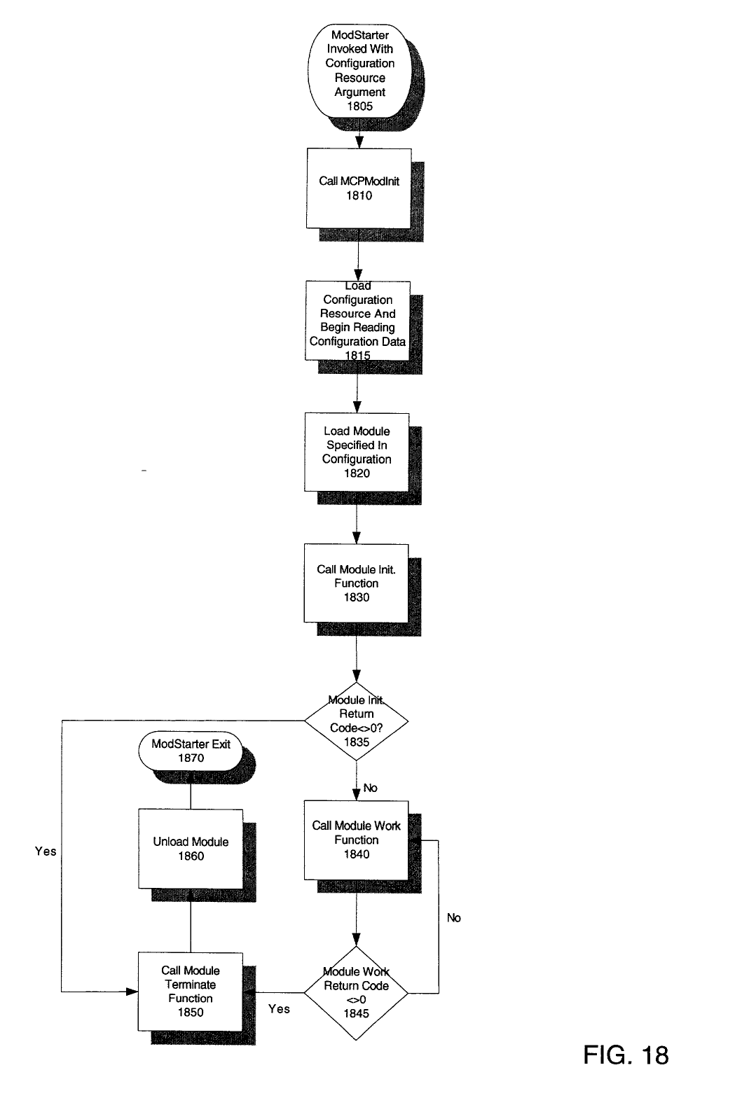

FIG. 18 is a flowchart that depicts the algorithmic structure of a module starter process. As described above with reference to FIG. 17, according to one embodiment of the present invention, a module starter 1505 is an executable file that resides on a particular host also occupied by a module manager module 201. The module manager module 201 utilizes the module starter executable 1505 to start a module 201. Specifically, referring to FIG. 18, the module starter process is initiated in step 1805 by a call from a module manager 201 including configuration resource arguments. Specifically, the configuration resource argument includes configuration data related to how the module 201 should be started. In step 1810a function call is made to MCPModInit (a function call in module API 610a) to start the module 201. In step 1815 an associated configuration resource and additional configuration data is read. In step 1820 the module 201 referenced in the configuration is loaded. In step 1830 the initialization function 910 is called for the module 201. In step 1835 it is determined whether the initialization attempt did not return a zero value. If not (‘no’ branch of step 1835) flow continues with step 1840 and the work function 920 for the module 201 is called. If so (‘yes’ branch of step 1835) flow continues with step 1850 and the module terminate function 930 is called. In step 1845 it is determined whether the attempt to call the module work function 290 did not return the value zero. If so (‘yes’ branch of step 1845), flow continues with step 1850 and the module terminate function 930 is called. If not (‘no’ branch of step 1845), flow continues with step 1840 and another attempt is made to call the module work function 920. In step 1860 the module 201 is unloaded. The process ends in step 1870.

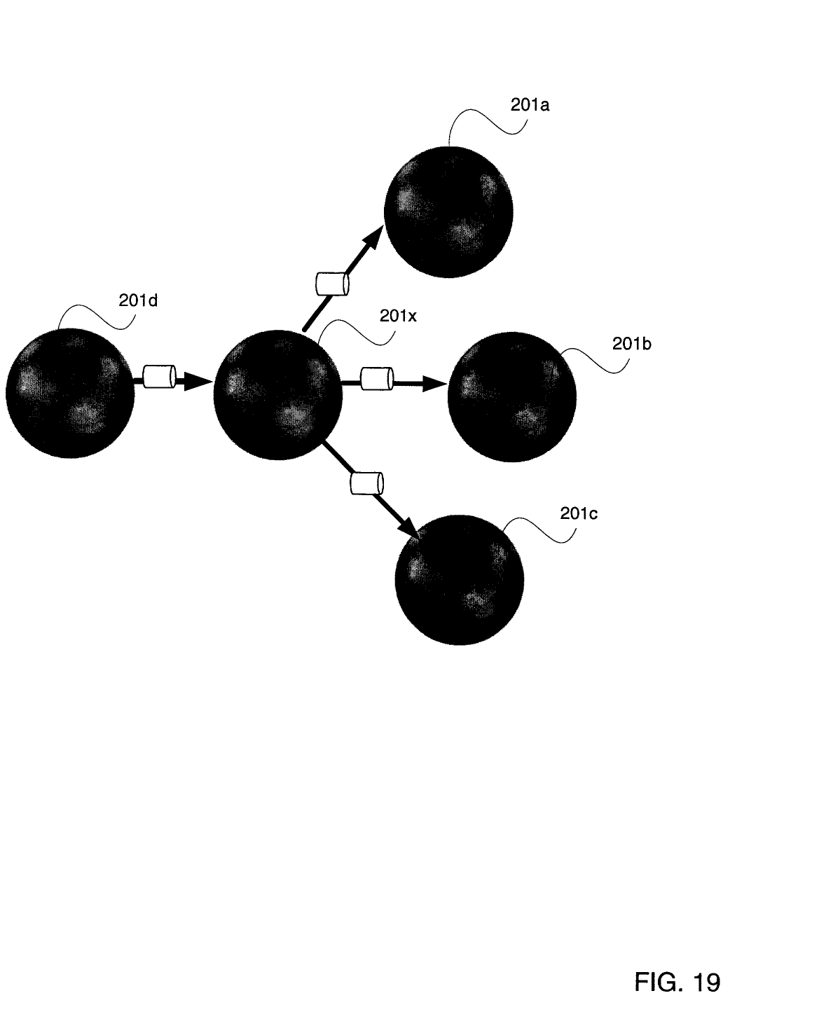

FIG. 19 schematically depicts the operation of a router module according to one embodiment of the present invention. A router module 201 is tasked with dynamic routing of messages 305 between modules 201. Conditional routing of messages 305 may be accomplished utilizing a routing table (not shown) as defined within a configuration file 720. Routing may also be effected dynamically such that rules may be added or removed during runtime. As shown in FIG. 19, router module 201x performs routing of messages received from module 201d to modules 201a-201c. According to one embodiment, router module 201x utilizes a routing table (not shown) stored in the configuration file 720 for the router module 201x that provides routing information for performing routing of modules to modules (e.g., 201a-201c). Furthermore, routing rules stored in a routing table may be edited and reconfigured at runtime.

Thus, for example, as shown in FIG. 19, the default output channel of module 201d is connected to the default input channel of router module 201x. Utilizing routing information, module 201d may send messages 305 to modules 201a, 201b and/or 201c.

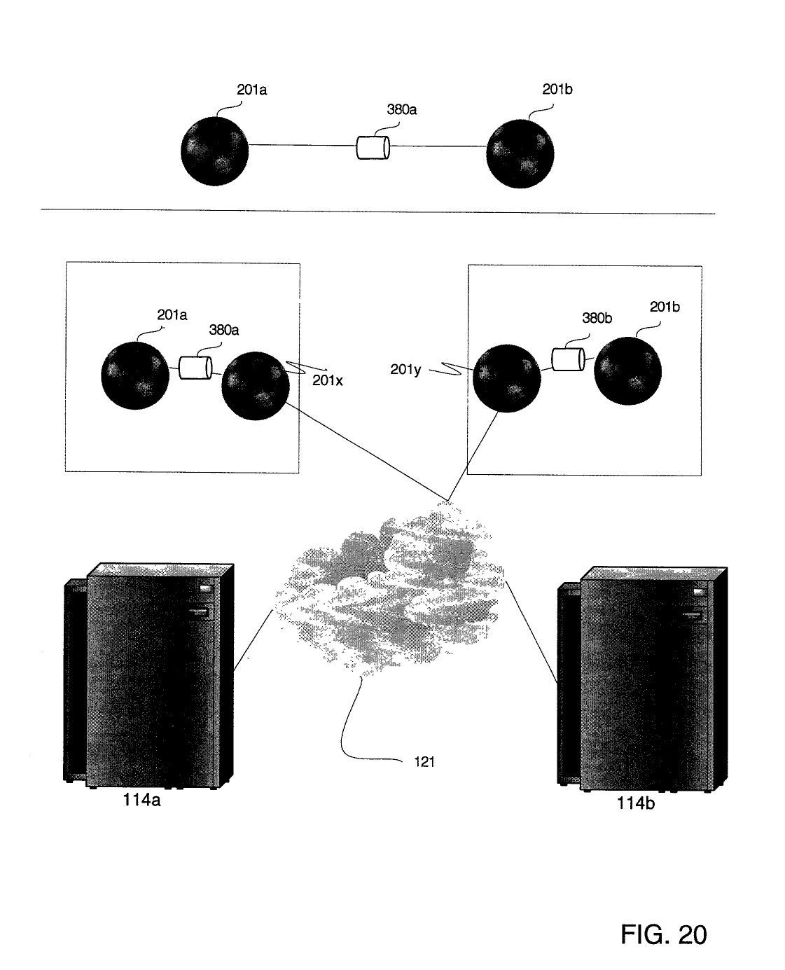

According to one embodiment of the present invention, interaction between modules 201 deployed on separate hosts 114 may be affected by utilizing a sender module 201 and receiver module 201. A sender module 201 maps a particular channel 380 to a particular physical or virtual communications port. FIG. 20 schematically depicts the operation of a sender and receiver module 201 according to one embodiment of the present invention. Note that modules 201a and 201b are deployed on separate respective hosts 114a and 114b. Application 405 (not shown) including modules 201a and 201b requires interaction between module 201a and module 201b as if modules 201a and 201b were coupled together via channel 380 (shown on top portion of FIG. 20). In order to achieve interaction between modules 201 deployed on separate hosts, sender modules 201 and receiver modules 201 may be deployed on separate respective hosts 114. A sender module 201 and a receiver module 201 may interact and exchange messages 305 across separate hosts coupled together on a network 121. In particular, a sender module 201 and a receiver module 201 may communicate over a network 121 utilizing a particular network protocol such as TCP/IP (“Transmission Control Protocol/Internet Protocol”). Returning to the example shown in FIG. 20, module 201a deployed on host 114a is coupled to sender module 201x via channel 380a. Similarly, on host 114b, module 201b is coupled to receiver module 201y via channel 380b. Module 201a deployed on host 114a may thus interact with module 201b deployed on host 114b by sending messages 305 to sender module 201x via channel 380b. Messages 305 received by sender module 201x from module 201a on default input channel 380a are transmitted over network 121 to receiver module 201y on host 114b. Receiver module 201y then transmits received messages 305 on default output channel 380b to module 201b.

A multiplexer module 201 and demultiplexer module 201 may be deployed to extend and preserve multiple physical channels 380 across a single channel divide. A multiplexer module 201 performs (as its work function 920) the operation of combining messages 305 arriving from multiple channels 380 so that they can be transported over a single channel 380. A demultiplexer module 201 performs the function of demultiplexing messages 305 arriving over a single channel 380 into separate channels 380. According to one embodiment, information encoded with each multiplexed message 305 is read by demultiplexer module 201 to determine the appropriate channel 305 to divide multiplexed messages 305.

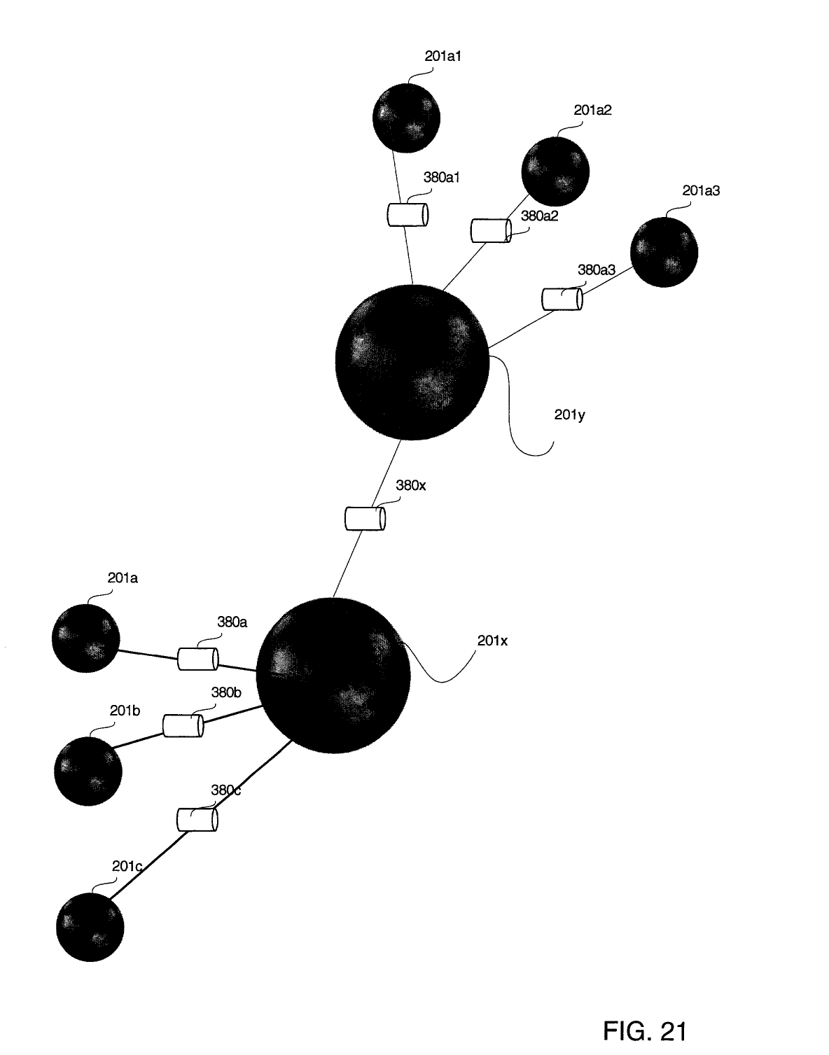

FIG. 21 depicts the operation of a multiplexer and demultiplexer module according to one embodiment of the present invention. As shown in FIG. 21, it is assumed that it is desired for modules 201a, 201b and 201c to interact with modules 201a1, 201b1 and 201c1 respectively. Typically, the interaction scheme just described would require three separate channels 380 respectively coupling module 201a to module 201a1, module 201b to module 201b1 and module 201c to module 201c1. However, the same interaction may be achieved by utilizing multiplexer module 201x and demultiplexer module 201y. In particular, modules 201a, 201b and 201c respectively transmit messages to multiplexer module 201x via channels 380a, 380b and 380c. Multiplexer module 201x combines messages arriving on channels 380a, 380b and 380c and transmits these messages 305 to default output channel 380x. Demultiplexer module 201y receives multiplexed messages 305 arriving on default input channel 380x and demultiplexes the messages 305 into respective default output channels 380a1, 380a2 and 380a3, which are respectively coupled to modules 201a1, 201b1 and 201c1. Thus, it is assumed under this example that messages 305 bound for module 201a1 from module 201a are demultiplexed to channel 380a1, messages 305 bound for module 201b1 from module 201b are demultiplexed to channel 380b1 and messages 305 bound for module 201c1 from module 201c are demultiplexed to channel 380c1.

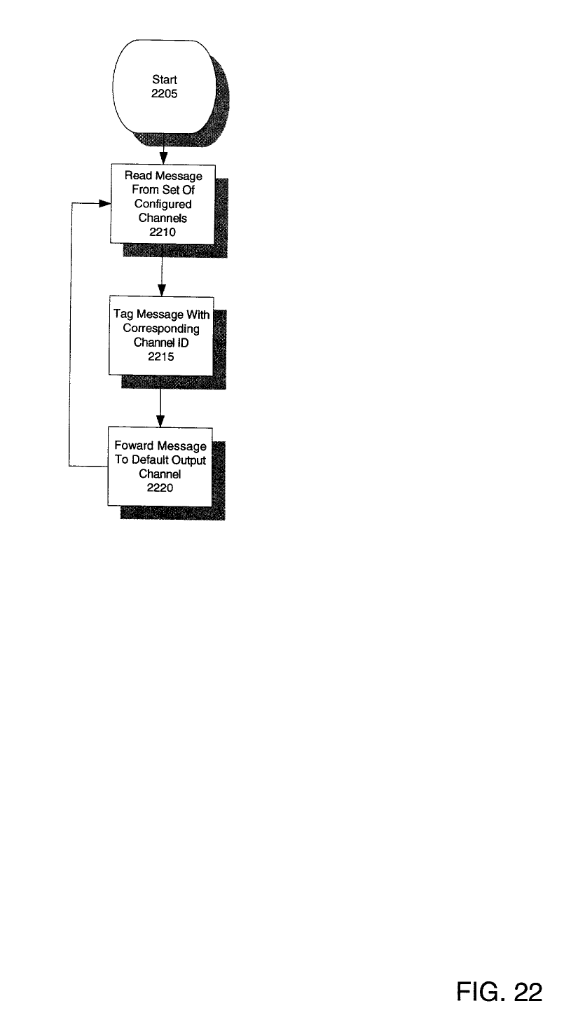

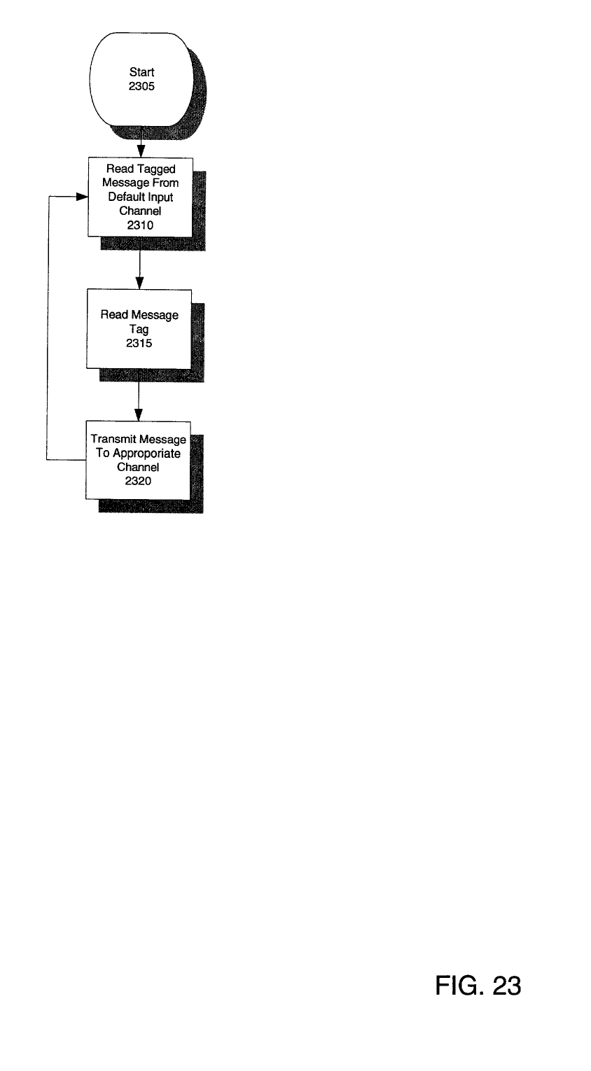

FIG. 22 is a flowchart depicting the work function operation of a multiplexer module according to one embodiment of the present invention. The process is initiated in step 2205. In step 2210, multiplexer module 201 reads a message from one of its configured input channels 380. In step 2215, multiplexer module 201 tags the message 305 with a corresponding channel identifier. According to one embodiment, this is accomplished by appending a channel identifier of the channel 380 being multiplexed to a list within a field named _MuxChan. In step 2220, multiplexer module forwards the message to its default output channel 380.

FIG. 23 is a flowchart depicting the work function operation of a demultiplexer module according to one embodiment of the present invention. The process is initiated in step 2305. In step 2310, demultiplexer module 201 reads a tagged message 305 from its default input channel 380. In step 2315, demultiplexer module 201 finds the _MuxChannel field value. In step 2320, demultiplexer module forwards the message to the appropriate output channel 380 as a function of the _MuxChannel field value.

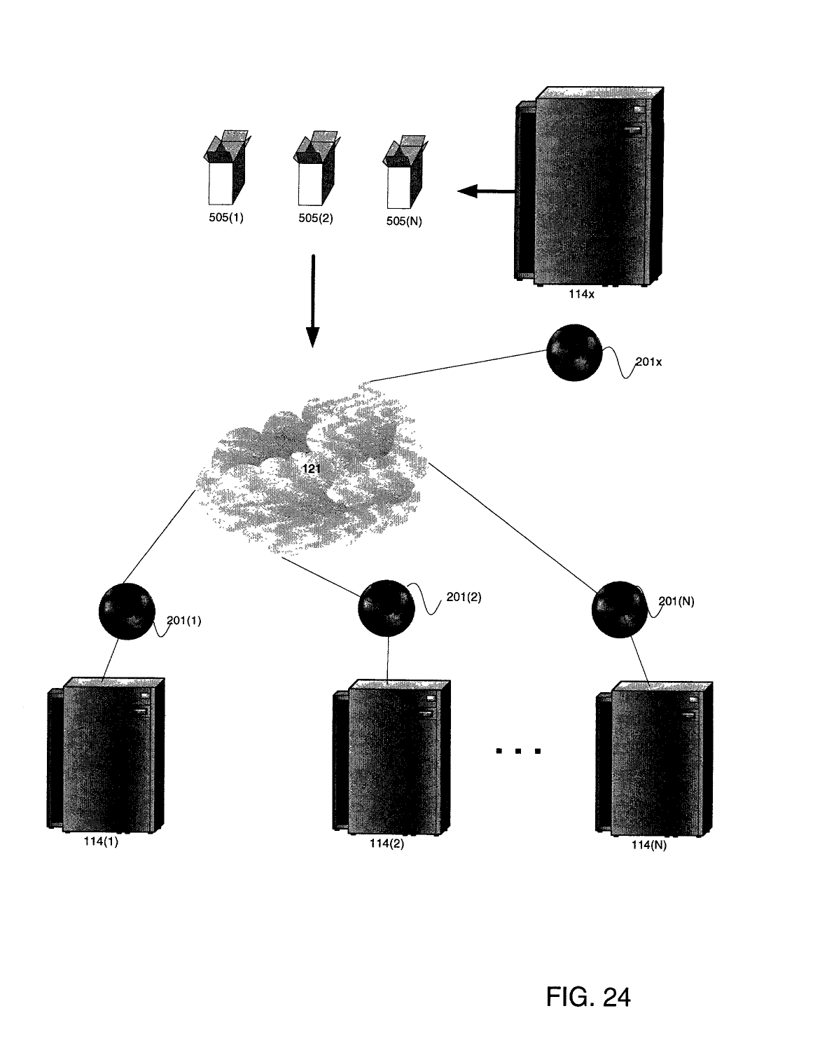

FIG. 24 depicts the operation of a communications module according to one embodiment of the present invention. As described below, the present invention provides for the automated deployment of modules 201 included within an application to any number of hosts 114 within a computing environment 121. Referring to FIG. 24, it is desired to deploy components 505(1)-505(N) comprising an application 405 within a computing environment 121 including hosts 114(1)-114(N). In order to accomplish this, a respective communications module 201(1)-201(N) is deployed upon each respective host 114(1)-114(N). A communications module 201 provides a conduit for the deployment of modules 201 including a runtime environment itself 1520 on a host 114. Accordingly, host 114x is also equipped with a communications module 201x. Communications module 201x on host 114x performs transmission of modules 201 to hosts 114(1)-114(N) where application 405 will be installed and executed.

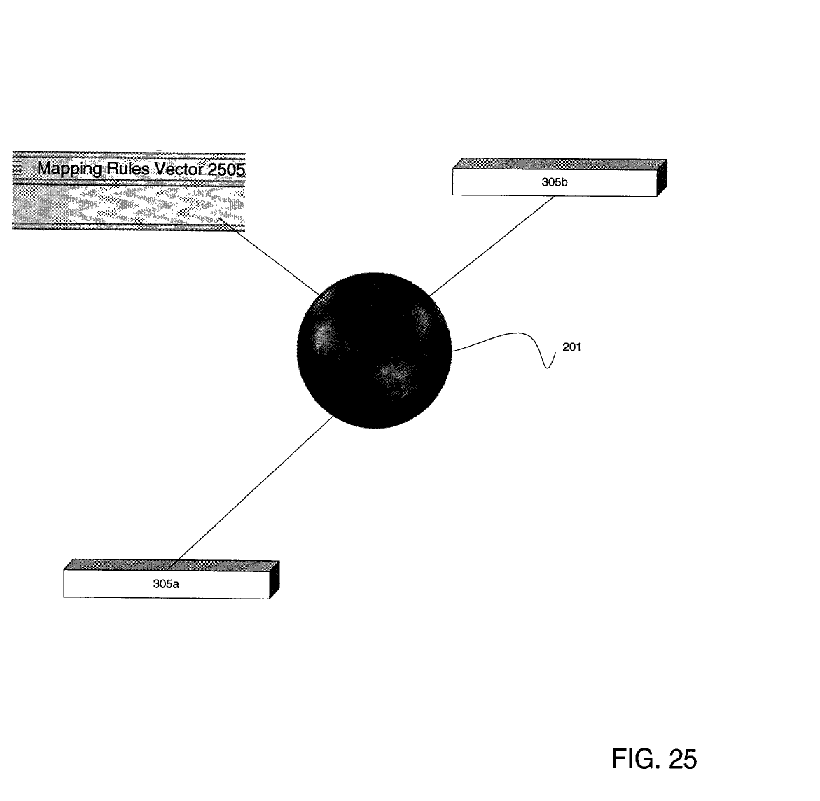

FIG. 25 depicts the operation of a data mapper module according to one embodiment of the present invention. A data mapper module performs the task of transforming message formats based upon conditional rules. Message data may be re-mapped or aggregated. As shown in FIG. 25, data mapper module 201 receives message 305a and performs a rule look-up utilizing mapping rules vector 2505. In particular, mapping rules vector 2505 stores mapping rules for actions (i.e., mappings) to be undertaken with respect to certain message types or formats. If a match is found in mappings rules vector, a data mapping and/or transformation for the message 305a is performed to generate message 305b. If no match is found, data mapper module 201 simply outputs the message 305a without any alteration. Note that a data mapper module 201 may map on a one-to-one, many-to-one or many-to-many basis.

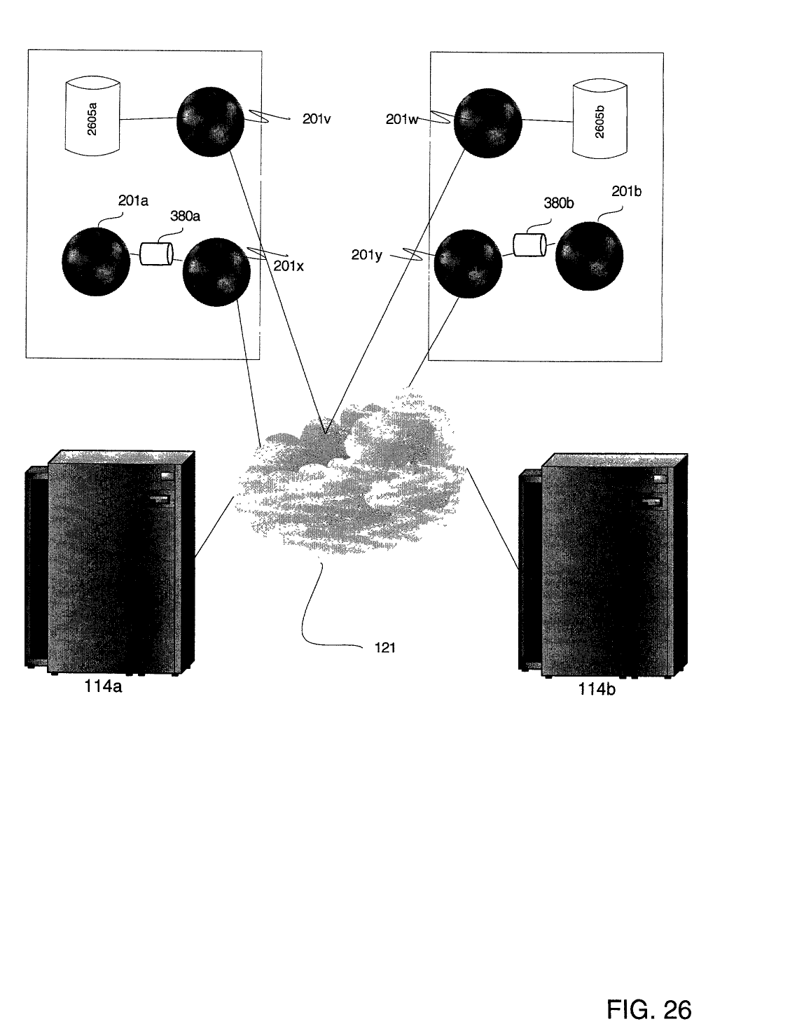

In order to run an application 405 where modules 201 may be distributed across multiple hosts 114, it may become necessary for a particular host 114 to retrieve or gain access to particular files that may reside on a remote host. In particular, the present invention provides functional to define large data references such as fields, files and vectors within a message. According to one embodiment, a specially designed module 201 referred to herein as a reference retriever module performs functions for resolving remote file access and reference requests. FIG. 26 depicts the operation of a reference retriever module according to one embodiment of the present invention. A reference retriever module 201 receives requests to initialize file references, to resolve file references from remote hosts 114 and to make copies of file references.

According to one embodiment the present invention provides a mechanism for transferring files by reference. Consistent with the general paradigm of the invention, a reference retriever module is employed for this purpose. A file reference is a type that provides the capability of transferring files between environments via messages without overburdening channels 380. This is achieved by passing a reference to the file on a remote system, which is automatically resolved by employing a reference retriever module that transfers a copy of the remote file onto a local system through an independent mechanism (i.e., not via message data over channels). When a file reference is encountered within a message in the environment, a reference retriever module 201 (which is deployed as part of runtime environment 1520) is called upon to resolve the remote reference to the file on the local system. The reference retriever module 201 acts as both a client and a server for out-of-channel file transfers. The local reference retriever 201 (acting as a client) uses this information to connect to the reference retriever (acting as a file server) and obtain a copy of the file, which it places onto the local file system.

FIG. 26 depicts the operation of a reference retriever module according to one embodiment of the present invention. Note that module 201a, sender module 201xand reference retriever module 201v are deployed on host 114a. Module 201a interacts with sender module via channel 380. Module 201b, receiver module 201yand reference retriever module 201w are deployed on host 201w. Receiver module 201y interacts with module 201b via channel 380b. Sender module 201xcommunicates with receiver module 201y via computing environment 121 over a specific network port. For purposes of this example, it is assumed that a message 305 is transmitted from module 201a on host 114a to module 201b on host 114b. When the message 305 with the file reference reaches receiver module 201y on host 114b, a request to resolve the reference into a local file is sent to reference retriever module 201w on host 114b. The file reference has all of the required information to contact reference retriever 201v on host 114a to copy the file from host 114a to 114b. When module 201b receives the original message, the reference information points to a local copy of the original file on host 114b.

According to one embodiment, a special module 201 referred to as an authorization module 201 may be deployed as part of a runtime environment 1520. The function of an authorization module 201 is to provide authentication of users (or groups) for performing actions on objects. An authorization module 201 receives authorization requests from its default input channel 380. According to one embodiment, an authorization request includes information regarding a user, an object and an action to be taken with respect to that object. According to one embodiment, an authorization module 201 makes use of the RespondToMsg( ) function described above to respond to authorization requests. In particular, authorization module 201 responds with an allow/deny response as a function of the user, object and requested action.

According to one embodiment, an authorization module 201 stores information regarding actions, objects, users and groups are named entities in the authorization module's persistent configuration file 720. Sets of actions on objects are used to define roles, which are applied to users and/or groups. According to one embodiment, an authorization module 201 also has the capability of assigning tokens that may be used to authenticate actions on objects.

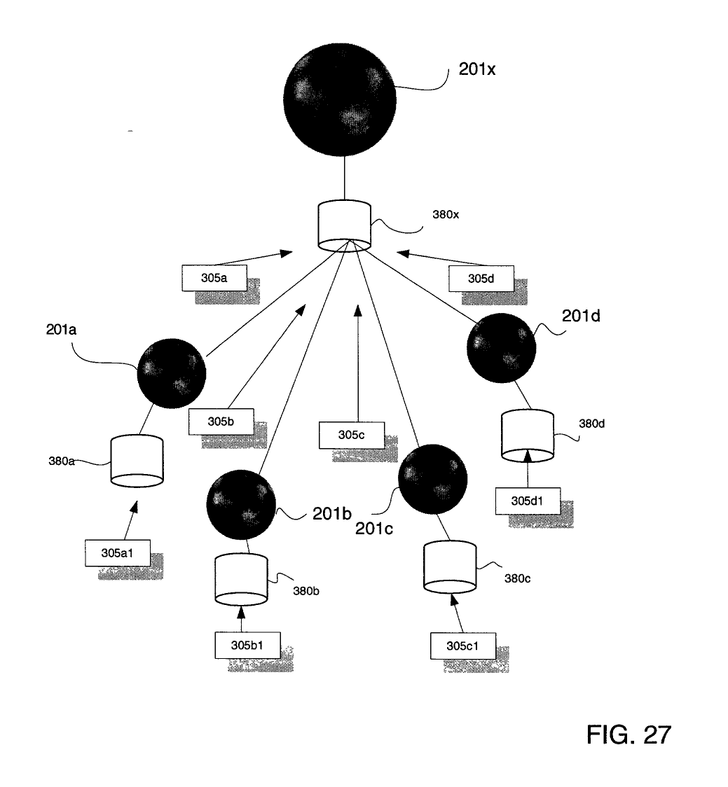

FIG. 27 depicts the operation of an authorization module according to one embodiment of the present invention. Allows for authenticated administration of authenticated objects. FIG. 27 shows authorization module 201x and modules 201a-201c. It is assumed that authorization module 201x and modules 201a-201c reside on a single host 114. Modules 201a-201c may generate “Respond To Message” requests by transmitting messages 305 on input channel 380a of authorization module 201x. Messages 305 generated by modules 201a-201c and transmitted to authorization module 201x relate to permissions and authentication for various objects including writes to channels 380, etc. Authorization module 201x generates response messages 305 for each authorization request generated by modules 201a-201c such that the response messages 305 are directly placed on the respective “respondTo” channel 380 specified by each module 201a. Accordingly, authorization module 201x places response messages 305 for module 201a directly on channel 380a, response messages 305 for module 201b directly on channel 380b, response message 305 for module 201c directly on channel 380c and response messages for module 201 directly on channel 380d.

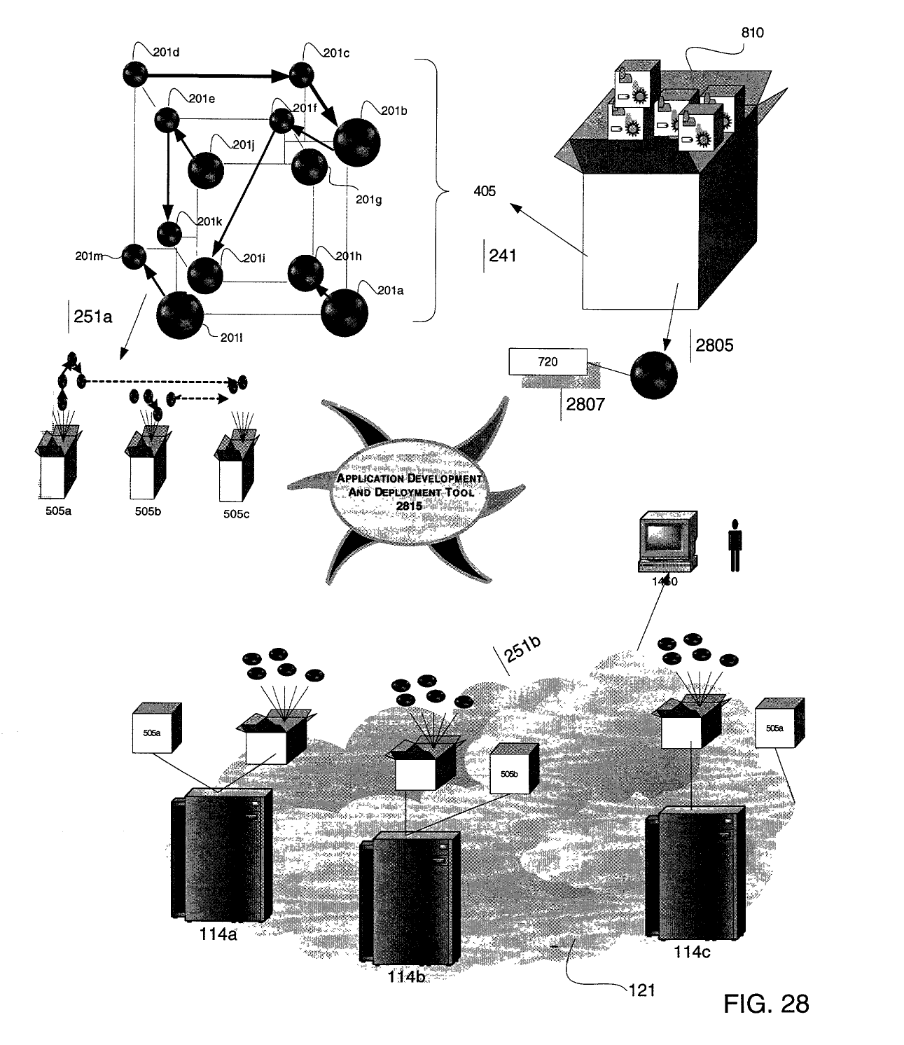

FIG. 28 illustrates the functionality of an application development and network deployment tool according to one embodiment of the present invention. Application development and network deployment tool (“ADNDT”) 2815 provides functionality for module packaging 233, application building 241 and deployment 251. The functions of ADNDT 2815 may be combined in a single functional entity or may be separated into multiple entities.

According to one embodiment, ADNDT provides a GUI environment through which an application developer may define and deploy an application 405 within a computing environment 121. As a function of input received through the GUI, ADNDT automatically populates associated configuration files 720 for modules 201 included within an application 405. ADNDT 2815 provides functionality for building an application 405 by allowing an application developer to select desired modules 201 from a module repository 810 to perform an application build step 241 and a deploy step 251 for the application. In addition, ADNDT 2815 provides functionality to allow an application developer to perform a packaging step 233 on previously coded modules 201. The development environment permits the application developer to utilize any tools of choice for performing coding step 231.

FIG. 28 graphically illustrates a set of steps for the development and deployment of an application 405 utilizing ADNDT 2815. According to one embodiment, ADNDT provides a GUI by which the application developer may select graphical icons indicating desired modules 201. In step 2807, the application developer provides configuration data for selected modules 201 necessary for successful implementation of the application 405. Configuration data may be entered manually or may be updated automatically as an application developer builds an application 405. Configuration data may include names of default input and output channels 380, setting of pre-defined switches related to a module's behavior, etc. According to one embodiment, a GUI is provided by which the application developer may edit configuration data by selecting a desired module 201 with a pointing device such as a mouse or keyboard. In particular, ADNDT 2815 provides an interface for creating and editing a configuration file 720 associated with a module 201. Thus, ADNDT provides a GUI through which an application developer may build an application using a drag and drop approach and through which configuration files for modules 205 are updated automatically as a function of the application developer's interaction with the GUI.

In application build step 241, the application developer defines communication pathways 314 between modules 201 selected for inclusion within the application 405. During step 2810, ADNDT 2815 provides automated functionality for dynamically populating configuration files 720 associated with modules 201 within the application 405 as a function of the application developer's indication of a particular interaction between modules 201. According to one embodiment, this is accomplished using a GUI provided by ADNDT, which dynamically edits configuration data within configuration file 720 as a function of the application developer's selection of an interaction relationship between modules 201. For example, according to one embodiment, the application developer may graphically connect two modules 201 for which an interaction is desired by drawing a graphical line between them using the GUI. Upon this input, ADNDT stores a named placeholder (e.g., “$PATH_1”) within the relevant configuration files 720 of each respective module 201. At this point, the communication pathway 314 between the modules 201 is undefined and further definition will require input from the application developer regarding the particular host 114 or hosts 114 upon which each respective module will be deployed. A number of exemplary situations are described below relating to the resolution of communications information for modules 201.

In deployment step 251a, the application developer defines one or more components 505 from the application 405, which designate particular hosts 114 on which each module 201 included in the application is to be installed. ADNDT 2815 further provides a GUI for component 505 definition. Furthermore, according to one embodiment ADNDT 2815 automatically collects data regarding all hosts 114 within computing environment 121 including protocol specific data. The application developer is presented with a graphical depiction of the computing environment 121 and related hosts 121 and may install components 505 by simply dragging groups of modules 201 to desired hosts 114. Furthermore, as ADNDT 2815 may automatically collect information regarding protocol implementations on various hosts 114 within computing environment 121, channel resolution and establishment of communication 314 pathways between modules 201 within an application 405 is automated. This process is described in detail below.

In deployment step 251b, the application developer may issue a command to ADNDT 2815, which causes deployment of application 405 to the computing environment 121. In particular, during this step ADNDT 2815 causes all components 505 for the defined application 405 to be remotely installed on respective hosts 405. As a preliminary step, ADNDT 2815 remotely installs a runtime environment 1520 on each host 114 defined in the deployment configuration for the application 405. Other than essential runtime entities as described above, the application developer is presented with the choice of runtime entities to be deployed to each particular host 114 in the computing environment 121.

During deployment step 251a, the application developer assigns components 505 to specific network hosts 114. According to one embodiment, when a component 505 is assigned to a host 114, as part of the deployment step 251a, ADNDT 2830 performs a step of transferring all files associated with each module 201 included within each component 505 to the respective host 114. This may be accomplished, for example, by utilizing a communications module 201 as described above. In addition, ADNDT 2830 performs appropriate steps and configuration procedures to insure that network connectivity between all modules 201 across computing environment 121 is achieved. According to one embodiment, ADNDT 2815 achieves the appropriate network configuration by pre-configuring and deploying appropriate support modules such as sender and receiver modules 201 required to achieve the desired interaction between modules 201 that may be deployed on separate hosts 114 (using the required respective protocols for those hosts 114).

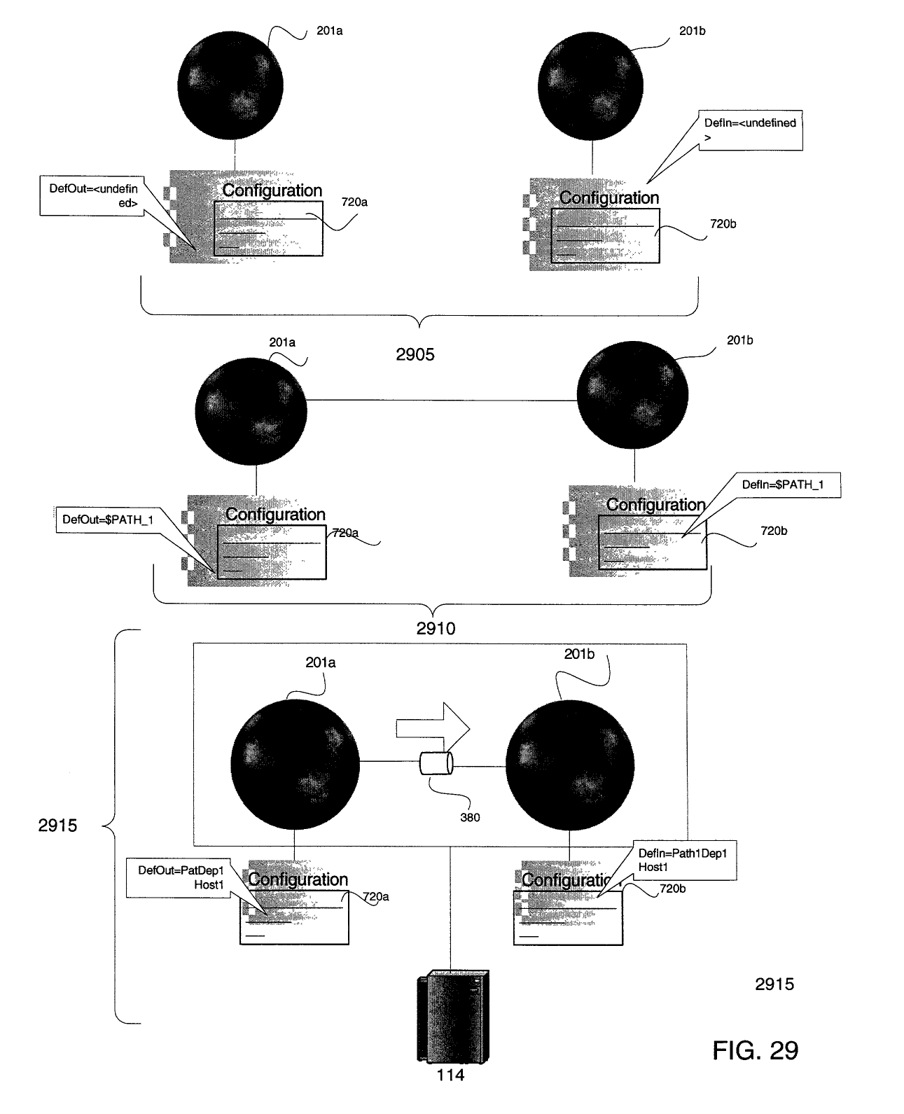

FIG. 29 graphically depicts a set of steps for the resolution of a default input channel and a default output channel by an ADNDT 2815 for modules deployed on the same host according to one embodiment of the present invention. Step 2905, shows modules 201a and 201b that have not been related to one another through a communication pathway 314. For example, modules 201a and 201b may have been previously defined and may simply be defined such that they reside in a module repository 810. Note at this step, configuration files 720a and 720b corresponding respectively to modules 201a and 201b hold undefined channel entries.

In step 2910, the application developer provides input to ADNDT 2815 (e.g., through a graphical input device) 2815 that module 201a is to interact with module 201b (i.e., by graphically drawing a communications pathway between modules 201a and 201b. In this step, ADNDT 2815 stores a named placeholder string (e.g., $PATH_1) for the yet unresolved communication pathway 314 as the default output channel 380 for module 201a and the default input channel 380 of module 201b. Note that at step 2910, the communications pathway 314 is undefined since the application developer has not indicated whether modules 201a and 201b will reside on the same host or separate hosts 114.

In step 2915, the application developer provides input to ADNDT 2815 indicating precisely where modules 201a and 201b are to reside within computing environment 121 (i.e., the particular hosts 114 on which these modules 201 will be deployed). This definition may be effected as part of a component 505 definition. Upon this input from the application developer, ADNDT 2815 will set appropriate parameters in respective configuration files 720a and 720b so that the default output channel 380 of module 201a corresponds to the default input channel 380 of module 201b. In the particular example depicted in FIG. 29, it is assumed that the application developer has indicated that modules 201a and 201b are to reside on the same host 114. In this case, the default output channel 380 of module 201a is set to the default input channel of module 201b. This is accomplished by modifying respective configuration files 720a and 720b of modules 201a and 201b. In this particular example, the default input channel 380 of module 201b and the default output channel of module 201a are set to the name “Path1Dep1Host1.”

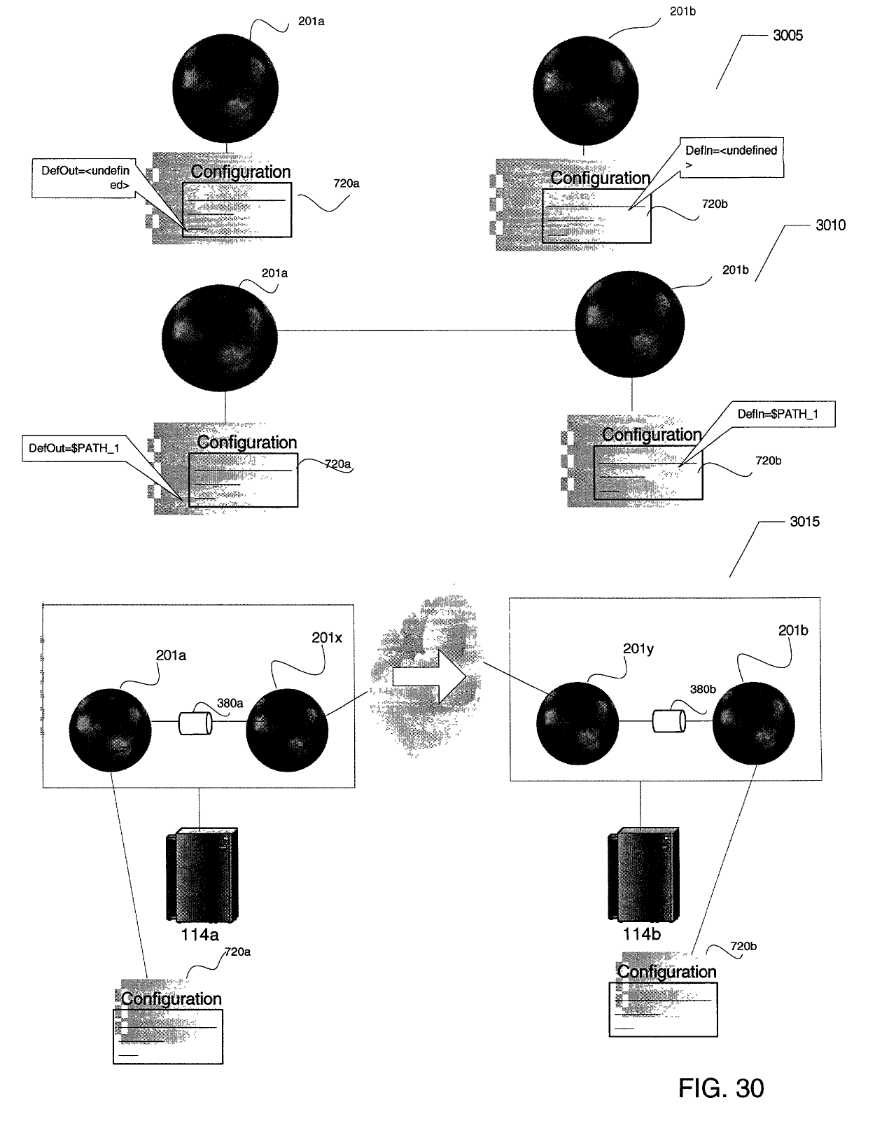

FIG. 30 graphically depicts a set of steps for the resolution of a default input channel and a default output channel by an ADNDT for modules deployed on separate hosts according to one embodiment of the present invention. Step 3005, shows modules 201a and 201b that have not been related to one another through a communication pathway 314. For example, modules 201a and 201b may have been previously defined and may simply be defined such that they reside in a module repository 810. Note at this step, configuration files 720a and 720b corresponding respectively to modules 201a and 201b hold undefined channel entries.

In step 3010, the application developer provides input to ADNDT 2815 (e.g., through a graphical input device) 2815 that module 201a is to interact with module 201b (i.e., by graphically drawing a communications pathway between modules 201a and 201b. In this step, ADNDT 2815 stores a named placeholder string (e.g., $PATH_1) for the yet unresolved communication pathway 314 as the default output channel 380 for module 201a and the default input channel 380 of module 201b. Note that at step 2910, the communications pathway 314 is undefined since the application developer has not indicated whether modules 201a and 201b will reside on the same host or separate hosts 114.

In step 3015, the application developer provides input to ADNDT 2815 indicating precisely where modules 201a and 201b are to reside within computing environment 121 (i.e., the particular hosts 114 on which these modules 201 will be deployed). This definition may be effected as part of a component 505 definition. Upon this input from the application developer, ADNDT 2815 will set appropriate parameters in respective configuration files 720a and 720b so that the default output channel 380 of module 201a corresponds to the default input channel 380 of module 201b. In the particular example depicted in FIG. 29, it is assumed that the application developer has indicated that modules 201a and 201b are to reside on separate hosts 114a and 114. In this case, ADNDT 2815 causes facilitator modules 201x and 201y, which are respectively sender and receiver modules 201 to be deployed respectively to host 114a and host 114b. The default output channel of module 201a is set to the default input channel of module 201b via configuration file 720a. Similarly, the default output channel of receiver module 201y is set to the default input channel of module 201b.

ADNDT 2815 also provides for the application developer to deploy a single component within an application 405 onto a set of more than one host 114. In such a case, the application developer is prompted to specify the intention of the deployment: scalability or high-availability. If the application developer chooses scalability, a load balancing module 201 (not shown) is automatically deployed in front of input channels 380 of the component 505. A load balancing module 201 routes messages 305 from its input conditionally to one of its set of outputs and may be configured with a policy (e.g., round robin messaging or use of a rule set). All of the outputs for the duplicate components 505 are directed to similar outputs. If it is a high-availability deployment, messages 305 arriving at the inputs of the set of component duplicates 505 are optionally duplicated using a router module 201, which is specially configured to unconditionally copy all messages 305 to all components 505. Other messages 305 may be throttled with a switch (with corresponding configuration GUI) to select which of the components 505 is to be the primary (active) runtime instance.

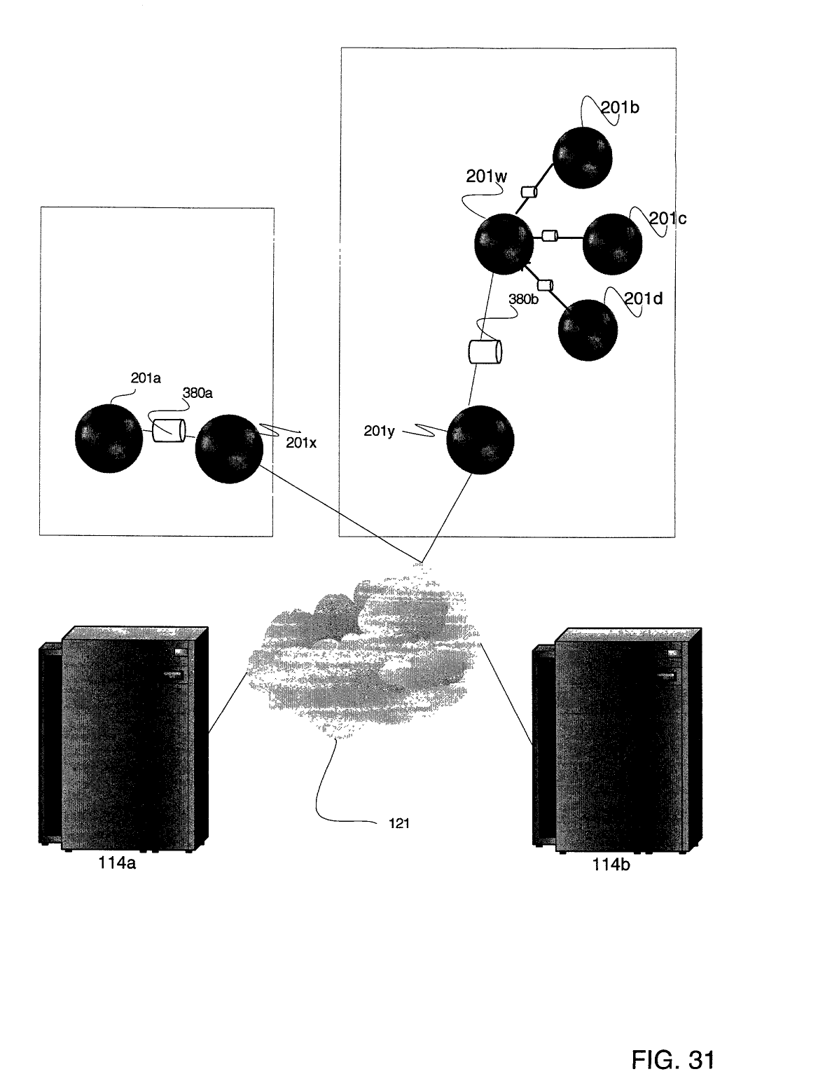

FIG. 31 further illustrates an exemplary deployment configuration for modules residing on separate hosts according to one embodiment of the present invention. FIG. 31 corresponds to a situation in which module 201a outputs messages to a router module 201w that conditionally outputs the messages to modules 201b, 201c and 201d. It is desired to deploy module 201a on host 114a and router module 201w, module 201b, module 201c and module 201d on host 114b. In order to effect this deployment, module 201a is deployed on host 114a along with sender module 201x. Receiver module 201y is deployed on host 114b along with router module 201w and modules 201b-201d. Furthermore, the default output channel of module 201a is set to the default input channel of sender module 201x on host 114a while the default output channel of receiver module 201y is set to the default input channel of router 201w on host 114b. Under this deployment example, only a single channel (i.e, between sender module 201x and receiver module 201y) must be extended across hosts 114a and 114b.

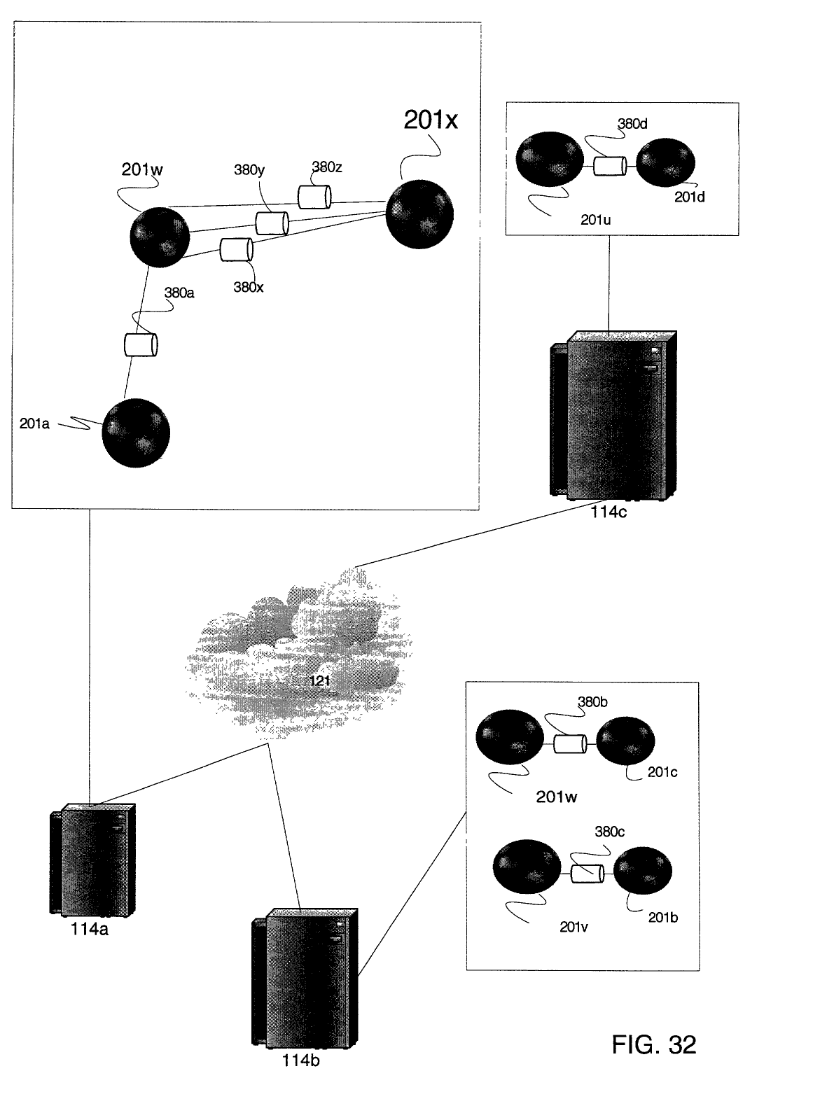

FIG. 32 further illustrates an exemplary deployment configuration for modules residing on separate hosts according to one embodiment of the present invention. As in FIG. 31, it is desired for module 201a to communicate with modules 201b-201d. In order to effect this interaction, module 201a is deployed on host 114a along with router module 201w and sender module 201x. Default output channel 380a of module 201a is set to the default input channel 380a of router module 201w. Router module 201w is coupled to sender module 201x via custom channels 380x, 380y and 380z. Receiver modules 201v and 201w are deployed on host 114b along with modules 201b and 201c. The default output channel of receiver module 201w is set to the default input channel of module 201c (380b) and the default input channel of module 201b (380c) is set to the default output channel of receiver module 201(v). Module 201d and receiver module 201u are deployed on host 114c. The default output channel of receiver module 201u (380d) is set to the default input channel of module 201d. It is assumed that during deployment, the application developer specified that each module connection should go over a unique network port. Thus, module 201a may interact with modules 201b-201d on hosts 114b-114c.

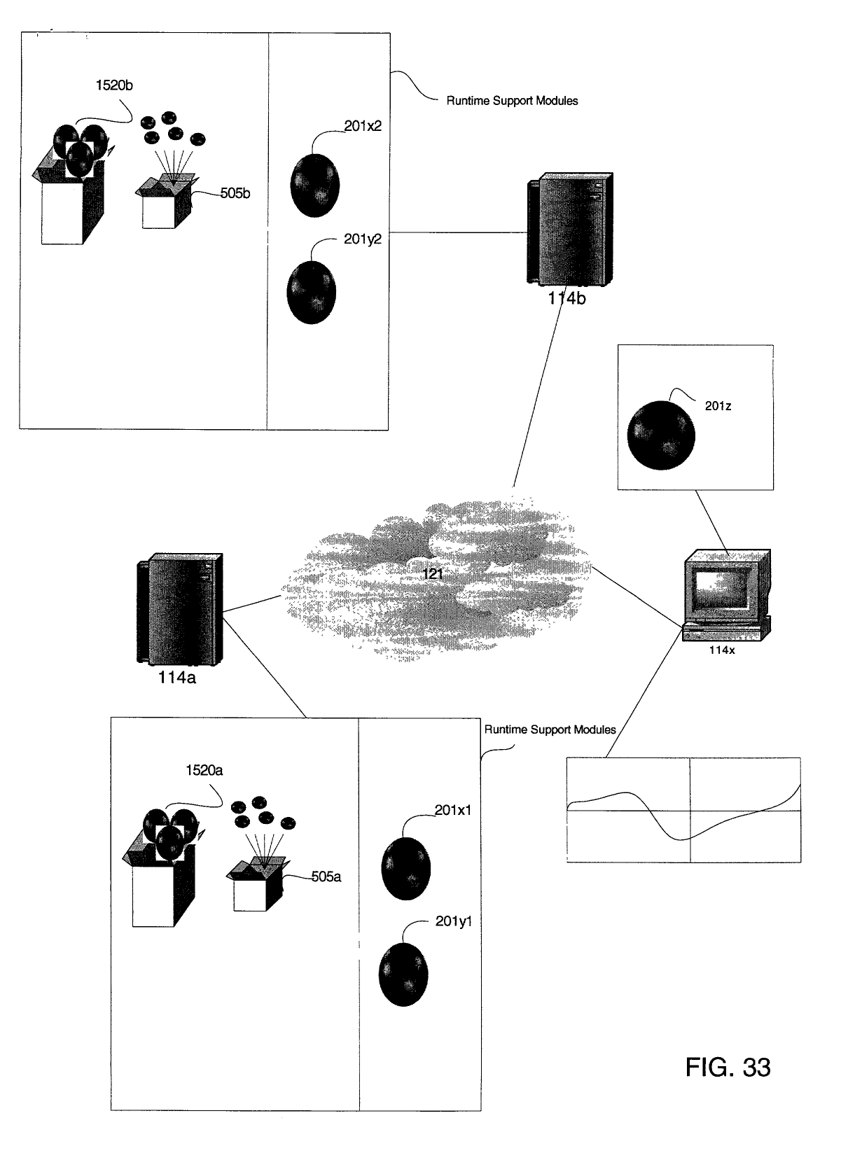

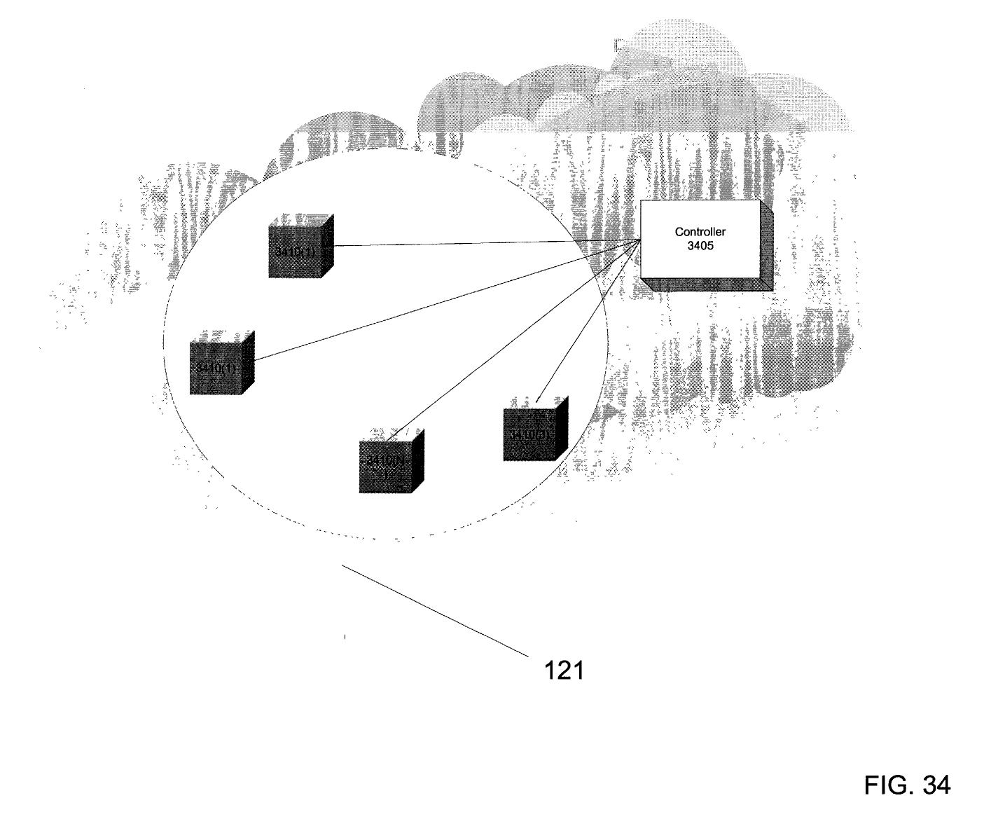

According to one embodiment, upon deployment of an application 405 to a computing environment 121, a monitoring function is available to monitor performance of the application. In accordance with the paradigm of the invention, a system monitor module 201 and a channel monitor module 201 are employed for this purpose. FIG. 33 depicts the operation of a system monitor module and channel monitor module according to one embodiment of the present invention. It is assumed that an application 405 has been deployed to hosts 114a and 114b and is running. Thus, components 505a and 505b have been deployed to hosts 114a and 114b respectively. In addition, runtime environments 1520a and 1520b have been deployed to hosts 114a and 114b respectively. In addition, note that runtime support modules 201x1 and 201y1 and runtime support modules 201x2 and 201y2 have been respectively deployed to hosts 114a and 114b. Runtime support modules 201x1 and 201x2 perform channel monitoring functionality to report criteria related to channel use. Runtime support modules 201y1 and 201y2 perform system monitoring related to disk usage, CPU usage, etc.

Note that monitoring host 114x has communications module 201z. Monitoring host 114x may receive information and data generated by runtime support modules 201x1-201x2 and 201y1-201y2 via communication module 201z and respective communication modules deployed on hosts 114a and 114b and included in runtime environment packages 1520a and 1520b. Application performance may be analyzed and reported using any combination of graphical or text output. Based upon this information, applications 405 may be reconfigured and/or redeployed to achieve various performance metrics.

A method and system for application development has been described. The present invention provides a system and method for application development, deployment and runtime monitoring which significantly fosters code reuse and dynamic reconfiguration of developed applications. The development environment includes a module coding step, a packaging step, an application building step and a deployment step, in which an application is deployed (i.e., installed) in a computing environment (e.g., computer network). After runtime has commenced, the performance of the application may be monitored to evaluate its performance. During runtime, applications may be reconfigured dynamically to respond to temporal variations within a computing environment such as shifting load and/or faults. The development environment provided by the present invention obviates developer focus upon protocol and communication issues within an intended computing environment during the development phase. Instead, the paradigm promotes attention to functional behavior of code, efficient logic design, control and logic flow based upon a programming specification and desired overall functional behavior. Furthermore, the development environment significantly reduced development and reconfiguration time, code reusability, reduction in frequency of design errors and heightened performance through more efficient code design.

What is claimed is:

1. A distributed processing system comprising:
(a) a plurality of discrete, autonomous program processes, wherein each program process is capable of generating destinationless messages;
(b) at least one data repository for receiving and storing destinationless messages generated by program processes;
wherein each program process is associated with configuration information, which includes information for associating a program process with a data repository in at least one of a read and write capacity.

2. The distributed processing system according to claim 1, wherein each discrete autonomous program process is a module.

3. The distributed processing system according to claim 1, wherein each data repository is a channel.

4. The distributed processing system according to claim 1, wherein the configuration information for each program process is utilized at a runtime step to establish one of a read and write relationship with a data repository.

5. A reconfigurable data processing system comprising:
(a) a plurality of discrete, autonomous program processes, wherein each program process is capable of the generation of destinationless messages;
(b) at least one data repository for receiving and storing destinationless messages generated by program processes;
(c) a plurality of configuration parameters associating program processes with at least one data repository in one of a read and write capacity, the plurality of configuration parameters establishing a data flow mechanism.

6. A data processing system comprising:
(a) a plurality of modules, wherein a module is a discrete process and is associated with a capability for generating destinationless messages;
(b) at least one data repository, wherein each data repository receives and stores destinationless messages generated by modules;
(c) an API (“Application Program Interface”), wherein the API provides at least one function for associating a read operation of a module with a data repository and a write operation of a module with a data repository.

7. The data processing system according to claim 6, wherein each module does not include programming instructions relating to an interaction with a second module.

8. The data processing system according to claim 6, wherein each module is associated with configuration information, wherein the configuration information includes information for associating the module with a data repository for writing destinationless messages.

9. The data processing system according to claim 6, wherein each module is associated with configuration information, wherein the configuration information includes information for associating the module with a data repository for reading destinationless messages.

10. The data processing system according to claim 6, further including a second API for defining a module, wherein the module API includes at least one of a function for initializing, working and terminating a module.

11. The data processing system according to claim 6, further including a third API for defining a structure for a message, wherein the structure includes at least one field.

12. The data processing system according to claim 6, wherein a destinationless message is a BLOB (“Binary Large Object”).

13. The data processing system according to claim 8, wherein a module is associated with a data repository for writing messages at runtime utilizing the configuration information.

14. The data processing system according to claim 9, wherein a module is associated with a data repository for reading destinationless messages at runtime utilizing the configuration information.

15. The data processing system according to claim 6, wherein each of the data repositories is a segment of memory.

16. The data processing system according to claim 6, wherein each module includes a plurality of programming instructions including programming instructions for at least one of remotely initializing the module and remotely terminating the module.

17. The data processing system according to claim 16, wherein the programming instructions for remotely initializing the module include a function pointer.

18. A system for application development, comprising:
(a) a module API wherein the module API includes a plurality of function calls for defining a module, wherein a module is a discrete process that includes a capability for a generation of destinationless messages;
(b) a channel API, wherein the channel API includes a plurality of function calls for at least one of opening, writing to and reading from a channel, wherein a channel stores destinationless messages generated by modules;
(c) a message API, wherein the message API includes a plurality of function calls for defining a structure of destinationless messages.

19. The system according to claim 18, wherein the module API, channel API and message API are provided as statically linked libraries.

20. A method for developing a computer program comprising the steps of:
(a) defining a plurality of program modules, wherein each module includes a process to perform an associated function, and wherein each module includes a capability for generating destinationless messages;
(b) defining a plurality of communication pathways between the modules in order to achieve a desired program behavior;
(c) at runtime, resolving the communication pathways to associate the plurality of program modules with a plurality of data repositories, wherein the data repositories receive and store messages.

21. The method according to claim 20, wherein each of the plurality of program modules is associated with a data repository in one of a read and write capacity.

22. The method according to claim 20, wherein step (c) further includes the step of specifying configuration information for each module with respect to the plurality of data repositories in one of a read and write capacity as a function of the communication pathways.

23. A method for application development comprising the steps of:
(a) defining at least one module, wherein a module includes a discrete code element and performs a functional behavior;
(b) defining an interaction configuration between the at least one module to achieve an application behavior, wherein the interaction configuration includes re-configurable communication pathways for an exchange of messages between a first module and a second module;
(c) defining a deployment configuration for the application, wherein the deployment configuration defines at least a relationship between each module and one or more hosts within a computing environment;
(d) deploying the modules to the computing environment as a function of the deployment configuration; and,
(e) establishing the communication pathways between the at least one module as a function of the interaction and the deployment configuration.

24. The method according to claim 23, wherein step (e) further includes the steps of:
(i) defining at least one decentralized channel; and,
(ii) establishing communication between a first module and a second module sharing a communication pathway by setting the first module to exchange messages with the second module on a decentralized channel.

25. The method according to claim 24, wherein a decentralized channel is a shared memory resource including at least one of a resource on a storage device and a random access memory (“RAM”).

26. The method according to claim 23, wherein computing environment is a computer network.

27. The method according to claim 23, wherein step (e) further includes the steps of:
(i) defining at least one decentralized channel;
(ii) if a first module and a second module sharing a communication pathway are designated to reside on separate hosts as part of the deployment configuration, deploying a sender module to a first host associated with the first module and deploying a receiver module to a second host associated with the second module, wherein the sender module and the receiver modules perform communications between the first and second host; and,
(iii) establishing a communication between the first module and the sender module and establishing a communication between the second module and the receiver module.

28. A program module comprising:
(a) an initialization function process, wherein the initialization function process is executed upon an initialization of the program module;
(b) a work function process, wherein the work function process exhibits a behavior associated with the program module; and,
(c) a termination function process, wherein the termination function process is executed upon a termination of the program module.

29. The program module according to claim 28, wherein the initialization function process, the work function process and the termination function process are callback functions.

30. A distributed application development system comprising a processor, wherein the processor is adapted to: provide a graphical user interface (“GUI”) wherein the GUI:
(a) provides for a specification of a plurality of discrete, autonomous program processes to be used in the application, and receives information relating thereto;
(b) provides for a specification of a plurality of communication pathways between the plurality of program processes and receives information relating thereto; and,
(c) provides for a specification of a deployment configuration and receives information relating thereto;
wherein the processor is further adapted to modify runtime configuration information relating each of the program processes as a function of the information received by the GUI.

31. The distributed application development system according to claim 30, wherein the runtime configuration information of each program process includes information relating to associating the program process with a data repository in at least one of a read and write capacity.

32. The distributed application development system according to claim 31, wherein the processor updates the configuration information of each program process associating the program process with a data repository as a function of the communication pathways specified in step (b).
